(19) United States
(12) Patent Application Publication
(10) Pub. No.: US 2026/0334503 A1
(43) Pub. Date: Oct. 29, 2026

(54) Dasher, Vessel, and Pour-In Opening for a Drink Maker

(71) Applicant: SharkNinja Operating LLC, Needham, MA (US)

(72) Inventors: Connor J. Mayer, Waltham, MA (US); Michael Lerman, Providence, RI (US); Vipul Mone, Boston, MA (US); Jennifer Andrews, Boston, MA (US); Gabrielle Avendt, Woodbine, MD (US); Ethan Brown, Wayland, MA (US); Sophia Cheng, Needham, MA (US); Yaoming Deng, Shenzhen (CN); Tyler Long, West Roxbury, MA (US); Travis Marks, East Boston, MA (US); Dante G. Mauriello, Watertown, MA (US); Ryan Michienzi, Cumberland, RI (US); Julia Nosky, Needham, MA (US); Adam Robert, Mattapoisett, MA (US); Lukas Tubby, Mansfield, MA (US); Wu Ju, Shenzhen (CN); Baosheng Tu, Shenzhen (CN); Miao Qin, Shenzhen (CN)

(21) Appl. No.: 19/383,233

(22) Filed: Nov. 7, 2025

Related U.S. Application Data
(63) Continuation-in-part of application No. 18/445,679, filed on Apr. 29, 2025.
(63) Continuation-in-part of application No. 30/022,735, filed on Sep. 11, 2025.

(51) Int. Cl. A23G 9/22; A23G 9/04; A23G 9/12; B01F 27/091; B01F 27/1145; B01F 27/72; B01F 101/13; B01F 101/14

(52) U.S. Cl. CPC A23G 9/224; A23G 9/045; A23G 9/12; B01F 27/091; B01F 27/11451; B01F 27/72; B01F 2101/13; B01F 2101/14

(57) ABSTRACT

A dasher for reducing waste in a drink maker is described. An example dasher includes at least one helical blade oriented with a curvature around a major axis. The at least one helical blade rotates about the major axis. At least one scraper blade extends lengthwise parallel to the major axis and is connected to the at least one helical blade. A shaft mounting hub is removably connected to a drive shaft of a drive motor of the drink maker. At least one face blade is connected to the shaft mounting hub and a front end of the at least one helical blade. The at least one face blade has a front surface that is wider than a front surface of the at least one helical blade. The at least one face blade has a width spanning from an outer perimeter of the dasher to the shaft mounting hub.

### CROSS REFERENCE TO RELATED APPLICATIONS

This application is a continuation-in-part of U.S. patent application Ser. No. 18/445,679, filed Apr. 29, 2025, entitled “Dasher for Reduced Waste in a Drink Maker,” and this application is a continuation-in-part of U.S. Design patent application Ser. No. 30/022,735, filed Sep. 11, 2025, entitled “Drink Maker,” the disclosures of each of which are hereby incorporated by reference in their entireties.

### BACKGROUND

### 1. Technical Field

The present disclosure relates to drink makers and, in some non-limiting embodiments or aspects, to a dasher for a drink maker that is configured to reduce waste from accumulated frozen drink product.

### 2. Technical Considerations

Frozen drink makers, which may also be referred to as semi-frozen beverage makers or crushed-ice drink makers, typically include a transparent tank or mixing vessel in which a drink product is received and processed, including being cooled, often transforming the drink product from a pure liquid (or a combination of a liquid and portions of ice) to a frozen or semi-frozen product, such as, for example, a granita, slush drink, smoothie, ice cream, or other frozen or semi-frozen product, which is then dispensed. The cooled product is typically dispensed through a tap, spigot, or dispenser located at the front and near the bottom of the vessel. Thus, the term “frozen drink maker,” as used herein, is not limited to a device that only makes drinks or frozen drinks but includes devices that cool received drink products to produce cooled outputs in any of a variety of chilled below-zero degrees Celsius, frozen, and semi-frozen forms. A drink product may consist of a mixture of water or milk, a syrup, flavoring powders, or other additives that give the drink product the desired taste and color.

During operation, some frozen drink makers may allow material to accumulate in undesirable locations. This may lead to unused material remaining in a mixing vessel and/or potential damage to components of the drink maker.

### SUMMARY

Accordingly, provided is a dasher for reduced waste in a drink maker to reduce accumulation of frozen drink product at locations within the mixing vessel that may reduce throughput or damage the drink maker.

According to some non-limiting embodiments or aspects, provided is a dasher for use in a mixing vessel of a drink maker. An example dasher may include at least one helical blade oriented with a curvature around a major axis of the dasher. The at least one helical blade may be configured to rotate about the major axis. At least one scraper blade may extend lengthwise parallel to the major axis and may be connected to the at least one helical blade. A shaft mounting hub may be configured to be removably connected to a drive shaft of a drive motor of the drink maker. At least one face blade may be connected to the shaft mounting hub and a front end of the at least one helical blade. The at least one face blade may have a front surface that is wider than a front surface of the at least one helical blade. The at least one face blade may have a width spanning from an outer perimeter of the dasher to the shaft mounting hub.

In some non-limiting embodiments or aspects, the at least one helical blade may include a first helical blade and a second helical blade.

In some non-limiting embodiments or aspects, the at least one face blade may include a first face blade and a second face blade. The first face blade may be connected to a front end of the first helical blade and the second face blade may be connected to a front end of the second helical blade.

In some non-limiting embodiments or aspects, a first scoop may protrude from the front surface of the first face blade and may include a leading edge extending radially from the major axis. A second scoop may protrude from the front surface of the second face blade and may include a leading edge extending radially from the major axis.

In some non-limiting embodiments or aspects, each face blade of the at least one face blade may include a scoop protruding from the front surface of the face blade and may include a leading edge extending radially from the major axis.

In some non-limiting embodiments or aspects, each face blade of the at least one face blade may include a structural wing extending between the face blade and the shaft mounting hub.

In some non-limiting embodiments or aspects, the at least one scraper blade may be configured to dislodge at least a portion of the drink product accumulated on a surface of a metal drum of an evaporator positioned in the mixing vessel.

In some non-limiting embodiments or aspects, a mounting ring may be configured to encircle a circumference of the metal drum as the dasher is removably mounted to the drink maker.

In some non-limiting embodiments or aspects, the at least one helical blade may be connected to the mounting ring.

In some non-limiting embodiments or aspects, the at least one scraper blade is connected to the mounting ring.

In some non-limiting embodiments or aspects, the at least one scraper blade may include a first scraper blade and a second scraper blade positioned on an opposite side of the major axis from the first scraper blade.

In some non-limiting embodiments or aspects, the at least one scraper blade may include a third scraper blade and a fourth scraper blade positioned on an opposite side of the major axis from the third scraper blade.

In some non-limiting embodiments or aspects, each face blade of the at least one face blade may include a trailing edge that contacts or is proximate to a front, interior surface of the mixing vessel.

In some non-limiting embodiments or aspects, the at least one helical blade may be configured to urge drink product in the mixing vessel from a back of the mixing vessel to a front of the mixing vessel as the at least one helical blade rotates about the major axis.

In some non-limiting embodiments or aspects, the at least one scraper blade may be configured to move at least a portion of the drink product from a surface within the mixing vessel.

According to some non-limiting embodiments or aspects, provided is a drink maker. An example drink maker may include a mixing vessel, which may be configured to receive a drink product. The mixing vessel may have an outlet. A drive motor, a drive shaft, and a dasher may be included. The dasher may be configured to be received within the mixing vessel. The dasher may include at least one helical blade oriented with a curvature around a major axis of the dasher and configured to urge drink product in the mixing vessel from a back of the mixing vessel to a front of the mixing vessel as the at least one helical blade rotates about the major axis. The dasher may include at least one scraper blade extending lengthwise parallel to the major axis and connected to the at least one helical blade. The at least one scraper blade may be configured to move at least a portion of the drink product from a surface within the mixing vessel. The dasher may include a shaft mounting hub configured to be removably connected to the drive shaft of the drive motor of the drink maker. The dasher may include at least one face blade connected to the shaft mounting hub and a front end of the at least one helical blade. The at least one face blade may have a front surface that is wider than a front surface of the at least one helical blade. The at least one face blade may have a width spanning from an outer perimeter of the dasher to the shaft mounting hub. The at least one face blade may be configured to urge the drink product toward the outlet of the mixing vessel as the at least one face blade rotates about the major axis.

In some non-limiting embodiments or aspects, the at least one helical blade may include a first helical blade and a second helical blade.

In some non-limiting embodiments or aspects, the at least one face blade may include a first face blade and a second face blade. The first face blade may be connected to a front end of the first helical blade, and the second face blade may be connected to a front end of the second helical blade.

In some non-limiting embodiments or aspects, a first scoop may protrude from the front surface of the first face blade and may include a leading edge extending radially from the major axis. A second scoop may protrude from the front surface of the second face blade and may include a leading edge extending radially from the major axis.

In some non-limiting embodiments or aspects, each face blade of the at least one face blade may include a structural wing extending between the face blade and the shaft mounting hub.

According to some non-limiting embodiments or aspects, provided is a drink maker. An example maker may include a mixing vessel having a front end at which contents of the mixing vessel are dispensed, at least one helical blade oriented with a curvature around a major axis of a dasher, the at least one helical blade configured to rotate about the major axis, a central hub, and at least one face blade connected to the central hub and a front end of the at least one helical blade. The at least one face blade may have a front surface that is wider than a front surface of the at least one helical blade, at least a portion of the at least one face blade having a width spanning from an outer perimeter of the dasher to the central hub, and no portion of the at least one face blade has a front surface that extends further towards the front end of the mixing vessel than a front surface of the central hub.

In some non-limiting embodiments or aspects, the at least one helical blade may include a first helical blade and a second helical blade.

In some non-limiting embodiments or aspects, the at least one face blade may include a first face blade and a second face blade, the first face blade connected to a front end of the first helical blade and the second face blade connected to a front end of the second helical blade.

In some non-limiting embodiments or aspects, the drink maker further may include a first scoop protruding from the front surface of the first face blade and may include a leading edge extending radially from the major axis and a second scoop protruding from the front surface of the second face blade and may include a leading edge extending radially from the major axis.

In some non-limiting embodiments or aspects, each face blade of the at least one face blade may include a scoop protruding from the front surface of the face blade and may include a leading edge extending radially from the major axis.

In some non-limiting embodiments or aspects, each face blade of the at least one face blade may include a structural wing extending between the face blade and the central hub.

In some non-limiting embodiments or aspects, the drink maker further may include at least one scraper blade extending lengthwise parallel to the major axis, wherein the at least one scraper blade is connected to the at least one helical blade and is configured to dislodge at least a portion of a drink product accumulated on a surface of a metal drum of an evaporator positioned in the mixing vessel.

In some non-limiting embodiments or aspects, the drink maker further may include a mounting ring configured to encircle a circumference of the metal drum as the dasher is removably mounted to the drink maker.

In some non-limiting embodiments or aspects, the at least one helical blade may be connected to the mounting ring.

In some non-limiting embodiments or aspects, the at least one scraper blade is connected to the mounting ring.

In some non-limiting embodiments or aspects, the at least one scraper blade may include a first scraper blade and a second scraper blade positioned on an opposite side of the major axis from the first scraper blade.

In some non-limiting embodiments or aspects, the at least one scraper blade further may include a third scraper blade and a fourth scraper blade positioned on an opposite side of the major axis from the third scraper blade.

In some non-limiting embodiments or aspects, each face blade of the at least one face blade may include a trailing edge that contacts or is proximate to a front, interior surface of the mixing vessel.

In some non-limiting embodiments or aspects, the at least one helical blade is configured to urge drink product in the mixing vessel from a back of the mixing vessel to a front of the mixing vessel as the at least one helical blade rotates about the major axis.

In some non-limiting embodiments or aspects, the at least one scraper blade is configured to move at least a portion of a drink product from a surface within the mixing vessel.

In some non-limiting embodiments or aspects, at least one of the at least one scraper blade or the at least one helical blade is provided with a rough surface, and wherein the rough surface may include at least one of the following: ribs, a molded surface, an abraded surface, or any combination thereof.

In some non-limiting embodiments or aspects, the drink maker further may include a drive motor and a drive shaft, wherein the central hub is configured to be removably connected to the drive shaft.

According to some non-limiting embodiments or aspects, provided is a drink maker. An example drink maker may include a mixing vessel configured to receive a drink product, an evaporator positioned in the mixing vessel, and a dasher configured to process the drink product in the mixing vessel, wherein the mixing vessel may include at least one rib protruding from an interior surface of the mixing vessel, the at least one rib extending from a side of the mixing vessel, along the interior surface of the mixing vessel, toward a midline of the mixing vessel.

In some non-limiting embodiments or aspects, the at least one rib may include two or more ribs extending from a same side of the mixing vessel, along the interior surface of the mixing vessel, toward the midline of the mixing vessel.

In some non-limiting embodiments or aspects, an area between each rib of the two or more ribs is smooth.

In some non-limiting embodiments or aspects, the at least one rib extends at least partly perpendicularly from the side of the mixing vessel relative to a longitudinal axis of the mixing vessel, the at least one rib angled along its length toward a front of the mixing vessel.

In some non-limiting embodiments or aspects, the mixing vessel further may include a pour-in opening, and wherein the at least one rib terminates proximate to the pour-in opening.

In some non-limiting embodiments or aspects, the mixing vessel further may include a first internal protrusion extending horizontally along an interior wall of the mixing vessel.

In some non-limiting embodiments or aspects, the first internal protrusion is on a same side of the mixing vessel as the at least one rib.

In some non-limiting embodiments or aspects, an end of the at least one rib terminates at the first internal protrusion.

In some non-limiting embodiments or aspects, the mixing vessel further may include a second internal protrusion on an upper, interior surface of the mixing vessel, the second internal protrusion being at least partly rounded and configured to reduce adherence of the drink product to the upper, interior surface of the mixing vessel.

In some non-limiting embodiments or aspects, the second internal protrusion is at least partly convex and extends into an interior of the mixing vessel, toward a bottom of the mixing vessel.

In some non-limiting embodiments or aspects, the second internal protrusion is at least partly concave and forms an indentation on the upper, interior surface of the mixing vessel.

In some non-limiting embodiments or aspects, the second internal protrusion is shaped as a tear drop.

According to some non-limiting embodiments or aspects, provided is a mixing vessel for a drink maker. An example mixing vessel for a drink maker may include at least one rib protruding from an interior surface of the mixing vessel, the at least one rib extending from a side of the mixing vessel, along the interior surface of the mixing vessel, toward a midline of the mixing vessel, the mixing vessel being configured to receive a drink product to be processed in the mixing vessel, and the mixing vessel being further configured to receive an evaporator of the drink maker positioned in the mixing vessel.

In some non-limiting embodiments or aspects, the at least one rib may include two or more ribs extending from a same side of the mixing vessel, along the interior surface of the mixing vessel, toward the midline of the mixing vessel.

In some non-limiting embodiments or aspects, an area between each rib of the two or more ribs is smooth.

In some non-limiting embodiments or aspects, the at least one rib extends at least partly perpendicularly from the side of the mixing vessel relative to a longitudinal axis of the mixing vessel, the at least one rib angled along its length toward a front of the mixing vessel.

In some non-limiting embodiments or aspects, the mixing vessel further may include a pour-in opening, wherein the at least one rib terminates proximate to the pour-in opening.

In some non-limiting embodiments or aspects, the mixing vessel further may include a first internal protrusion extending horizontally along an interior wall of the mixing vessel.

In some non-limiting embodiments or aspects, the first internal protrusion is on a same side of the mixing vessel as the at least one rib.

In some non-limiting embodiments or aspects, the mixing vessel further may include a second internal protrusion on an upper, interior surface of the mixing vessel, the second internal protrusion being rounded.

In some non-limiting embodiments or aspects, the second internal protrusion is convex and extends into an interior of the mixing vessel, toward a bottom of the mixing vessel.

In some non-limiting embodiments or aspects, the second internal protrusion is concave and forms an indentation on the upper, interior surface of the mixing vessel.

According to some non-limiting embodiments or aspects, provided is a drink maker. An example drink maker may include a mixing vessel configured to receive a drink product, an evaporator positioned in the mixing vessel, and a dasher configured to process the drink product in the mixing vessel, wherein the mixing vessel may include a pour-in opening configured to initially receive the drink product and direct a flow of the drink product into the mixing vessel, and the pour-in opening may include a channel, a first surface sloped toward a rear section of the mixing vessel and toward the channel, a second surface opposite the first surface, the second surface being sloped toward the rear section of the mixing vessel and toward the channel, and an aperture proximate to the rear section of the mixing vessel.

In some non-limiting embodiments or aspects, the aperture is shaped as a slot.

In some non-limiting embodiments or aspects, a bottom portion of the pour-in opening extends into an interior of the mixing vessel.

In some non-limiting embodiments or aspects, the pour-in opening may include at least one retaining wall configured to enclose an interior volume of the pour-in opening and temporarily retain drink product within the pour-in opening.

In some non-limiting embodiments or aspects, the pour-in opening has a length greater than half a length of the mixing vessel, such that a front end of the pour-in opening is more proximate to a front of the mixing vessel, and a rear end of the pour-in opening is more proximate to a rear of the mixing vessel.

In some non-limiting embodiments or aspects, the pour-in opening is off-center from a midline of the mixing vessel, as viewed from a front of the mixing vessel.

In some non-limiting embodiments or aspects, the drink maker further may include a pour-in cover configured to at least partly enclose the pour-in opening, the pour-in cover configured to be removably attached to the pour-in opening.

In some non-limiting embodiments or aspects, the pour-in cover may include a first side with a movable portion configured to provide temporary access to an interior of the pour-in opening, a second side configured to remain stationary over the pour-in opening when the pour-in cover is removably attached to the pour-in opening, and at least one hinge portion connecting the first side to the second side.

In some non-limiting embodiments or aspects, the pour-in cover further may include a grip protrusion extending from a portion of the first side.

In some non-limiting embodiments or aspects, the second side of the pour-in cover further may include at least two depressions and a separator between the at least two depressions, the second side being configured to permit a user to pinch and lift the pour-in cover off of the pour-in opening.

In some non-limiting embodiments or aspects, the first side may include a door and a frame, the door being configured with a grip protrusion to permit a user to lift the door and access the interior of the pour-in opening.

According to some non-limiting embodiments or aspects, provided is a mixing vessel for a drink maker. An example mixing vessel for a drink maker may include a pour-in opening configured to initially receive a drink product and direct a flow of the drink product into the mixing vessel, and the pour-in opening may include a channel, a first surface sloped toward a rear section of the mixing vessel and toward the channel, a second surface opposite the first surface, the second surface being sloped toward the rear section of the mixing vessel and toward the channel, and an aperture proximate to the rear section of the mixing vessel.

In some non-limiting embodiments or aspects, a bottom portion of the pour-in opening extends into an interior of the mixing vessel.

In some non-limiting embodiments or aspects, the pour-in opening may include at least one retaining wall configured to enclose an interior volume of the pour-in opening and temporarily retain the drink product within the pour-in opening.

In some non-limiting embodiments or aspects, the pour-in opening has a length greater than half a length of the mixing vessel, such that a front end of the pour-in opening is more proximate to a front of the mixing vessel, and a rear end of the pour-in opening is more proximate to a rear of the mixing vessel.

In some non-limiting embodiments or aspects, the pour-in opening is off-center from a midline of the mixing vessel, as viewed from a front of the mixing vessel.

In some non-limiting embodiments or aspects, the mixing vessel further may include a pour-in cover configured to at least partly enclose the pour-in opening, the pour-in cover configured to be removably attached to the pour-in opening.

In some non-limiting embodiments or aspects, the pour-in cover may include a first side with a movable portion configured to provide temporary access to an interior of the pour-in opening, a second side configured to remain stationary over the pour-in opening when the pour-in cover is removably attached to the pour-in opening, and at least one hinge portion connecting the first side to the second side.

In some non-limiting embodiments or aspects, the pour-in cover further may include a grip protrusion extending from a portion of the first side.

In some non-limiting embodiments or aspects, the second side of the pour-in cover further may include at least two depressions and a separator between the at least two depressions, the second side being configured to permit a user to pinch and lift the pour-in cover off of the pour-in opening.

In some non-limiting embodiments or aspects, the first side may include a door and a frame, the door being configured with a grip protrusion to permit a user to lift the door and access the interior of the pour-in opening.

Further non-limiting embodiments or aspects are set forth in the following numbered clauses:

Clause 1: A drink maker comprising: a mixing vessel having a front end at which contents of the mixing vessel are dispensed; at least one helical blade oriented with a curvature around a major axis of a dasher, the at least one helical blade configured to rotate about the major axis; a central hub; and at least one face blade connected to the central hub and a front end of the at least one helical blade, the at least one face blade having a front surface that is wider than a front surface of the at least one helical blade, at least a portion of the at least one face blade having a width spanning from an outer perimeter of the dasher to the central hub, and no portion of the at least one face blade has a front surface that extends further towards the front end of the mixing vessel than a front surface of the central hub.

Clause 2: The drink maker of clause 1, wherein the at least one helical blade comprises a first helical blade and a second helical blade.

Clause 3: The drink maker of clause 1 or clause 2, wherein the at least one face blade comprises a first face blade and a second face blade, the first face blade connected to a front end of the first helical blade and the second face blade connected to a front end of the second helical blade.

Clause 4: The drink maker of any of clauses 1-3, further comprising: a first scoop protruding from the front surface of the first face blade and comprising a leading edge extending radially from the major axis; and a second scoop protruding from the front surface of the second face blade and comprising a leading edge extending radially from the major axis.

Clause 5: The drink maker of any of clauses 1-4, wherein each face blade of the at least one face blade comprises a scoop protruding from the front surface of the face blade and comprising a leading edge extending radially from the major axis.

Clause 6: The drink maker of any of clauses 1-5, wherein each face blade of the at least one face blade comprises a structural wing extending between the face blade and the central hub.

Clause 7: The drink maker of any of clauses 1-6, further comprising at least one scraper blade extending lengthwise parallel to the major axis, wherein the at least one scraper blade is connected to the at least one helical blade and is configured to dislodge at least a portion of a drink product accumulated on a surface of a metal drum of an evaporator positioned in the mixing vessel.

Clause 8: The drink maker of any of clauses 1-7, further comprising a mounting ring configured to encircle a circumference of the metal drum as the dasher is removably mounted to the drink maker.

Clause 9: The drink maker of any of clauses 1-8, wherein the at least one helical blade is connected to the mounting ring.

Clause 10: The drink maker of any of clauses 1-9, wherein the at least one scraper blade is connected to the mounting ring.

Clause 11: The drink maker of any of clauses 1-10, wherein the at least one scraper blade comprises: a first scraper blade; and a second scraper blade positioned on an opposite side of the major axis from the first scraper blade.

Clause 12: The drink maker of any of clauses 1-11, wherein the at least one scraper blade further comprises: a third scraper blade; and a fourth scraper blade positioned on an opposite side of the major axis from the third scraper blade.

Clause 13: The drink maker of any of clauses 1-14, wherein each face blade of the at least one face blade comprises a trailing edge that contacts or is proximate to a front, interior surface of the mixing vessel.

Clause 14: The drink maker of any of clauses 1-13, wherein the at least one helical blade is configured to urge drink product in the mixing vessel from a back of the mixing vessel to a front of the mixing vessel as the at least one helical blade rotates about the major axis.

Clause 15: The drink maker of any of clauses 1-14, wherein the at least one scraper blade is configured to move at least a portion of a drink product from a surface within the mixing vessel.

Clause 16: The drink maker of any of clauses 1-15, wherein at least one of the at least one scraper blade or the at least one helical blade is provided with a rough surface, and wherein the rough surface comprises at least one of the following: ribs, a molded surface, an abraded surface, or any combination thereof.

Clause 17: The drink maker of any of clauses 1-16, further comprising: a drive motor; and a drive shaft, wherein the central hub is configured to be removably connected to the drive shaft.

Clause 18. A drink maker comprising: a mixing vessel configured to receive a drink product; an evaporator positioned in the mixing vessel; and a dasher configured to process the drink product in the mixing vessel, wherein the mixing vessel comprises at least one rib protruding from an interior surface of the mixing vessel, the at least one rib extending from a side of the mixing vessel, along the interior surface of the mixing vessel, toward a midline of the mixing vessel.

Clause 19: The drink maker of clause 18, wherein the at least one rib comprises two or more ribs extending from a same side of the mixing vessel, along the interior surface of the mixing vessel, toward the midline of the mixing vessel.

Clause 20: The drink maker of clause 18 or clause 19, wherein an area between each rib of the two or more ribs is smooth.

Clause 21: The drink maker of any of clauses 18-20, wherein the at least one rib extends at least partly perpendicularly from the side of the mixing vessel relative to a longitudinal axis of the mixing vessel, the at least one rib angled along its length toward a front of the mixing vessel.

Clause 22: The drink maker of any of clauses 18-21, wherein the mixing vessel further comprises a pour-in opening, and wherein the at least one rib terminates proximate to the pour-in opening.

Clause 23: The drink maker of any of clauses 18-22, wherein the mixing vessel further comprises a first internal protrusion extending horizontally along an interior wall of the mixing vessel.

Clause 24: The drink maker of any of clauses 18-23, wherein the first internal protrusion is on a same side of the mixing vessel as the at least one rib.

Clause 25: The drink maker of any of clauses 18-24, wherein an end of the at least one rib terminates at the first internal protrusion.

Clause 26: The drink maker of any of clauses 18-25, wherein the mixing vessel further comprises a second internal protrusion on an upper, interior surface of the mixing vessel, the second internal protrusion being at least partly rounded and configured to reduce adherence of the drink product to the upper, interior surface of the mixing vessel.

Clause 27: The drink maker of any of clauses 18-26, wherein the second internal protrusion is at least partly convex and extends into an interior of the mixing vessel, toward a bottom of the mixing vessel.

Clause 28: The drink maker of any of clauses 18-27, wherein the second internal protrusion is at least partly concave and forms an indentation on the upper, interior surface of the mixing vessel.

Clause 29: The drink maker of any of clauses 18-27, wherein the second internal protrusion is shaped as a tear drop.

Clause 30: A mixing vessel for a drink maker, the mixing vessel comprising at least one rib protruding from an interior surface of the mixing vessel, the at least one rib extending from a side of the mixing vessel, along the interior surface of the mixing vessel, toward a midline of the mixing vessel, the mixing vessel being configured to receive a drink product to be processed in the mixing vessel, and the mixing vessel being further configured to receive an evaporator of the drink maker positioned in the mixing vessel.

Clause 31: The mixing vessel of clause 30, wherein the at least one rib comprises two or more ribs extending from a same side of the mixing vessel, along the interior surface of the mixing vessel, toward the midline of the mixing vessel.

Clause 32: The mixing vessel of clause 30 or clause 31, wherein an area between each rib of the two or more ribs is smooth.

Clause 33: The mixing vessel of any of clauses 30-32, wherein the at least one rib extends at least partly perpendicularly from the side of the mixing vessel relative to a longitudinal axis of the mixing vessel, the at least one rib angled along its length toward a front of the mixing vessel.

Clause 34: The mixing vessel of any of clauses 30-33, further comprising a pour-in opening, wherein the at least one rib terminates proximate to the pour-in opening.

Clause 35: The mixing vessel of any of clauses 30-34, further comprising a first internal protrusion extending horizontally along an interior wall of the mixing vessel.

Clause 36: The mixing vessel of any of clauses 30-35, wherein the first internal protrusion is on a same side of the mixing vessel as the at least one rib.

Clause 37: The mixing vessel of any of clauses 30-36, further comprising a second internal protrusion on an upper, interior surface of the mixing vessel, the second internal protrusion being rounded.

Clause 38: The mixing vessel of any of clauses 30-37, wherein the second internal protrusion is convex and extends into an interior of the mixing vessel, toward a bottom of the mixing vessel.

Clause 39: The mixing vessel of any of clauses 30-38, wherein the second internal protrusion is concave and forms an indentation on the upper, interior surface of the mixing vessel.

Clause 40: A drink maker comprising: a mixing vessel configured to receive a drink product; an evaporator positioned in the mixing vessel; and a dasher configured to process the drink product in the mixing vessel, wherein the mixing vessel comprises a pour-in opening configured to initially receive the drink product and direct a flow of the drink product into the mixing vessel, the pour-in opening comprising: a channel; a first surface sloped toward a rear section of the mixing vessel and toward the channel; a second surface opposite the first surface, the second surface being sloped toward the rear section of the mixing vessel and toward the channel; and an aperture proximate to the rear section of the mixing vessel.

Clause 41: The drink maker of clause 40, wherein the aperture is shaped as a slot.

Clause 42: The drink maker of clause 40 or clause 41, wherein a bottom portion of the pour-in opening extends into an interior of the mixing vessel.

Clause 43: The drink maker of any of clauses 40-42, wherein the pour-in opening comprises at least one retaining wall configured to enclose an interior volume of the pour-in opening and temporarily retain drink product within the pour-in opening.

Clause 44: The drink maker of any of clauses 40-43, wherein the pour-in opening has a length greater than half a length of the mixing vessel, such that a front end of the pour-in opening is more proximate to a front of the mixing vessel, and a rear end of the pour-in opening is more proximate to a rear of the mixing vessel.

Clause 45: The drink maker of any of clauses 40-44, wherein the pour-in opening is off-center from a midline of the mixing vessel, as viewed from a front of the mixing vessel.

Clause 46: The drink maker of any of clauses 40-45, further comprising a pour-in cover configured to at least partly enclose the pour-in opening, the pour-in cover configured to be removably attached to the pour-in opening.

Clause 47: The drink maker of any of clauses 40-46, wherein the pour-in cover comprises: a first side with a movable portion configured to provide temporary access to an interior of the pour-in opening; a second side configured to remain stationary over the pour-in opening when the pour-in cover is removably attached to the pour-in opening; and at least one hinge portion connecting the first side to the second side.

Clause 48: The drink maker of any of clauses 40-47, wherein the pour-in cover further comprises a grip protrusion extending from a portion of the first side.

Clause 49: The drink maker of any of clauses 40-48, wherein the second side of the pour-in cover further comprises at least two depressions and a separator between the at least two depressions, the second side being configured to permit a user to pinch and lift the pour-in cover off of the pour-in opening.

Clause 50: The drink maker of any of clauses 40-49, wherein the first side comprises a door and a frame, the door being configured with a grip protrusion to permit a user to lift the door and access the interior of the pour-in opening.

Clause 51: A mixing vessel for a drink maker, the mixing vessel comprising: a pour-in opening configured to initially receive a drink product and direct a flow of the drink product into the mixing vessel, the pour-in opening comprising: a channel; a first surface sloped toward a rear section of the mixing vessel and toward the channel; a second surface opposite the first surface, the second surface being sloped toward the rear section of the mixing vessel and toward the channel; and an aperture proximate to the rear section of the mixing vessel.

Clause 52: The mixing vessel of clause 51, wherein a bottom portion of the pour-in opening extends into an interior of the mixing vessel.

Clause 53: The mixing vessel of clause 51 or clause 52, wherein the pour-in opening comprises at least one retaining wall configured to enclose an interior volume of the pour-in opening and temporarily retain the drink product within the pour-in opening.

Clause 54: The mixing vessel of any of clause 51-53, wherein the pour-in opening has a length greater than half a length of the mixing vessel, such that a front end of the pour-in opening is more proximate to a front of the mixing vessel, and a rear end of the pour-in opening is more proximate to a rear of the mixing vessel.

Clause 55: The mixing vessel of any of clause 51-54, wherein the pour-in opening is off-center from a midline of the mixing vessel, as viewed from a front of the mixing vessel.

Clause 56: The mixing vessel of any of clause 51-55, further comprising a pour-in cover configured to at least partly enclose the pour-in opening, the pour-in cover configured to be removably attached to the pour-in opening.

Clause 57: The mixing vessel of any of clause 51-56, wherein the pour-in cover comprises: a first side with a movable portion configured to provide temporary access to an interior of the pour-in opening; a second side configured to remain stationary over the pour-in opening when the pour-in cover is removably attached to the pour-in opening; and at least one hinge portion connecting the first side to the second side.

Clause 58: The mixing vessel of any of clause 51-57, wherein the pour-in cover further comprises a grip protrusion extending from a portion of the first side.

Clause 59: The mixing vessel of any of clause 51-58, wherein the second side of the pour-in cover further comprises at least two depressions and a separator between the at least two depressions, the second side being configured to permit a user to pinch and lift the pour-in cover off of the pour-in opening.

Clause 60: The mixing vessel of any of clause 51-59, wherein the first side comprises a door and a frame, the door being configured with a grip protrusion to permit a user to lift the door and access the interior of the pour-in opening.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Reference to the detailed description, combined with the following figures, will make the disclosure more fully understood, wherein:

FIG. 1 is a perspective view of a frozen drink maker, according to some non-limiting embodiments or aspects;

FIG. 2 is a view of various internal components within the housing and mixing vessel of the frozen drink maker of FIG. 1, according to some non-limiting embodiments or aspects;

FIG. 3 is a front view of the frozen drink maker of FIG. 1, according to some non-limiting embodiments or aspects;

FIG. 4 is a block diagram of an example of a control system of the frozen drink maker of FIG. 1, according to some non-limiting embodiments or aspects;

FIG. 5A is an isometric view of the frozen drink maker with a mixing vessel having at least one internal baffle, according to some non-limiting embodiments or aspects;

FIG. 5B is a cross-sectional view of the frozen drink maker shown in FIG. 5A, taken along line B-B;

FIG. 5C is a cross-sectional view of the frozen drink maker shown in FIG. 5A, taken along line C-C;

FIG. 6A is a rear isometric view of a mixing vessel for a frozen drink maker with three internal baffles, according to some non-limiting embodiments or aspects;

FIG. 6B is a rear view of the mixing vessel shown in FIG. 6A;

FIG. 6C is a front isometric view of the mixing vessel shown in FIG. 6A;

FIG. 7 is a diagram of the frozen drink maker positioned on a mounting surface, according to some non-limiting embodiments or aspects;

FIG. 8A is a perspective view of a first dasher configuration for use in a drink maker, according to some non-limiting embodiments or aspects;

FIG. 8B is a perspective view of a second dasher configuration for use in a drink maker, according to some non-limiting embodiments or aspects;

FIG. 8C is a perspective view of a third dasher configuration for use in a drink maker, according to some non-limiting embodiments or aspects;

FIG. 9A is a profile view of a first dasher configuration for use in a drink maker, according to some non-limiting embodiments or aspects;

FIG. 9B is a profile view of a second dasher configuration for use in a drink maker, according to some non-limiting embodiments or aspects;

FIG. 9C is a profile view of a third dasher configuration for use in a drink maker, according to some non-limiting embodiments or aspects;

FIG. 10A is a front view of a first dasher configuration for use in a drink maker, according to some non-limiting embodiments or aspects;

FIG. 10B is a front view of a second dasher configuration for use in a drink maker, according to some non-limiting embodiments or aspects;

FIG. 10C is a front view of a third dasher configuration for use in a drink maker, according to some non-limiting embodiments or aspects;

FIG. 11A is a close-up, side view of a front end of a first dasher configuration for use in a drink maker, according to some non-limiting embodiments or aspects;

FIG. 11B is a close-up, side view of a front end of a second dasher configuration for use in a drink maker, according to some non-limiting embodiments or aspects;

FIG. 11C is a close-up, side view of a front end of a third dasher configuration for use in a drink maker, according to some non-limiting embodiments or aspects;

FIG. 12A is a close-up, perspective view of a front end of a first dasher configuration for use in a drink maker, according to some non-limiting embodiments or aspects;

FIG. 12B is a close-up, perspective view of a front end of a second dasher configuration for use in a drink maker, according to some non-limiting embodiments or aspects;

FIG. 12C is a close-up, perspective view of a front end of a third dasher configuration for use in a drink maker, according to some non-limiting embodiments or aspects;

FIG. 13A is a front, perspective view of a mixing vessel having a pour-in opening to allow for ingress to a vessel chamber of the mixing vessel, according to some non-limiting embodiments or aspects;

FIG. 13B is a front view of a mixing vessel having a pour-in opening to allow for ingress to a vessel chamber of the mixing vessel, according to some non-limiting embodiments or aspects;

FIG. 14 is a front, perspective view in partial transparency of a mixing vessel having a pour-in opening, according to some non-limiting embodiments or aspects;

FIG. 15 is a diagram of an end cap of a mixing vessel having a surface, according to some non-limiting embodiments or aspects;

FIG. 16 is a left side view of a vertical, longitudinal cross-section of a mixing vessel having a pour-in opening, including an internal edge feature, according to some non-limiting embodiments or aspects;

FIG. 17 is a lower, front, perspective view of a vertical, longitudinal cross-section of a mixing vessel having a pour-in opening, including an internal edge feature, according to some non-limiting embodiments or aspects;

FIG. 18 is a bottom, rotated view of a horizontal, longitudinal cross-section of a mixing vessel having a pour-in opening, including an internal edge feature, according to some non-limiting embodiments or aspects;

FIG. 19 is a front view of a vertical, latitudinal cross-section of a mixing vessel having a pour-in opening, including an internal edge feature, according to some non-limiting embodiments or aspects;

FIG. 20A is a front, perspective view of a mixing vessel having a pour-in opening, according to some non-limiting embodiments or aspects;

FIG. 20B is a front view of a mixing vessel having a pour-in opening, according to some non-limiting embodiments or aspects;

FIG. 20C is a top view of a mixing vessel having a pour-in opening, according to some non-limiting embodiments or aspects;

FIG. 20D is a side view of a mixing vessel having a pour-in opening, according to some non-limiting embodiments or aspects;

FIG. 20E is a rear view of a mixing vessel having a pour-in opening, according to some non-limiting embodiments or aspects;

FIG. 20F is a bottom, tilted, rear, perspective view of a mixing vessel having a pour-in opening, according to some non-limiting embodiments or aspects;

FIG. 20G is a rear, bottom view of a mixing vessel having a pour-in opening, according to some non-limiting embodiments or aspects;

FIG. 21A is a side view of a vertical, longitudinal cross-section of a mixing vessel having a pour-in opening, according to some non-limiting embodiments or aspects;

FIG. 21B is a close-up view of an exterior protrusion of a mixing vessel, according to some non-limiting embodiments or aspects;

FIG. 21C is a close-up view of an interior protrusion of a mixing vessel, according to some non-limiting embodiments or aspects;

FIG. 21D is a close-up view of a flow-promotion feature and internal baffle of a mixing vessel, according to some non-limiting embodiments or aspects;

FIG. 21E is a close-up view of a pour-in opening of a mixing vessel, according to some non-limiting embodiments or aspects;

FIG. 22A is a perspective view of a drink maker with a mixing vessel having a pour-in opening enclosed by a cover, according to some non-limiting embodiments or aspects;

FIG. 22B is a perspective view of a drink maker with a mixing vessel having a pour-in opening enclosed by a cover, according to some non-limiting embodiments or aspects;

FIG. 23A is a close-up, perspective view of a mixing vessel having a pour-in opening enclosed by a cover, according to some non-limiting embodiments or aspects;

FIG. 23B is a close-up, perspective view of a mixing vessel having a pour-in opening enclosed by a cover, according to some non-limiting embodiments or aspects;

FIG. 24A is a perspective view of a cover for a pour-in opening, according to some non-limiting embodiments or aspects;

FIG. 24B is a perspective view of a cover for a pour-in opening, according to some non-limiting embodiments or aspects;

FIG. 25A is a bottom, perspective view of a cover for a pour-in opening, according to some non-limiting embodiments or aspects;

FIG. 25B is a bottom, perspective view of a cover for a pour-in opening, according to some non-limiting embodiments or aspects;

FIG. 25C is a bottom, perspective view of a cover for a pour-in opening, according to some non-limiting embodiments or aspects;

FIG. 26A is a side view of a dasher, according to some non-limiting embodiments or aspects;

FIG. 26B is a side-angle view of a dasher, according to some non-limiting embodiments or aspects;

FIG. 26C is a side-angle view of a dasher, according to some non-limiting embodiments or aspects;

FIG. 26D is a side-angle view of a dasher, according to some non-limiting embodiments or aspects;

FIG. 27 is a close-up, midline view of a dasher, according to some non-limiting embodiments or aspects;

FIG. 28 is a side-angle view of a dasher, according to some non-limiting embodiments or aspects;

FIG. 29A is a close-up, excerpt view of a dasher, according to some non-limiting embodiments or aspects;

FIG. 29B is a close-up, excerpt view of a dasher, according to some non-limiting embodiments or aspects;

FIG. 30 is a flow diagram of a method for controlling a drink maker, according to some non-limiting embodiments or aspects;

FIG. 31 is a close-up view of a zone of engagement between two gears in a gear assembly of a drink maker, according to some non-limiting embodiments or aspects;

FIG. 32A is a view of a planetary gear system configuration for a gear assembly of a drink maker, according to some non-limiting embodiments or aspects;

FIG. 32B is a close-up view of the planetary gear system configuration of FIG. 32A, according to some non-limiting embodiments or aspects;

FIG. 33 is a cross-sectional view of a mixing vessel of a drink maker, according to some non-limiting embodiments or aspects;

FIG. 34A is a cross-sectional view of a mixing vessel and dispenser assembly of a drink maker, according to some non-limiting embodiments or aspects;

FIG. 34B is a cross-sectional view of a mixing vessel and dispenser assembly of a drink maker, according to some non-limiting embodiments or aspects;

FIG. 34C is a cross-sectional view of a mixing vessel and dispenser assembly of a drink maker, according to some non-limiting embodiments or aspects;

FIG. 35A is a cross-sectional view of a mixing vessel and dispenser assembly of a drink maker, according to some non-limiting embodiments or aspects;

FIG. 35B is a front-end cross-sectional view of a drink maker, according to some non-limiting embodiments or aspects;

FIG. 36 is a perspective view of a condensation collection tray, according to some non-limiting embodiments or aspects;

FIG. 37A is a perspective view of a pour-in opening of a drink maker, according to some non-limiting embodiments or aspects;

FIG. 37B is a top-down view of the pour-in opening of FIG. 37A, according to some non-limiting embodiments or aspects;

FIG. 37C is a perspective view of a pour-in opening of a drink maker, according to some non-limiting embodiments or aspects;

FIG. 37D is a top-down view of the pour-in opening of FIG. 37C, according to some non-limiting embodiments or aspects; and

FIG. 37E is a perspective view of a pour-in opening of a drink maker, according to some non-limiting embodiments or aspects.

### DETAILED DESCRIPTION

In the following description, like components have the same reference numerals, regardless of different illustrated implementations. To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

The application, in various implementations, addresses deficiencies of existing frozen drink makers associated with controlling slush flow. Unfortunately, existing frozen drink makers must be very tall to provide sufficient headspace above the slush, so the slush does not contact the upper sidewalls of the vessel and the top of the chamber.

Accordingly, there is a need for features within the mixing chamber to effectively control the slush and keep it from migrating up the sidewalls and sticking to the top of the chamber. The need for controlling slush is especially important for household frozen drink makers (as compared to commercial models) because household frozen drink makers cannot rely on a tall chamber height to control slush flow.

The disclosed mixing vessels include at least one internal baffle (e.g., rib) positioned toward a front of the mixing chamber to optimize slush processing and flow within the vessel. The mixing vessel may include one, two, three, or more internal baffles to control slush flow. For example, the mixing vessel may include a first baffle (e.g., a “side baffle”) extending laterally along a sidewall of the vessel chamber, a second baffle (e.g., a “front baffle” positioned along a front surface of the vessel chamber, and/or a third baffle (e.g., a “corner baffle”) positioned at a front top side of the vessel chamber, optionally extending between the side baffle and the corner baffle, if present. In implementations in which the corner baffle, side baffle, and front baffle are each present, the corner baffle may physically join the side baffle and the front baffle. The one or more internal baffles are arranged to keep slush off of the upper sidewalls and top of the mixing vessel chamber. Without wishing to be bound by theory, implementations in which the mixing vessel includes a side baffle, a front baffle, and a corner baffle connecting the side baffle and the front baffle, all three baffles may work in tandem to direct contents within the mixing vessel away from the top of the vessel. In contrast to commercial frozen drink makers with a significant amount of headspace in the mixing chamber, the disclosed mixing vessels may have a much shorter chamber, meaning a shorter distance between the center axis of the dasher and the top of the mixing vessel to ensure the device can fit under a cabinet. The reduced chamber height of household frozen drink makers amplifies the need for precise slush control to keep slush from sticking to the upper sidewalls and top of the vessel, which can result in poor circulation, non-uniform dispensing, and product waste. Furthermore, the one or more baffles present in the vessel chamber may also deflect slush away from the chamber lid so that the lid does not get forced off, as in some commercial units.

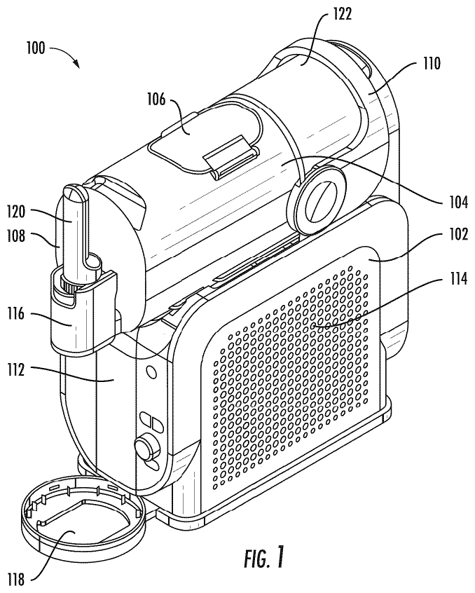

FIG. 1 shows a perspective view of a frozen drink maker 100, according to an illustrative implementation of the disclosure. The frozen drink maker 100 includes a housing 102 and mixing vessel 104. The housing 102 may include user interface 112 for receiving user inputs to control frozen drink maker 100 and/or to output or display information. User interface 112 may include one or more buttons, dials, switches, touchscreens, indicators, LEDs, and the like. User interface 112 may display status information including, for example, a temperature of a drink product within mixing vessel 104, an indicator of a recipe and/or program currently being implemented, a timer associated with the progress of a recipe and/or program in progress and/or currently being implemented. User interface 112 may provide indicators and/or warnings to users regarding, for example, when a recipe is complete or when a user is expected to perform an action associated with processing a drink product. User interface 112 may include a selectable menu of drink types (e.g., recipes) and/or programs for different types of drink products such as, without limitation, granita, smoothie, margarita, daiquiri, pina colada, slush, cocktail, frappé, juice, diary, milkshake, cool drink, semi-frozen drink, frozen drink, and the like.

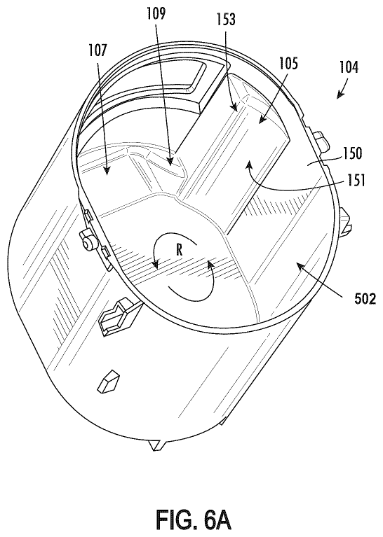

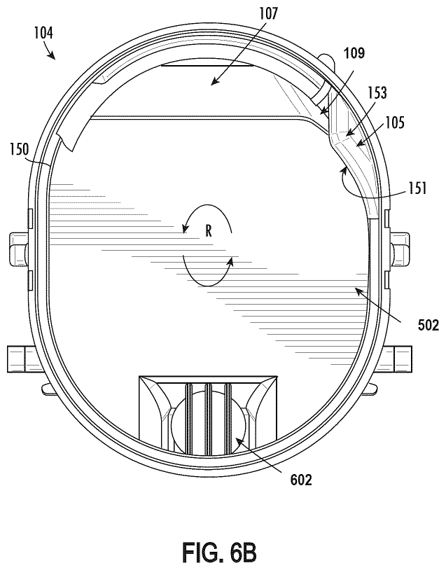

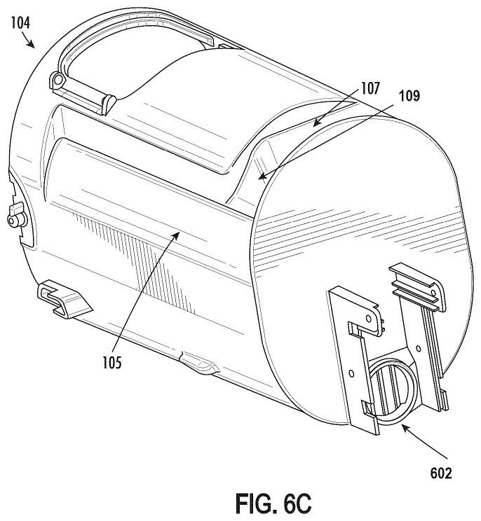

Housing 102 may include a panel (e.g., a removable panel) 114 along a side of the housing 102. Panel 114 may include a plurality of openings that facilitate air flow to aid in cooling components within housing 102. Housing 102 may include upper housing section 122 that is arranged to couple with a rear end of mixing vessel 104 when mixing vessel 104 is attached to housing 102. Mixing vessel 104 may include walls, or a portion thereof, that are transparent to enable a viewer to see a drink product within mixing vessel 104 during processing. Mixing vessel 104 may include pour-in opening 106 whereby mixing vessel 104 can receive ingredients for processing a drink product within mixing vessel 104. FIG. 1 shows pour-in opening 106 in a closed configuration with a cover sealing pour-in opening 106. The cover may be detachably removable or moveable to open or close pour-in opening 106. Pour-in opening 106 may include a grate to inhibit a user from reaching into mixing vessel 104 when pour-in opening 106 is open, e.g., the cover is not installed. Mixing vessel 104 may include dispenser assembly 108 having user handle 120, a spout (not shown), and a spout shroud and/or cover 116. Dispenser assembly 108 enables a user, by pulling down on handle 120, to open a spout, connected to a wall of mixing vessel 104, to dispense a processed (e.g., cooled) drink product from mixing vessel 104. The user can close the spout by pushing handle 120 back to its upright position (shown in FIG. 1) and, thereby, stop the dispensing of the processed drink product. In some non-limiting embodiments or aspects, operation of user handle 120 of dispenser assembly 108 may allow a drink product to be released from mixing vessel 104 through an outlet (e.g., outlet 602 shown and described with regard to FIGS. 6B and 6C) of mixing vessel 104.

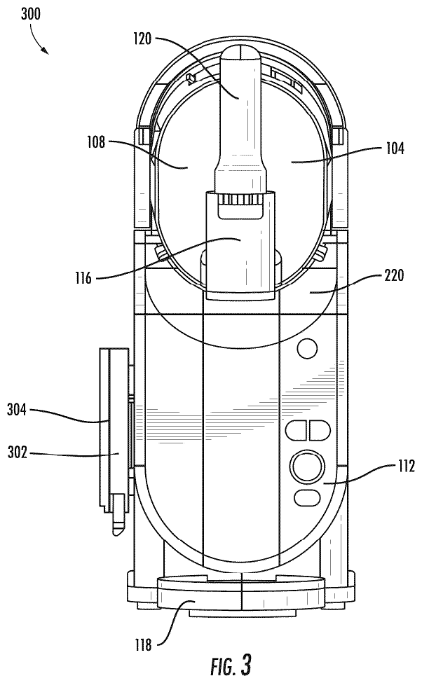

Frozen drink maker 100 may include lever 110 that enables a locked coupling of mixing vessel 104 to housing 102 including upper housing section 122. FIG. 1 shows lever 110 in the locked and/or closed position whereby mixing vessel 104 is engaged and/or coupled to housing 102 and upper housing section 122. In the closed and/or engaged position, lever 110 ensures that there is a water-tight seal to reduce/prevent leakage of drink product from mixing vessel 104. Lever 110 may be placed in the closed, coupled, and/or engaged position by sliding mixing vessel 104 against upper housing section 122 and then rotating lever 110 in a clockwise direction until its handle rests on or about the top surface of upper housing section 122. Mixing vessel 104 can be disengaged and/or decoupled from housing 102 and upper housing section 122 by pulling and/or rotating lever 110 in a counter-clockwise direction (from the perspective of FIG. 1) toward the front of mixing vessel 104, which causes lever 110 to release mixing vessel 104. Once released and/or decoupled, mixing vessel 104 may slide in a forward direction (away from upper housing section 122) to be fully detached and/or removed from housing 102. Mixing vessel 104 may include a radial seal and/or face seal. The face seal may provide an improved seal based on compression provided by lever 110 pushing mixing vessel 104 laterally against a wall of upper housing section 122. Mixing vessel 104 may include a circular and/or cylindrical opening at its rear end that couples mixing vessel 104 to upper housing section 122. An interlock switch may be implemented at upper housing section 122 that is activated when mixing vessel 104 is coupled to upper housing section 122 that prevents activation of drive motor 208 unless mixing vessel 104 is coupled to upper housing section 122. This ensures that a user is not exposed to moving dasher 204. Frozen drink maker 100 may also include drip tray 118 being positioned below dispenser assembly 108 and arranged to collect any drink product that is not properly dispensed from mixing vessel 104 to, for example, a user cup. Drip tray 118 may be attachably removable from its operational position shown in FIG. 1. For example, drip tray 118 may be mounted and/or stored on a side panel of housing 102, as illustrated in FIG. 3 as drip tray 304.

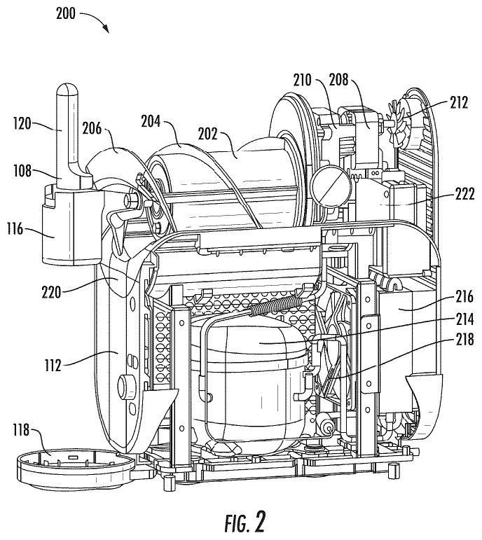

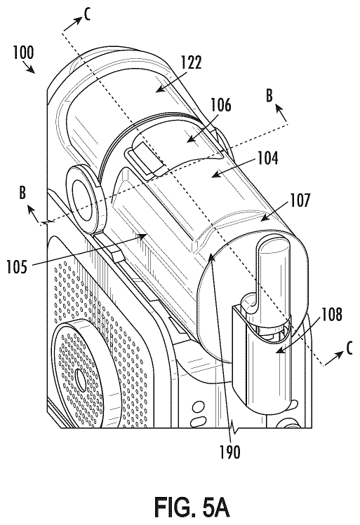

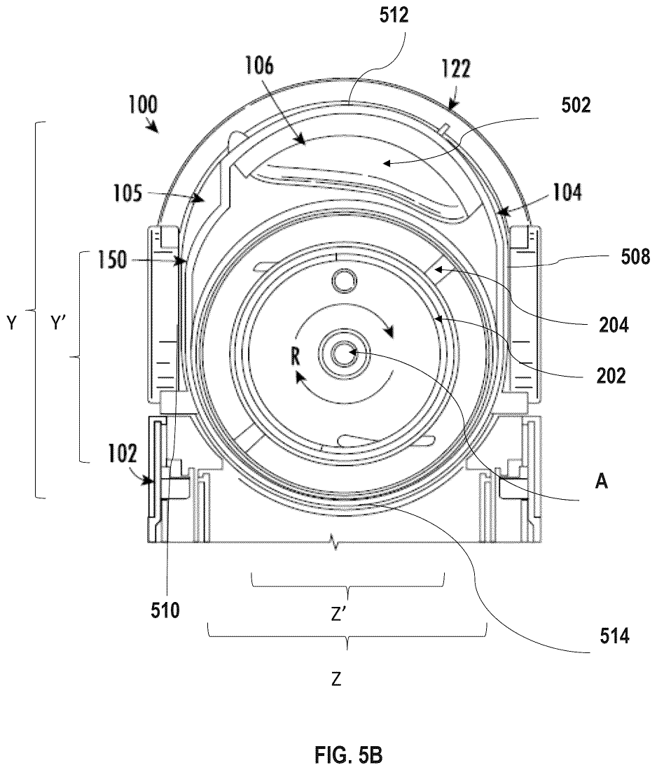

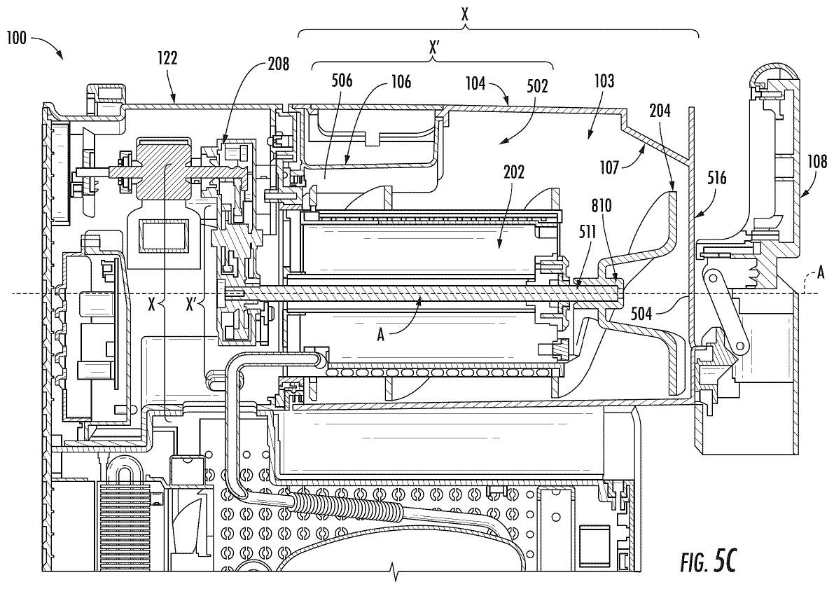

FIG. 2 shows view 200 of various internal components within housing 102 and mixing vessel 104 of frozen drink maker 100 of FIG. 1. Frozen drink maker 100 includes cylindrical evaporator 202 that is surrounded by dasher 204. Dasher 204 may include one or more mixing blades and/or protrusions that extend helically around evaporator 202 (e.g., chiller). In some non-limiting embodiments or aspects, dasher 204 may include an auger. Dasher 204 may be driven to rotate by a central drive shaft (see FIG. 5C) within mixing vessel 104. The drive shaft may be surrounded by evaporator 202. However, in various implementations, evaporator 202 does not rotate. The drive shaft may be coupled via gear assembly 210 to drive motor 208. In some non-limiting embodiments or aspects, drive motor 208 is an AC motor, but another type of motor may be used such as, without limitation, a DC motor. Drive motor 208 may include motor fan 212 arranged to provide air cooling for drive motor 208. While FIG. 2 shows an implementation where drive motor 208 is not coaxially aligned with the drive shaft used to rotate dasher 204, in other implementations, drive motor 208 can be aligned coaxially with the drive shaft. During processing of a drink product, drive motor 208 may be continuously operated at one or more speeds to drive continuous rotation of dasher 204 and, thereby, provide continuous processing (e.g., scraping, mixing, churning, pushing, etc.) of the drink product within mixing vessel 104. In some non-limiting embodiments or aspects, the rotation of dasher 204 causes the helically arranged blades to push the cooling drink product to the front of mixing vessel 104. During the processing, portions of the drink product may freeze against the surface of evaporator 202 as a result of being cooled by evaporator 202. In some non-limiting embodiments or aspects, the blades of rotating dasher 204 scrape frozen portions of the drink product from the surface of evaporator 202 while concurrently mixing and pushing the cooling drink product towards the front of mixing vessel 104.

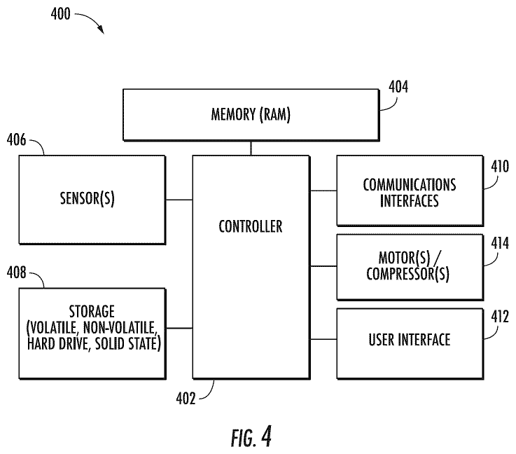

Frozen drink maker 100 may include a cooling circuit and/or system to provide cooling of a drink product and/or to control the temperature of a drink product within mixing vessel 104. The cooling circuit may include compressor 214, evaporator 202, condenser 216, condenser fan 218, bypass valve, and conduit that carries refrigerant in a closed loop among the cooling circuit components. Operations of the cooling circuit may be controlled by a controller, such as controller (e.g., processor) 402, as described further with respect to FIG. 4 later herein. Frozen drink maker 100 may also include condensation collection tray 220 arranged to collect any liquid condensation caused by cooling from evaporator 202. FIG. 2 shows tray 220 in the inserted position. Tray 220 may be insertably removable from a slot within housing 102 to enable collection of condensed liquid when inserted into the slot and then efficient removal to empty tray 220, and then re-insertion into the slot for subsequent liquid collection. In some non-limiting embodiments, tray 220 may include a spout (e.g., a pour spout, a lip, such as a water guide lip, etc.) to direct a liquid from tray 220 as a user empties tray 220. The spout may be positioned on an end of tray 220 that is opposite a handle (e.g., a handle formed in tray 220). For example, the spout may be attached (e.g., integrally formed) on an end (e.g., rear end) of tray 220 that is opposite to an end (e.g., front end) of tray 220 that is adjacent dispenser assembly 108 when tray 220 is in the inserted position.

FIG. 3 shows front view 300 of frozen drink maker 100 of FIG. 1. Frozen drink maker 100 may include user interface 112 on a front surface of housing 102. In other implementations, user interface 112 may be located on a side, top, or back of housing 102. Frozen drink maker 100 may include mount 302 on a side of housing 102 where drip tray 118 can be mounted when not in use (shown as drip tray 304 in FIG. 3), such as during transport of frozen drink maker 100. Frozen drink maker 100 may include a power interface arranged to receive AC power from a power outlet (not shown). In some non-limiting embodiments or aspects, frozen drink maker 100 may include one or more batteries housed within housing 102 and arranged to provide power to various components of frozen drink maker 100. Frozen drink maker 100 may also include printed circuit board assembly (PCBA) 222 within housing 102. As will be explained with respect to FIG. 4, PCBA 222 may include control system 400 arranged to automatically control certain operations of frozen drink maker 100.

FIG. 4 is a block diagram illustrating an example of control system 400 of frozen drink maker 100, according to some implementations of the disclosure. Control system 400 may include a microcontroller, a processor, a system-on-a-chip (SoC), a client device, and a physical computing device. In some non-limiting embodiments or aspects, control system 400 may include a hardware processor and/or virtual processor(s). In some non-limiting embodiments or aspects, control system 400 and elements, as shown in FIG. 4, each relate to physical hardware, while in some non-limiting embodiments or aspects, one, more, or all of the elements could be implemented using emulators or virtual machines. In some non-limiting embodiments or aspects, control system 400 may be implemented on physical hardware, such as in frozen drink maker 100.

As also shown in FIG. 4, control system 400 may include user interface 412 and/or 112, having, for example, a keyboard, keypad, one or more buttons, dials, touchpad, or sensor readout (e.g., biometric scanner), and one or more output devices, such as displays, speakers for audio, LED indicators, and/or light indicators. Control system 400 may also include communications interfaces 410, such as a network communication unit that could include a wired communication component and/or a wireless communications component, which may be communicatively coupled to controller 402. The network communication unit may utilize any of a variety of proprietary or standardized network protocols, such as Ethernet, TCP/IP, to name a few of many protocols, to effect communications between controller 402 and another device, network, or system. Network communication units may also comprise one or more transceivers that utilize the Ethernet, power line communication (PLC), Wi-Fi, cellular, and/or other communication methods. For example, control system 400 may send one or more communications associated with a status of frozen drink maker 100 to a mobile device of a user, e.g., send an alert to the mobile device when a recipe is complete and/or a drink product is ready for dispensing, or to indicate that the mixing vessel is low or out of a drink product.

Control system 400 may include a processing element, such as controller 402, which may contain one or more hardware processors, where each hardware processor may have a single or multiple processor cores. In one implementation, controller 402 includes at least one shared cache that stores data (e.g., computing instructions) that are utilized by one or more other components of controller 402. For example, the shared cache may be a locally cached data stored in a memory for faster access by components of the processing elements that make up controller 402. Examples of processors include, but are not limited to, a central processing unit (CPU) and/or microprocessor. Controller 402 may utilize a computer architecture based on, without limitation, the Intel® 8051 architecture, Motorola® 68HCX, Intel® 80X86, and the like. Controller 402 may include, without limitation, an 8-bit, 12-bit, 16-bit, 32-bit, or 64-bit architecture. Although not illustrated in FIG. 4, the processing elements that make up controller 402 may also include one or more other types of hardware processing components, such as graphics processing units (GPUs), application specific integrated circuits (ASICs), field-programmable gate arrays (FPGAs), and/or digital signal processors (DSPs).

FIG. 4 also illustrates that memory 404 may be operatively and communicatively coupled to controller 402. Memory 404 may be a non-transitory medium configured to store various types of data. For example, memory 404 may include one or more storage devices 408 that include a non-volatile storage device and/or volatile memory. Volatile memory, such as random-access memory (RAM), can be any suitable non-permanent storage device. The non-volatile storage devices 408 may include one or more disk drives, optical drives, solid-state drives (SSDs), tape drives, flash memory, read-only memory (ROM), and/or any other type of memory designed to maintain data for a duration time after a power loss or shut down operation. In certain configurations, the non-volatile storage devices 408 may be used to store overflow data if allocated RAM is not large enough to hold all working data. The non-volatile storage devices 408 may also be used to store programs that are loaded into the RAM when such programs are selected for execution. Data store and/or storage devices 408 may be arranged to store a plurality of drink product making and/or processing instruction programs associated with a plurality of drink product processing sequences, e.g., recipes. Such drink product making and/or processing instruction programs may include instruction for controller 402 to: start or stop one or more motors and/or compressors 414 (e.g., such as drive motor 208 and/or compressor 214), start or stop compressor 214 to regulate a temperature of a drink product being processed within mixing vessel 104, operate the one or more motors and/or compressors 414 (e.g., drive motor 208 and/or compressor 214) at certain periods during a particular drink product processing sequence, operate drive motor 208 at certain speeds during certain periods of time of a recipe, issue one or more cue instructions to user interface 412 and/or 112 that are output to a user to illicit a response, action, and/or input from the user.

Persons of ordinary skill in the art are aware that software programs may be developed, encoded, and compiled in a variety of computing languages for a variety of software platforms and/or operating systems and subsequently loaded and executed by controller 402. In one implementation, the compiling process of the software program may transform program code written in a programming language to another computer language such that controller 402 is able to execute the programming code. For example, the compiling process of the software program may generate an executable program that provides encoded instructions (e.g., machine code instructions) for controller 402 to accomplish specific, non-generic, particular computing functions.

After the compiling process, the encoded instructions may be loaded as computer executable instructions or process steps to controller 402 from storage device 408, from memory 404, and/or embedded within controller 402 (e.g., via a cache or on-board ROM). Controller 402 may be configured to execute the stored instructions or process steps in order to perform instructions or process steps to transform the electronic control system 400 into a non-generic, particular, specially programmed machine or apparatus. Stored data, e.g., data stored by a data store and/or storage device 408, may be accessed by controller 402 during the execution of computer executable instructions or process steps to instruct one or more components within control system 400 and/or other components or devices external to system 400. For example, the recipes may be arranged in a lookup table and/or database within data storage device 408 and be accessed by controller 402 when executing a particular recipe selected by a user via user interface 412 and/or 112.

User interface 412 and/or 112 can include a display, positional input device (such as a mouse, touchpad, touchscreen, or the like), keyboard, keypad, one or more buttons, one or more dials, a microphone, speaker, or other forms of user input and output devices. The user interface components may be communicatively coupled to controller 402. When the user interface output device is or includes a display, the display can be implemented in various ways, including by a liquid crystal display (LCD) or a cathode-ray tube (CRT) or light emitting diode (LED) display, such as an OLED display.

Sensors 406 may include one or more sensors that detect and/or monitor conditions of a drink product within mixing vessel 104, conditions associated with a component of frozen drink maker 100, and/or conditions of a refrigerant within the refrigeration system. Conditions may include, without limitation, rotation, speed of rotation, and/or movement of a device or component (e.g., a motor), rate of such movement, frequency of such movement, direction of such movements, motor current, motor voltage, motor power, motor torque, temperature, pressure, fluid level in mixing vessel 104, position of a device or component (e.g., whether pour-in opening 106 is open or closed), and/or the presence of a device or component (e.g., whether shroud 116 is installed or not). Types of sensors may include, for example, electrical metering chips, Hall sensors, pressure sensors, temperature sensors, optical sensors, current sensors, torque sensors, voltage sensors, cameras, other types of sensors, or any suitable combination of the foregoing. Frozen drink maker 100 may include one or more temperature sensors positioned in various locations within mixing vessel 104 such as, for example, on or about the lower front area within mixing vessel 104, on or about the upper front area within mixing vessel 104, on or about the upper rear area within mixing vessel 104, within one or more coils of evaporator 202, and/or within housing 102.

Sensors 406 may also include one or more safety and/or interlock switches that prevent or enable operation of certain components, e.g., a motor, when certain conditions are met (e.g., enabling activation of motor and/or compressor 414 when a lid or cover for opening 106 is attached or closed and/or when a sufficient level of drink product is in mixing vessel 104). Persons of ordinary skill in the art are aware that electronic control system 400 may include other components well known in the art, such as power sources and/or analog-to-digital converters, not explicitly shown in FIG. 4.

In some non-limiting embodiments or aspects, control system 400 and/or controller 402 includes an SoC having multiple hardware components, including but not limited to: a microcontroller, microprocessor or digital signal processor (DSP) core and/or multiprocessor SoCs (MPSoC) having more than one processor cores; memory blocks including a selection of read-only memory (ROM), random access memory (RAM), electronically erasable programmable read-only memory (EEPROM) and flash memory; timing sources including oscillators and phase-docked loops; peripherals including counter-timers, real-time timers and power-on reset generators; external interfaces, including industry standards such as universal serial bus (USB), FireWire, Ethernet, universal synchronous/asynchronous receiver/transmitter (USART), serial peripheral interface (SPI); analog interfaces including analog-to-digital converters (ADCs) and digital-to-analog converters (DACs); and voltage regulators and power management circuits.

A SOC includes both the hardware, described above, and software controlling the microcontroller, microprocessor and/or DSP cores, peripherals and interfaces. Most SoCs are developed from pre-qualified hardware blocks for the hardware elements (e.g., referred to as modules or components which represent an IP core or IP block), together with software drivers that control their operation. The above listing of hardware elements is not exhaustive. A SOC may include protocol stacks that drive industry-standard interfaces like a universal serial bus (USB).

Once the overall architecture of the SoC has been defined, individual hardware elements may be described in an abstract language called RTL, which stands for register-transfer level. RTL is used to define the circuit behavior. Hardware elements are connected together in the same RTL language to create the full SoC design. In digital circuit design, RTL is a design abstraction which models a synchronous digital circuit in terms of the flow of digital signals (data) between hardware registers, and the logical operations performed on those signals. RTL abstraction is used in hardware description languages (HDLs) like Verilog and VHDL to create high-level representations of a circuit, from which lower-level representations and ultimately actual wiring can be derived. Design at the RTL level is typical practice in modern digital design. Verilog is standardized as Institute of Electrical and Electronic Engineers (IEEE) 1364 and is an HDL used to model electronic systems. Verilog is most commonly used in the design and verification of digital circuits at the RTL level of abstraction. Verilog may also be used in the verification of analog circuits and mixed-signal circuits, as well as in the design of genetic circuits. In some non-limiting embodiments or aspects, various components of control system 400 are implemented on a PCBA such as PCBA 222.

In operation in certain implementations, a user fills mixing vessel 104 via pour-in opening 106 with ingredients associated with a drink product. The user selects the type of drink product to be processed via user interface 112, e.g., the user selects the recipe for “margarita.” In some non-limiting embodiments or aspects, the user selects the product type and/or recipe before filling mixing vessel 104 and user interface 112 provides one or more indicators or queues (visible and/or audible) that instruct the user to add ingredients to mixing vessel 104. Mixing vessel 104 may include one or more fill sensors that detect when a sufficient amount or level of ingredients and/or fluid is within mixing vessel 104. The one or more fill sensors may provide a signal to controller 402 that indicates when mixing vessel 104 is sufficiently filled or not filled. Controller 402 may prevent operations of frozen drink maker 100 (e.g., prevent activation of drive motor 208 and/or other components) if the fill sensor(s) 406 indicate that mixing vessel 104 is not sufficiently filled. A lid sensor may be associated with pour-in opening 106 whereby the lid sensor sends an open and/or closed signal to controller 402 that indicates whether pour-in opening 106 is open or closed. Controller 402 may prevent operations of frozen drink maker 100 if the lid sensor indicates that pour-in opening 106 is open and/or not closed. Depending on the sensed condition, user interface 112 may provide an indication regarding the condition, e.g., that mixing vessel 104 is sufficiently filled or not sufficiently filled and/or that opening 106 is not closed, to enable a user to take appropriate action(s).

Once mixing vessel 104 is filled with ingredients, the user may provide an input, e.g., a button press, to start processing of the drink product based on the selected recipe. Processing may include activation of drive motor 208 to drive rotation of dasher 204 and/or blade 206 to effect mixing of the ingredients of the drink product. Processing may also include activation of the refrigeration system including activation of compressor 214 and condenser fan 218. The compressor 214 facilitates refrigerant flow through one or more coils of evaporator 202 and through condenser 216 to provide cooling and/or temperature control of the drink product within mixing vessel 104. Controller 402 may control operations of various components, such as drive motor 208 and compressor 214. To regulate temperature at a particular setting associated with a recipe, controller 402 may activate/start and/or de-activate/stop compressor 214 to start and/or stop refrigerant flow through the coil(s) of evaporator 202 and, thereby, start or stop cooling of the drink product within mixing vessel 104.

By cooling a drink product to a particular temperature, slush and/or ice particles may be formed within the drink product. Typically, the amount of particles and/or texture of a drink product corresponds to a temperature of the drink product, e.g., the cooler the temperature—the larger the amount of particles (and/or the larger the size of particles) and/or the more slushed the drink product. User interface 112 may enable a user to fine tune and/or adjust a preset temperature associated with a recipe to enable a user to adjust the temperature and/or texture of a drink product to a more desirable temperature and/or texture.

Controller 402 may perform processing of the drink product for a set period of time in one or more phases and/or until a desired temperature and/or texture is determined. Controller 402 may receive one or more temperature signals from one or more temperature sensors 406 within mixing vessel 104 to determine the temperature of the drink product. Controller 402 may determine the temperature of the drink product by determining an average temperature among temperatures detected by multiple temperature sensors 406. Controller 402 may determine the temperature of the drink product based on the detected temperature from one sensor 406 within mixing vessel 104 and/or based on a temperature of the refrigerant detected by a refrigerant temperature sensor 406. Once a phase and/or sequence of a recipe is determined to be completed by controller 402, controller 402 may, via user interface 112, provide a visual and/or audio indication that the recipe is complete and ready for dispensing. In response, a user may place a cup or container below dispenser assembly 108 and pull handle 120 rotationally downward towards the user to open a spout located at the lower front wall of mixing vessel 104, resulting in dispensing of the drink product into the cup or container. Once filled, the user can close the spout by pushing handle 120 back rotationally upward away from the user to its upright position shown in FIG. 2.

FIGS. 5A-5C show a sample frozen drink maker 100 with mixing vessel 104 coupled to housing 102 (specifically, upper housing section 122) and dispenser assembly 108, according to some implementations. Mixing vessel 104 has a curved sidewall defining vessel chamber 502 within. In some non-limiting embodiments or aspects, vessel chamber 502 may be at least partly cylindrical. For example, in some non-limiting embodiments or aspects, vessel chamber 502 may be substantially cylindrical. As shown in FIGS. 5B and 5C, vessel chamber 502 may include a front 504, a rear 506, a right side 508, a left side 510, a top, and a bottom.

In some non-limiting embodiments or aspects, mixing vessel 104 is shaped as an ovoid or approximately as an ovoid (e.g., a cylinder with an ovular cross-section), or as an elliptic cylinder (e.g., a cylinder with an elliptic cross-section), or an approximate elliptic cylinder. When coupled to housing 102, the front of mixing vessel 104 contacts dispenser assembly 108 and the rear of mixing vessel 104 abuts upper housing section 122. Within mixing vessel 104, the front face of the chamber may have a substantially ovular shape or a substantially circular shape. The rear of vessel chamber 502 of mixing vessel 104 may include an opening configured to form a seal with upper housing section 122. The opening at the rear of mixing vessel 104 may have a substantially circular shape or a substantially ovular shape. Mixing vessel 104 is sized to accommodate dasher 204 that rotates about a center axis (shown as center axis “A” in FIG. 5C). FIG. 5B shows a possible direction of dasher 204 rotation (“R”). Mixing vessel 104 may be shaped such that a distance from the center axis (A) of dasher 204 to the top of vessel chamber 502 is less than 6 inches, less than 8 inches, less than 10 inches, less than 12 inches, less than 14 inches, or less than 16 inches.

In some non-limiting embodiments or aspects, mixing vessel 104 may include at least one asymmetric wall. In some non-limiting embodiments or aspects, the at least one asymmetric wall may be proximate to at least one of the front 504 or the top of vessel chamber 502. In this way, the at least one asymmetric wall may be configured to promote slush flow within vessel chamber 502 of mixing vessel 104. In some non-limiting embodiments or aspects, the at least one asymmetric wall may be positioned such that dasher 204 directs a drink product toward the at least one asymmetric wall while moving the drink product upwardly within vessel chamber 502 of mixing vessel 104.

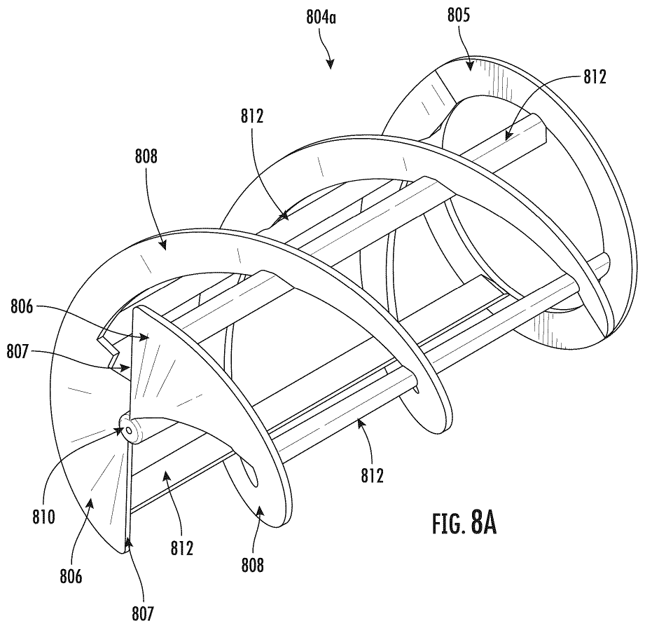

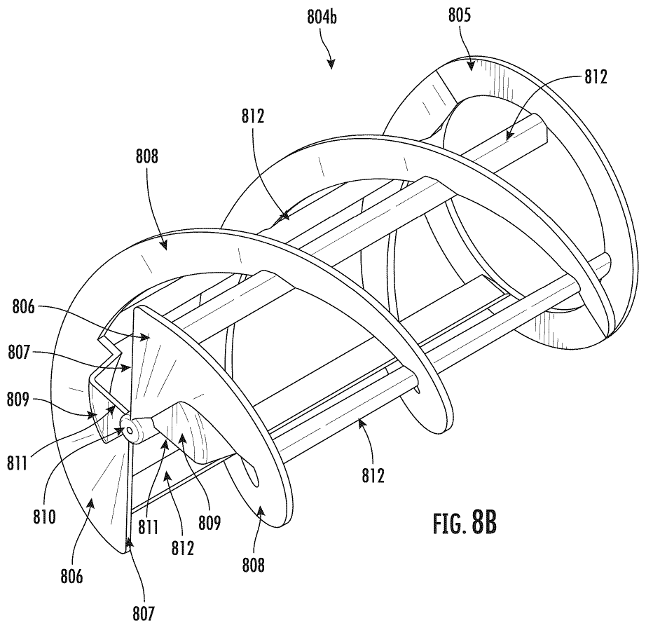

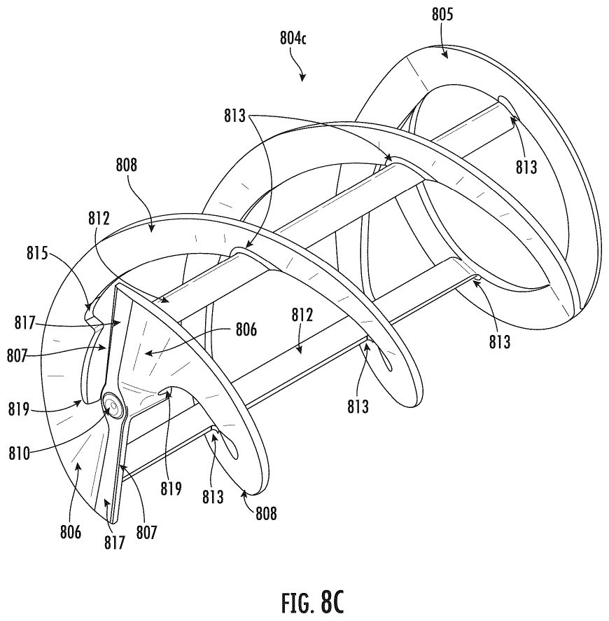

In some non-limiting embodiments or aspects, and as shown in FIG. 5C, drive motor 208 may cause dasher 204 to turn by way of drive shaft 511. Drive shaft 511 may extend lengthwise along axis A, connecting to drive motor 208 on a first end and to dasher 204 on a second end. The connection between drive motor 208 and dasher 204 may be completed with a central hub 810 of dasher 204 (see FIGS. 8A-12B for further detail). Central hub 810 may seat onto an end of drive shaft 511, directly or via a coupling extending from drive shaft 511 through an end surface of evaporator 202. Power from drive motor 208 may cause drive shaft 511 to rotate about axis A, which may impart the rotational force, at least partly, to central hub 810 of dasher 204, which may cause dasher 204 to rotate about axis A. In some non-limiting embodiments or aspects, central hub 810 may have a length that is shorter than a length of dasher 204 (e.g., extending only along a frontmost portion of dasher 204), such as in embodiments where the drink maker includes an internal evaporator positioned in a processing chamber of the mixing vessel. In some non-limiting embodiments or aspects, central hub 810 may have a length that is longer than half a length of dasher 204 or greater (e.g., approximately the length of dasher 204), such as in embodiments where the drink maker includes an external evaporator positioned outside a processing chamber of the mixing vessel. In some non-limiting embodiments, central hub 810 may have an internal shape for connecting to a drive shaft (e.g., drive shaft 511). For example, the internal shape of central hub 810 may include an indentation with three ribs that is configured to receive a corresponding shape at an end of the drive shaft. In this way, the internal shape may more evenly distribute force applied to central 810 (and the dasher) by the driver shaft and/or provide for optimized manufacturing (e.g., injection molding) of the dasher.

FIGS. 6A-6C show an example of mixing vessel 104 with the at least one asymmetric wall including at least one internal baffle configured to control slush flow within mixing vessel 104. As shown in FIGS. 5A, 5B, 6A, and 6B, mixing vessel 104 may include side baffle 105 on the at least one asymmetric wall. In some non-limiting embodiments or aspects, side baffle 105 may extend laterally along sidewall 150 of vessel chamber 502. In some non-limiting embodiments or aspects, side baffle 105 extends from the front of vessel chamber 502 (or approximate thereto) to the rear of vessel chamber 502 (or approximate thereto). In some non-limiting embodiments or aspects, side baffle 105 extends along the chamber sidewall in a direction parallel to the center axis (A) of dasher 204. In some non-limiting embodiments or aspects, side baffle 105 is positioned on a left side (when viewed from the front) of the chamber sidewall (e.g., in embodiments in which the dasher rotates in a clockwise direction). FIGS. 6A and 6C illustrate a clockwise direction of dasher rotation (R) when viewed from the front. Side baffle 105 may be positioned slightly above the center axis (A) of dasher 204, in some non-limiting embodiments or aspects.

Side baffle 105 may include curved surface 151 that conforms to the pathway of dasher 204, as shown in FIGS. 6A and 6B. For example, when viewed along the center axis (A) of dasher 204, side baffle 105 may protrude inwardly relative the ovular (e.g., elliptical) cross-section of chamber sidewall 150, where, starting from a bottom end of side baffle 105 at which curved surface 151 of side baffle 105 is vertical or substantially vertical, curved surface 151 may slope gradually inward until reaching inflection point 153. After reaching inflection point 153, curved surface 151 may slope more sharply vertically until the top end of side baffle 105 is reached and, thereafter, curved surface 151 of side baffle 105 returns to a curvature in conformance with the ovular cross-section of chamber sidewall 150. The radial direction of curved surface 151 of side baffle 105 from its bottom to inflection point 153 is generally aligned with the radial movement of dasher 204 and thus the contents of vessel chamber 502. The cross-sectional geometry of side baffle 105 described above directs the contents of vessel chamber 502 away from a top of vessel chamber 502 (e.g., at a lower radial trajectory than if side baffle 105 was not present, such as right side 508 of vessel chamber 502, as shown in FIG. 5B). If side baffle 105 was not present, contents of vessel chamber 502 could flow unimpeded up sidewall 150 to a top interior surface of vessel chamber 502, which would leave these contents excluded from mixing and/or allow them to escape from mixing vessel 104. Side baffle 105, thus, reduces the amount of frozen material that could otherwise form on the top interior surface of mixing vessel 104 as a result of its contents being rotated upwards.

In some non-limiting embodiments or aspects, side baffle 105 may extend laterally along left side 510 or right side 508 of vessel chamber 502. Side baffle 105 may be configured to promote slush flow away from left side 510 or right side 508 of vessel chamber 502 and back toward center axis A.

As shown in FIGS. 5B, 5C, and 6A-C, mixing vessel 104 may include front baffle 107 as the at least one asymmetric wall. If present, front baffle 107 may be positioned at a front top portion of vessel chamber 502 (illustrated in FIG. 5B). In some non-limiting embodiments or aspects, front baffle 107 extends along the front face of vessel chamber 502 between the right sidewall and the left sidewall of vessel chamber 502. The rotation of dasher 204 pushes vessel contents towards the front of vessel chamber 502, where, if left unchecked, contents could build up near the top front, perhaps even creating a frozen mass detrimental to the mixing process. Viewing from the cross-section of FIG. 5C, front baffle 107 may form an angle relative the front face of vessel chamber 502 (e.g., 100°-150°, 100°-125°, or 105°-120°), which redirects vessel contents that have been forced into the top front of mixing vessel 104 towards the rear of vessel chamber 502. In some non-limiting embodiments or aspects, front baffle 107 may include a curved surface extending upwardly from the front face of vessel chamber 502 toward top 512 of vessel chamber 502. In some such implementations, the angle of front baffle 107 forms relative to front 504 of vessel chamber 502 varies from a lower angle (e.g., 5°-20°) at a section of front baffle 107 proximate to the front face of vessel chamber 502 to a higher angle (e.g., 75°-90°) at a section of front baffle 507 proximate to the top of vessel chamber 502.

Front baffle 107 is configured to urge contents away from the top surface of vessel chamber 502 to avoid buildup and overflow on the top of mixing vessel 104. Front baffle 107, thus, reduces the amount of frozen material that could otherwise form on the top front interior surface of mixing vessel 104 as a result of the action of dasher 204. In some non-limiting embodiments or aspects, front baffle 107 may be positioned at an intersection of front 504 and top 512 of vessel chamber 502. Front baffle 107 may be configured to promote slush flow away from the intersection of front 504 and top 512 of vessel chamber 502 and back toward center axis A.

As further shown in FIGS. 5B and 5C, vessel chamber 502 of mixing vessel 104 of drink maker 100 may have first dimension X, second dimension Y, and third dimension Z, and dasher 204 may have first dimension X′, second dimension Y′, and third dimension Z′. In some non-limiting embodiments or aspects, first dimension X and X′ may refer to a length of vessel chamber 502 of mixing vessel 104 and a length of dasher 204, respectively, second dimension Y and Y′ may refer to a height of vessel chamber 502 of mixing vessel 104 and a height of dasher 204, respectively, and third dimension Z and Z′ may refer to a width of vessel chamber 502 of mixing vessel 104 and a width of dasher 204, respectively. In some non-limiting embodiments or aspects, a height (e.g., a total height) Y of vessel chamber 502 may be less than or equal to 180% of a height (e.g., a total height) Y′ of dasher 204. In some non-limiting embodiments or aspects, a width (e.g., a total width) Z of vessel chamber 502 is less than or equal to 140% of a width (e.g., a total width) Z′ of dasher 204. In some non-limiting embodiments or aspects, a length (e.g., a total length) X of vessel chamber 502 may be less than or equal to 120% of a length (e.g., a total length) X′ of the dasher.

As shown in FIGS. 5C and 6A-6C, mixing vessel 104 may include corner baffle 109 as the at least one asymmetric wall. Corner baffle 109 may be positioned at a front top side of vessel chamber 502. Corner baffle 109 joins or connects side baffle 105 and front baffle 107. Thus, if side baffle 105, front baffle 107, and corner baffle 109 are each present, corner baffle 109 physically joins side baffle 105 to front baffle 107. As shown in FIGS. 6A and 6B, side baffle 105 and front baffle 107 are orthogonal to each other and if these baffles terminated in a hard corner without corner baffle 109, slush may not be properly directed. Connecting side baffle 105 and front baffle 107 with corner baffle 109 allows slush to easily flow out of the corner between side baffle 105 and front baffle 107.

Corner baffle 109 has curved surface 155 that extends from side baffle 105 to front baffle 107. Curved surface 155 may be convex, as shown in FIG. 6A. Along its length, corner baffle 109 extends into vessel chamber 502 at a relatively constant distance. In other words, the depth of corner baffle 109 may be relatively constant along the length of corner baffle 109. The side of vessel chamber 502 in which corner baffle 109 is positioned (e.g., the left side or the right side) can be selected based on the direction in which dasher 204 rotates within mixing vessel 104. In particular, corner baffle 109 may be positioned such that dasher 204 is directed toward corner baffle 109 while moving upwardly within vessel chamber 502. For example, in select implementations, corner baffle 109 is positioned at the left top front of vessel chamber 502 when dasher 204 is arranged to rotate in a clockwise direction. This positioning may advantageously force slush downward toward dasher 204 when the slush contacts corner baffle 109 as the slush moves upwardly with dasher 204, thereby reducing slush buildup on the sidewall and the top of mixing vessel 104.

In some non-limiting embodiments or aspects, corner baffle 109 may be positioned proximate to an intersection of front 504 and top 512 of vessel chamber 502 and positioned proximate to right side 508 or left side 510 of vessel chamber 502. Corner baffle 109 may be configured to promote slush flow away from a corner of vessel chamber 502 and back toward center axis A.

It should be understood that, in some non-limiting embodiments or aspects, mixing vessel 104 includes one, two, three, or more internal baffles positioned within vessel chamber 502. In other words, mixing vessel 104 may include side baffle 105, front baffle 107, and/or corner baffle 109. Side baffle 105, front baffle 107, and/or corner baffle 109 can reduce slush buildup on the sidewalls and top of vessel chamber 502, which is important for commercial frozen drink makers, as well as household frozen drink makers with significantly less headspace than commercial units.

As further shown in FIGS. 6B and 6C, mixing vessel 104 may include outlet 602. In some implements, outlet 602 may be proximate to an intersection of front 504 and bottom 514 of vessel chamber 502. Outlet 602 may be configured to release a drink product from vessel chamber 502. In some non-limiting embodiments or aspects, outlet 602 may be on (e.g., positioned on) front surface 516 of mixing vessel 104 adjacent front 504 of vessel chamber 502. In some non-limiting embodiments or aspects, outlet 602 may be fluidly connected to dispenser assembly 108, which may be at least partly positioned on front surface 516 of mixing vessel 104.

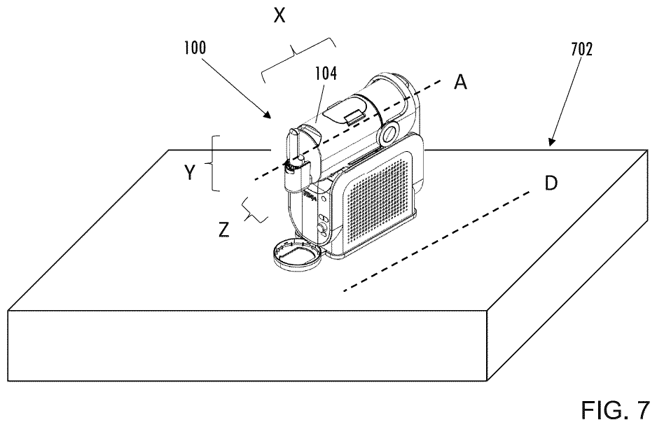

Referring now to FIG. 7, FIG. 7 is a diagram of drink maker 100 positioned on mounting surface 702, such as a countertop. As shown in FIG. 7, vessel chamber 502 of mixing vessel 104 of drink maker 100 may have first dimension X, second dimension Y, and third dimension Z. In some non-limiting embodiments or aspects, first dimension X may refer to a length of vessel chamber 502 of mixing vessel 104, second dimension Y may refer to a height of vessel chamber 502 of mixing vessel 104, and third dimension Z may refer to a width of vessel chamber 502 of mixing vessel 104. As further shown in FIG. 7, drink maker 100 may include center axis A (e.g., as described with regard to FIG. 5C) of a dasher (e.g., dasher 204) which is positioned within vessel chamber 502 and rotates about center axis A to move a drink product within vessel chamber 502. In some non-limiting embodiments or aspects, a largest dimension of vessel chamber 502 of mixing vessel 104 of drink maker 100 is oriented along horizontal axis D that is parallel to mounting surface 702 of drink maker 100. In some non-limiting embodiments or aspects, horizontal axis D may be parallel to center axis A about which the dasher rotates. For example, as shown in FIG. 7, first dimension X is the largest dimension of vessel chamber 502 of mixing vessel 104 of drink maker 100 and first dimension X is oriented along horizontal axis D, which is parallel to mounting surface 702 of drink maker 100.

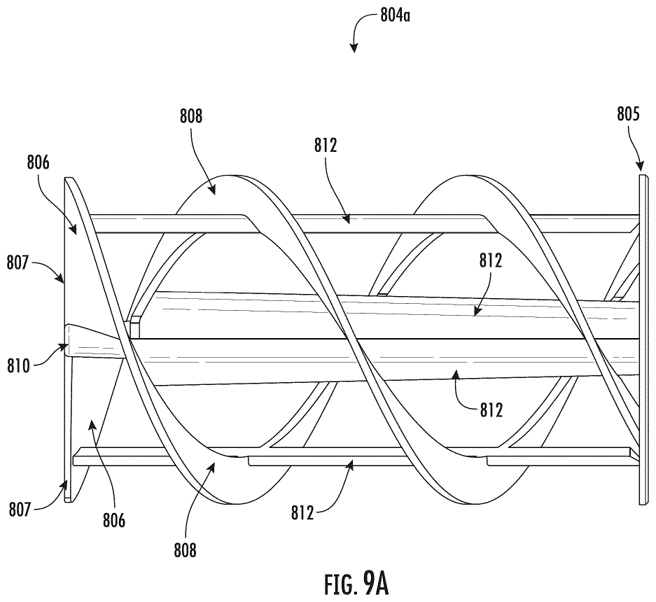

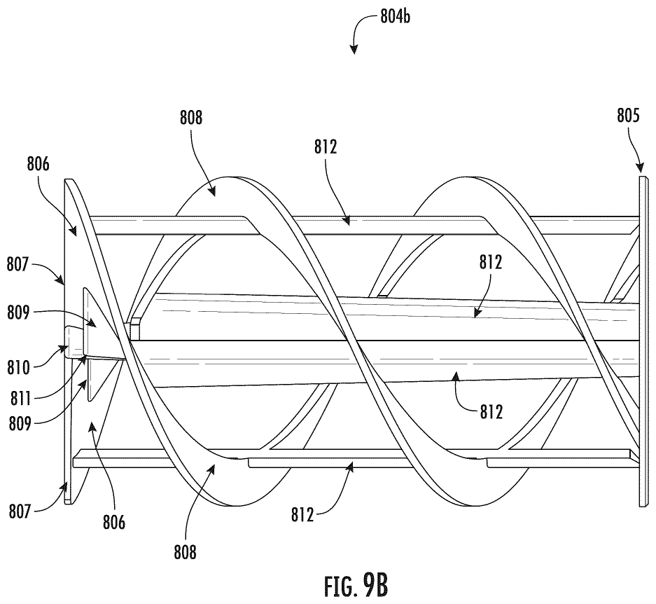

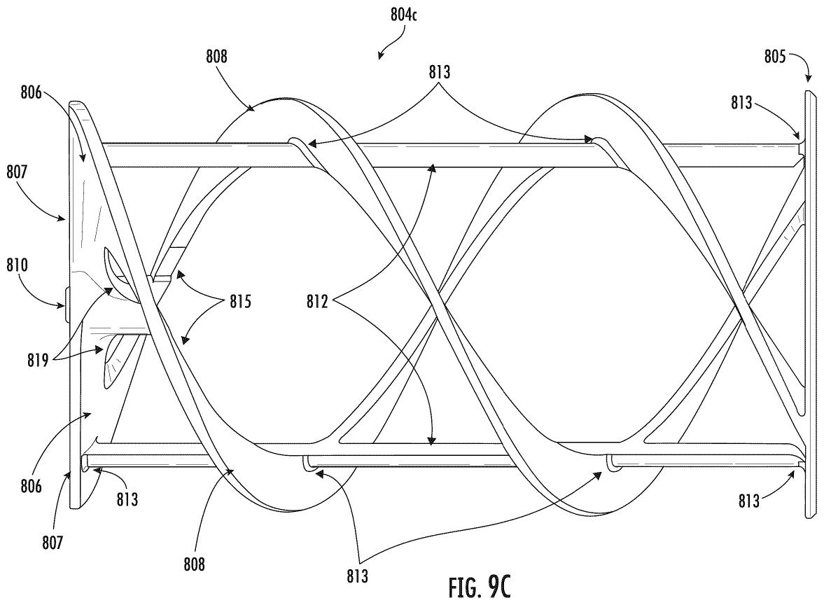

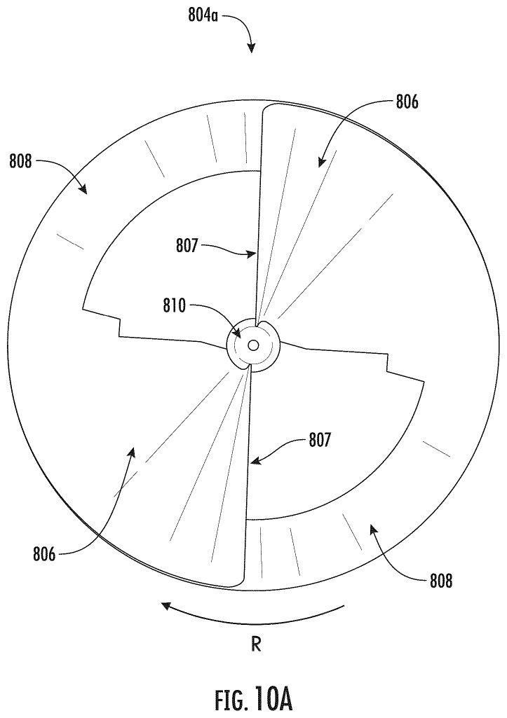

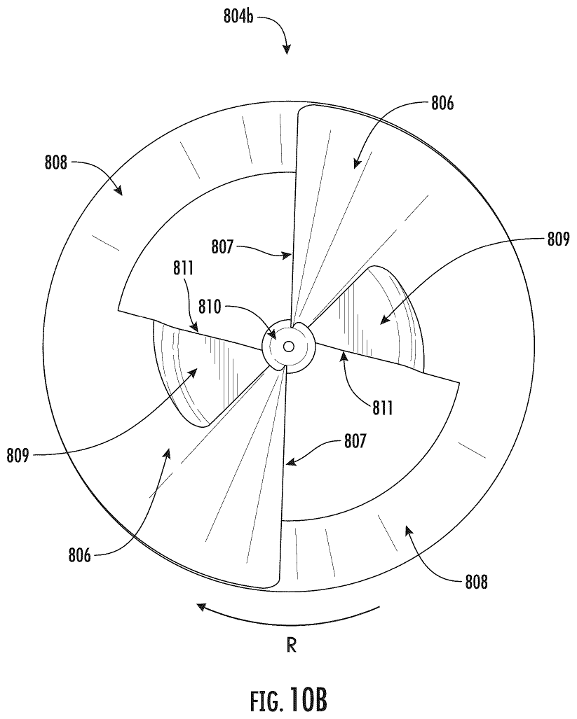

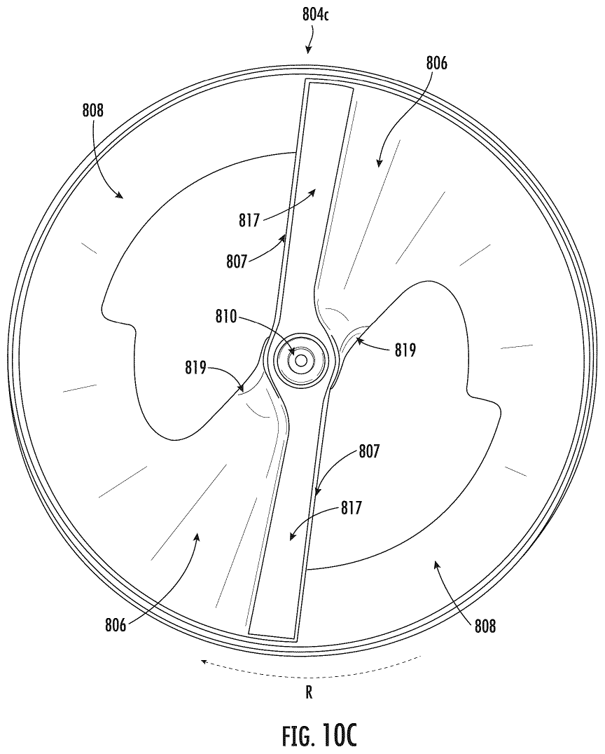

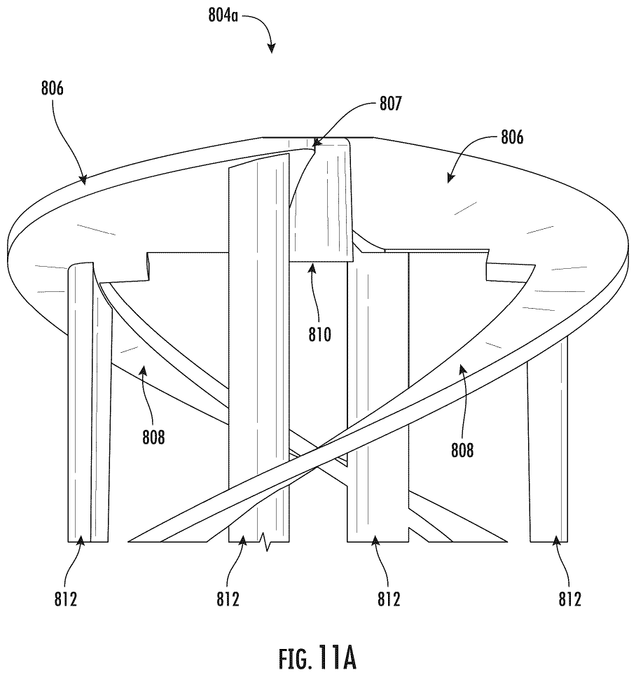

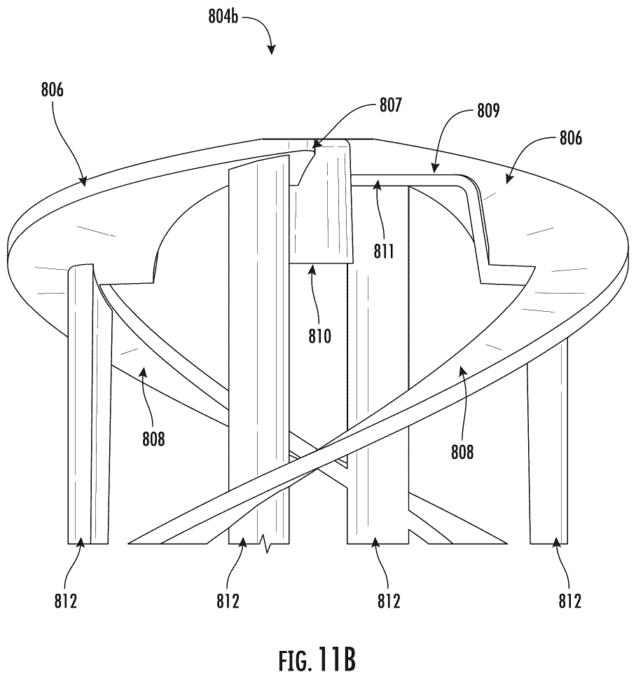

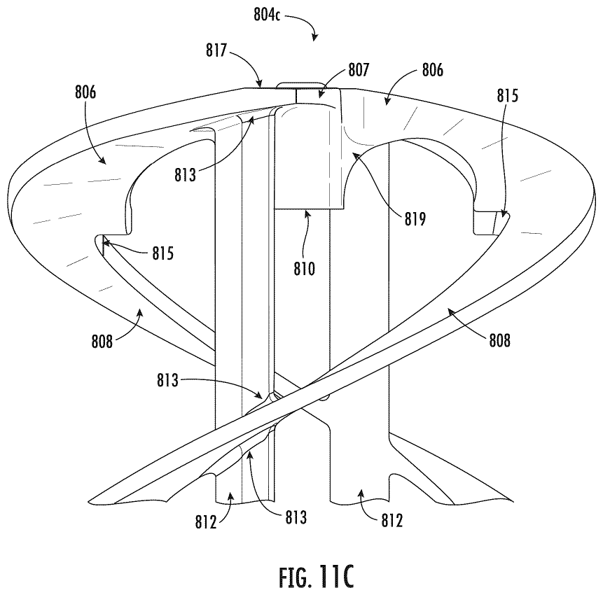

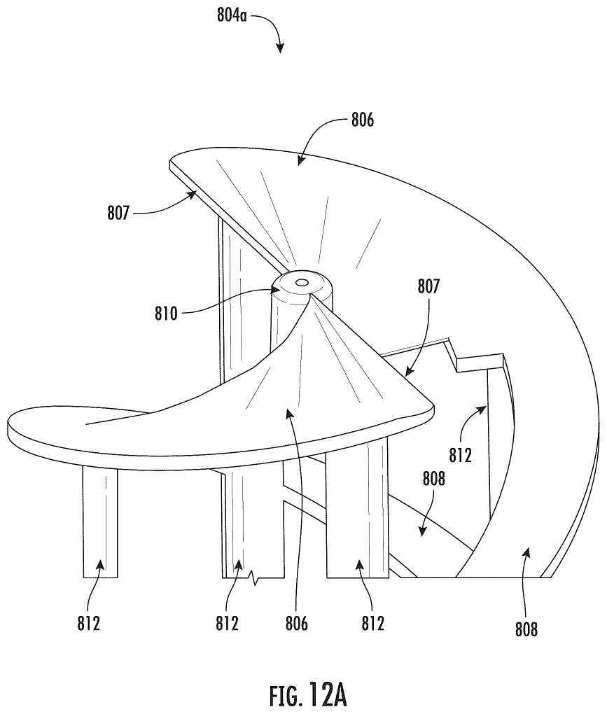

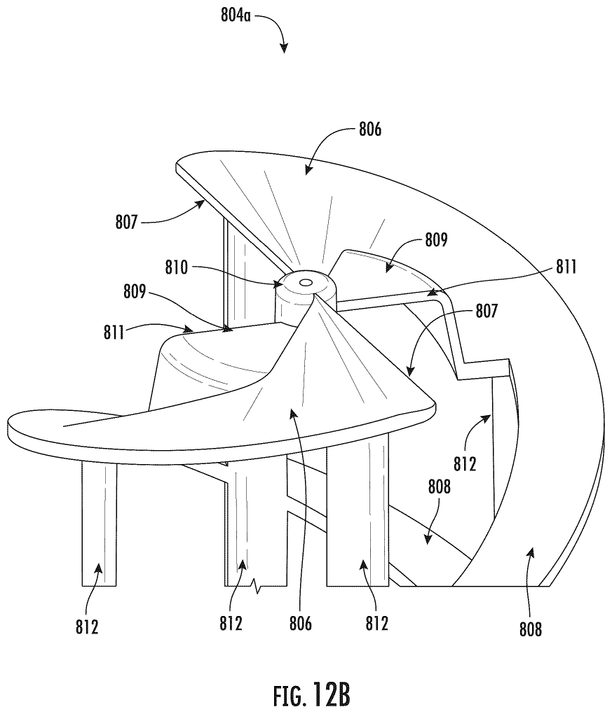

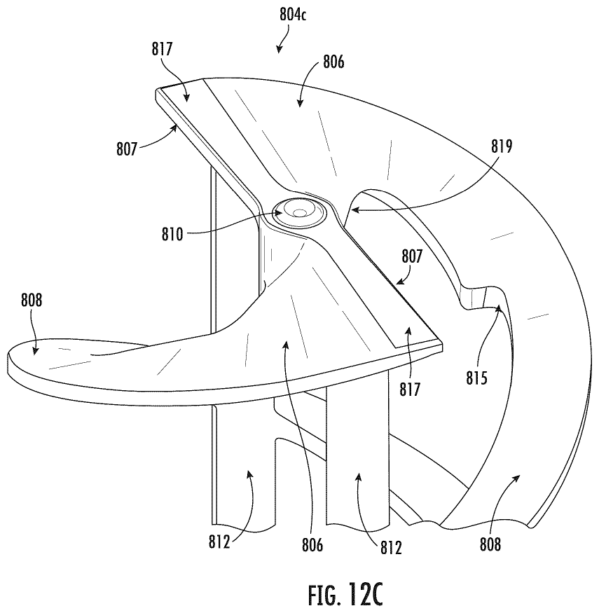

Referring now to FIGS. 8A-12C, shown are various views of dasher configurations for use in a drink maker, according to some non-limiting embodiments or aspects. FIG. 8A shows a perspective view of first dasher 804a (e.g., dasher 204), FIG. 8B shows a perspective view of second dasher 804b (e.g., dasher 204), and FIG. 8C shows a perspective view of third dasher 804c (e.g., dasher 204). FIG. 9A shows a profile view of first dasher 804a, FIG. 9B shows a profile view of second dasher 804b, and FIG. 9C shows a profile view of third dasher 804c. FIG. 10A shows a front view of first dasher 804a, FIG. 10B shows a front view of second dasher 804b, and FIG. 10C shows a front view of third dasher 804c. FIG. 11A shows a close-up, side view of first dasher 804a, FIG. 11B shows a close-up, side view of second dasher 804b, and FIG. 11C shows a close-up, side view of third dasher 804c. FIG. 12A shows a close-up, perspective view of first dasher 804a, FIG. 12B shows a close-up perspective view of second dasher 804b, and FIG. 12C shows a close-up perspective view of third dasher 804c. With reference to the structure and configuration of dasher 804a, 804b, 804c, the term “connected to” may refer to a connection point between two separately formed structures, two features of a singularly formed structure, and/or the like. In some non-limiting embodiments or aspects, dasher 804a, 804b, 804c may be formed (e.g., molded) from a single, coextensive material (e.g., plastic). For example, dasher 804a, 804b, 804c may be formed from, but is not limited to, polyoxymethylene (POM), polycarbonate, nylon, acrylonitrile butadiene styrene (ABS), and/or the like.

Dasher 804a, 804b, 804c may include one or more scraper blades 812 extending lengthwise from a rear to a front of dasher 804a, 804b, 804c. Each scraper blade 812 may have a leading, angled edge that is configured to scrape drink product that freezes against an outer surface of evaporator 202 (e.g., a metal drum thereof). Each scraper blade 812 may be formed of a rigid material (e.g., a plastic material) that is sufficiently hard to break through accumulations of frozen drink product without permanent deformation of scraper blade 812. The leading, angled edge may be oriented in a same direction as the direction of rotation of dasher 804a, 804b, 804c such that the sharper edge of scraper blade 812 shears through frozen drink product. One or more scraper blades 812 of dasher 804a, 804b, 804c may be configured to rest against an outer surface of evaporator 202. Additionally, or alternatively, one or more scraper blades 812 of dasher 804a, 804b, 804c may be configured to be proximate to the outer surface of evaporator 202 (e.g., a millimeter, a few millimeters, etc.), such that scraper blades 812 do not directly contact evaporator 202, which may cause wear on scraper blades 812 and/or evaporator 202. In some non-limiting embodiments or aspects, dasher 804a, 804b, 804c may include a plurality of scraper blades 812, such as two scraper blades 812 (e.g., as in dasher 804c, shown in FIGS. 8C, 9C, 11C, and 12C), four scraper blades 812 (e.g., as in dasher 804a, 804b, shown in FIGS. 8A, 8B, 9A, 9B, 11A, 11B, 12A, and 12B), or a different numbers of scraper blades 812. Scraper blades 812 may be connected on a first end to mounting ring 805, and extend along a length of dasher 804a, 804b, 804c to connect on a second end to a terminal end of helical blade 808 and/or a rear surface of face blade 806. In some non-limiting embodiments, a predetermined number of scraper blades 812 may be added to a dasher (e.g., dasher 804a). For example, scraper blades 812 may configured to remove ice and/or other material from an exterior surface of evaporator 202.

In some non-limiting embodiments or aspects, scraper blades 812 may be instead formed as support rails (e.g., structural cross-supports) that are not configured to scrape evaporator 202 or dislodge ice from evaporator 202. In such embodiments, helical blades 808 may primarily churn and move drink product about mixing vessel 104 to cause drink product to be processed. Also, in such embodiments, support rails may not have a sharpened or roughened edge and may instead be shaped with a cross-section (e.g., circular, square, rectangular, non-acute polygonal) to provide structural rigidity to dasher 804a, 804b, 804c.

In some non-limiting embodiments or aspects, dasher 804a, 804b, 804c may include at least two scraper blades 812. For example, dasher 804a, 804b, 804c may include a first scraper blade 812 positioned on a first side of the major axis of dasher 804a, 804b, 804c, extending lengthwise along the first side from a rear of dasher 804a, 804b (e.g., proximal and/or connected to mounting ring 805), toward a front of dasher 804a, 804b, 804c (e.g., proximal and/or connected to a rear surface of face blade 806). By way of further example, dasher 804a, 804b, 804c may include a second scraper blade 812 positioned on a second side of the major axis of dasher 804a, 804b, 804c opposite the first side, extending lengthwise along the second side from the rear of dasher 804a, 804b, 804c toward a front of dasher 804a, 804b, 804c.

In some non-limiting embodiments or aspects, dasher 804a, 804b may include at least four scraper blades 812. In addition to first scraper blade 812 and second scraper blade 812, described above, dasher 804a, 804b may include a third scraper blade 812 positioned on a third side of the major axis of dasher 804a, 804b, and a fourth scraper blade 812 positioned on a fourth side of the major axis of dasher 804a, 804b that is opposite the third side of the major axis. It will be appreciated that any number of two or more scraper blades 812 may be positioned radially about the major axis of dasher 804a, 804b, 804c (e.g., two scraper blades 812 at 180-degree increments, three scraper blades 812 at 120-degree increments, four scraper blades 812 at 90-degree increments, etc.). Symmetrical placement of multiple scraper blades 812 about the major axis of dasher 804a, 804b, 804c may improve the dislodgement of drink product from evaporator 202 while maintaining a mechanical balance of dasher 804a, 804b, 804c about an inertial center axis.

Dasher 804a, 804b, 804c may include one or more helical blades 808, which may be formed of a rigid material (e.g., a plastic material) sufficient to push drink product forward (e.g., toward a front end of dasher 804a, 804b, 804c) as dasher 804a, 804b, 804c rotates about a central axis (e.g., clockwise). Helical blades 808 may also cause a churning action in the drink product that is being mixed in mixing vessel 104. Each helical blade 808 may have a front face that pushes against the drink product during rotation, opposite a rear face. In some non-limiting embodiments or aspects, scraper blade 812 may act as a supporting connection between loops of helical blade 808. Likewise, helical blades 808 may act as a supporting framework to position scraper blades 812, including orienting scraper blades 812 toward a frozen drink product that is to be scraped from a surface within mixing vessel 104. In that manner, scraper blade 812 may be co-formed with and/or connected to portions of helical blade 808. In some non-limiting embodiments or aspects, a height of dasher 804c may increase as helical blade 808 extends from central hub 810 toward mounting ring 805 (e.g., a tapered height of dasher 804c along its length), such that a height of dasher 804c at a front end proximate to central hub 810 is smaller than a height of dasher 804c at a rear end proximate to mounting ring 805 (see, e.g., FIG. 10C). This may improve contact of dasher 804c with drink product in mixing vessel 104, as an average level of drink product at a rear end of mixing vessel 104 may be lower than an average level of drink product at a front end of mixing vessel 104, due to the forward movement of drink product in mixing vessel 104 brought about by helical blade 808 and the rotational movement of dasher 804c.

With further reference to FIGS. 8C, 9C, and 11C, and in some non-limiting embodiments or aspects, dasher 804c may include transitional joints 813 for connecting scraper blades 812 to helical blades 808, mounting ring 805, and/or face blade 806. A transitional joint 813 may be provided at each connection point between scraper blade 812 and one of helical blade 808, mounting ring 805, and/or face blade 806. Transitional joint 813 may be provided to improve a mechanical strength of the connection between scraper blade 812 and other components of dasher 804c, such as to allow rotational energy from central hub 810 to be transferred into the movement of scraper blade 812 without stressing the connections of scraper blade 812 to the point of breaking, dislodging, and/or the like. In configurations where scraper blade 812 is co-formed as a single structure with one of helical blade 808, mounting ring 805, and/or face blade 806, the point of transition between scraper blade 812 and the co-formed helical blade 808, mounting ring 805, and/or face blade 806 may include transitional joint 813 as additional structural material at/around the point of transition. In such examples, the additional structural material at/around the point of transition may be formed into a curved surface that transitions between the surface of scraper blade 812 and the connected component. In configurations where scraper blade 812 is an attachable separate structure that may be connected to one of helical blade 808, mounting ring 805, and/or face blade 806, the point of connection between scraper blade 812 and the co-formed helical blade 808, mounting ring 805, and/or face blade 806 may include transition joint 813 as additional connective material between the surface of scraper blade 812 and the connected component. In such examples, the additional connective material (e.g., a bonding agent) at/around the point of transition may be formed into a curved surface that transitions between the surface of scraper blade 812 and the connected component.

With further reference to FIGS. 8A-8C, 9A-9C, 11A-11C, and 12A-12C, and in some non-limiting embodiments or aspects, dasher 804a, 804b, 804c may include at least one helical blade 808 oriented with a curvature around a major axis (see axis A in FIGS. 5C and 7, for example). Each helical blade 808 may be configured to urge drink product in mixing vessel 104 (see, e.g., FIGS. 2 and 5C) to a front of mixing vessel 104 (e.g., a front being proximate to a dispenser assembly and/or spout of mixing vessel 104) as helical blade 808 rotates about the major axis (e.g., clockwise, for the configurations shown in FIGS. 8A-12C). In some non-limiting embodiments or aspects, dasher 804a, 804b, 804c may include at least one scraper blade 812 extending lengthwise parallel to the major axis and being connected to at least one helical blade 808 (e.g., intersecting substantially perpendicular to a curvature of helical blade 808). At least one scraper blade 812 may be configured to move (e.g., dislodge) at least a portion of frozen drink product accumulated on a surface in mixing vessel 104 (e.g., a surface of an evaporator 202, such as a metal drum of evaporator 202, as shown in FIG. 2).

In some non-limiting embodiments or aspects, dasher 804a, 804b, 804c may include central hub 810, which may act as a shaft mounting hub (e.g., a connector to provide a mechanical connection to a drive shaft, such as drive shaft 511, as shown in FIG. 5C). Central hub 810 may be configured to removably connect to drive shaft 511 of drink maker 100. Central hub 810 may include a recessed portion and/or receiving cavity in which to receive a tip or portion of drive shaft 511 (e.g., a lengthwise connector thereof). Central hub 810 may provide a forward connecting point for face blade 806 and/or scoop 809, so as to transfer the rotational force from drive motor 208 into the body of dasher 804a, 804b, 804c, and so as to securely affix face blade 806, scoop 809, and/or helical blade 808 at a front end of dasher 804a, 804b, 804c.

With further reference to FIGS. 8A-12C, dasher 804a, 804b, 804c may further include one or more face blades 806, formed as larger surface areas on a front end of helical blades 808. Each face blade 806 may be connected to central hub 810 on a first end and one of helical blade 808 on a second end. As shown, a front end of each helical blade 808 widens along its surface area incrementally to form a larger surface area comprising face blade 806. Each face blade 806 may have a front surface that is wider than a front surface of helical blades 808 (e.g., as measured in one or more directions perpendicular to a major axis of dasher 804a, 804b, 804c). Each face blade 806 may have a width spanning from a perimeter (e.g., distal radial edge, measured from the major axis) of dasher 804a, 804b, 804c to central hub 810 (see at least a portion of a span demarcated by trailing edge 807). Each face blade 806 may be configured to urge the drink product in mixing vessel 104 toward an outlet of mixing vessel 104 (see, e.g., outlet 602, as shown in FIG. 6B) as face blade 806 rotates about the major axis (e.g., about central hub 810). The wider front surface of face blade 806, as compared to helical blade 808, may promote more transfer of rotational force into a forward pushing direction, reducing a potential waste due to build-up of frozen or semi-frozen drink product at a front of mixing vessel 104.

In some non-limiting embodiments or aspects, dasher 804a, 804b, 804c may have at least two helical blades 808. First helical blade 808 may be symmetrically positioned at an opposite radial position on the major axis from second helical blade 808, such that both helical blades 808 are nested as a double helix. In some non-limiting embodiments or aspects, dasher 804a, 804b, 804c may have at least two face blades 806. First face blade 806 may be connected to (e.g., formed from) a front end of first helical blade 808, and second face blade 806 may be connected to a front end of second helical blade 808. Moreover, a radial position of first face blade 806 may be opposite from a radial position of second face blade 806, such that face blades 806 are symmetrically aligned along the major axis.

With further reference to FIGS. 8C, 9C, 11C, and 12C, each face blade 806 may have a thicker depth (e.g., measured along an axis perpendicular to a facial surface) than that of helical blade 808 connected thereto. Added thickness may provide for added structural stability at and around face blade 806, including to reduce unwanted flexing/shearing through the mechanical force imparted by central hub 810. Added thickness may also provide added structural stability to withstand the repeated contacting of face blade 806 with frozen or semi-frozen drink product at a front of mixing vessel 104. Transitional section 815 is provided to move from helical blade 808 having a first thickness to face blade 806 having a second thickness. In embodiments where face blade 806 is co-formed as a single piece with helical blade 808, transitional section 815 may include at least a portion of the structure corresponding to face blade 806 and/or helical blade 808 that has a sloped depth progressing from a first thickness to a second thickness. In embodiments where face blade 806 is connected as a separate piece to helical blade 808, transitional section 815 may include at least a portion of the structure corresponding to face blade 806 and/or helical blade 808, proximate to the adjoining surfaces of face blade 806 and helical blade 808, that has a sloped depth progressing from a first thickness to a second thickness. Below transitional section 815, in the area of helical blade 808, the thickness may be less, and above transitional section 815, in the area of face blade 806, the thickness may be greater. In some non-limiting embodiments or aspects, face blade 806 may have a thickness that is at least 1 mm thicker than helical blade 808. In some non-limiting embodiments, transitional section 815 may act as a blocking step to prevent a dasher from moving backwards in rotation.

With further reference to FIGS. 8A-12C, each face blade 806 may include trailing edge 807 that contacts or is proximate to a front, interior surface of mixing vessel 104 (see FIG. 6B). The upper portion of face blade 806 closest to trailing edge 807 may be the closest point of proximity between dasher 804a, 804b, 804c and the front, interior surface of mixing vessel 104. As dasher 804a, 804b, 804c rotates, face blade 806 may likewise rotate, causing drink product to be pushed by the angled surface of face blade 806 as the angled surface slopes outward from the tapered first end connected to helical blade 808 and up to trailing edge 807. Because trailing edge 807 extends from a perimeter of dasher 804a, 804b, 804c (e.g., an outer perimeter), to a central hub 810, there are little to no areas in the plane of trailing edge 807 that would not be cleared by a rotational motion of face blade 806 and/or central hub 810, thereby reducing waste due to a build-up of frozen or semi-frozen drink product at the front of mixing vessel 104. The outer perimeter may be a maximum outer perimeter of the entire dasher 804a, 804b, 804c, or a local outer perimeter in one or more planes of face blade 806.

With further reference to FIGS. 8C, 10C, 11C, and 12C, face blade 806 of dasher 804c may further include tapered end 817. For example, tapered end 817 may include a width of face blade 806 proximate and parallel to trailing edge 807. Tapered end 817 may reduce in thickness from a first side distant from trailing edge 807 to a second side proximate to trailing edge 807. Tapered end 817 may increase a surface area of an upper trim of face blade 806 that is proximate to a front, inner surface of mixing vessel 104, further reducing the likelihood of drink product building up on the front, inner surface of mixing vessel 104. A thinner trailing edge 807 caused by tapered end 817 may further promote flexibility in the tip of face blade 806. Moreover, by way of each face blade 806 including tapered end 817, a relatively flat surface may be created by and connecting between each tapered end 817. The relatively flat surface by and between tapered ends 817 of face blades 806, including around central hub 810, may reduce the likelihood of drink product building up between face blade 806 and a front, inner surface of mixing vessel 104. While some drawings show tapered end 817 as encompassing a region on or near a surface of face blade 806 extending partway or all the way to an edge of face blade 806, it will be appreciated that tapered end 817 may encompass some or all of a width of an edge of face blade 806 across a width of dasher 804c from one lateral extreme to the other. In some non-limiting embodiments or aspects, one or more corner edges of face blade 806 and/or helical blade 808 may be slightly rounded to reduce sharp edges that may contact a user's hands during installation. In some non-limiting embodiments, central hub 810 may extend from a front plane defined by a foremost edge of the elements of a dasher (e.g., leading edges 811, trailing edges 807, tapered end 817). In this way, central hub 810 may be sized and configured to extend in a direction that prevents the foremost edge of the dasher from contacting an interior wall of a mixing vessel (e.g., mixing vessel 2000).

With further reference to FIGS. 8A-9C, dasher 804a, 804b, 804c may further include mounting ring 805 (e.g., a circular or semi-circular structure configured to form a rear end of dasher 804a, 804b, 804c and fit over and/or mount dasher 804a, 804b, 804c onto a portion of drink maker 100). Mounting ring 805 may be configured to encircle a circumference of evaporator 202 (e.g., a metal drum thereof) positioned in mixing vessel 104, such that when dasher 804a, 804b, 804c is removably inserted over evaporator 202, mounting ring 805 slides over evaporator 202 until it becomes seated adjacent a portion of upper housing section 122 (e.g., adjacent flexible seal). One or more helical blades 808 may be connected on one end to mounting ring 805. Moreover, one or more scraper blades 812 may be connected on one end to mounting ring 805.

With further reference to FIGS. 8B, 9B, 10B, 11B, and 12B, dasher 804b may further include at least one scoop 809. Scoop 809 may protrude from (e.g., be formed on an extended surface of) face blade 806. In some non-limiting embodiments or aspects, each face blade 806 may include scoop 809 protruding therefrom. Scoop 809 may be configured to clear out frozen or semi-frozen drink product that is collecting at a front and middle of dasher 804b, by forcing such drink product to be pushed back toward a middle of mixing vessel 104. Each scoop 809 may have leading edge 811, which is positioned at a radially forward position in the direction of rotation of dasher 804b. Leading edge 811 may extend radially from the major axis, such as connected to and extending from central hub 810. Scoop 809 may have an angle from the radial extension of leading edge 811, allowing leading edge 811 to connect back into a front face of face blade 806. Scoop 809 may form a curved surface on an interior of scoop 809, which may urge drink product away from a front side of face blade 806. Moreover, scoop 809 may reduce the likelihood of formation and/or prevent the formation of a frozen clump (e.g., a puck or blockage) at a front end of dasher 804b, thereby further reducing waste.

In some non-limiting embodiments or aspects, first scoop 809 may protrude from a front surface of first face blade 806 and include leading edge 811 extending radially from the major axis, including from central hub 810. Moreover, second scoop 809 may protrude from a front surface of second face blade 806 and include leading edge 811 extending radially from the major axis, including from central hub 810. Each scoop 809 may have a radial width (e.g., measured from and perpendicular to a major axis, on which central hub 810 is centered) that is less than a radial width of a corresponding face blade 806 on which scoop 809 is mounted, to allow for a sufficient surface area of face blade 806 to remain for pushing drink product forward, optimizing the efficiency of both face blade 806 and scoop 809. The above-described features of dasher 804a, 804b depicted in FIGS. 8A-12B, including, but not limited to, helical blades 808, scraper blades 812, face blades 806, scoops 809, leading edges 811, trailing edges 807, and central hub 810, both individually and in combination, reduce waste in mixing vessel 104 due to build-up of frozen or semi-frozen drink product inside mixing vessel 104.

With further reference to FIGS. 8C, 9C, 10C, 11C, and 12C, dasher 804c may further include structural wing 819 connecting face blade 806 to central hub 810. For example, structural wing 819 may include a curved surface transitioning from an inner curved edge of face blade 806 and connecting to a lateral side of central hub 810. Each face blade 806 may be connected to central hub 810 by way of structural wing 819. The presence of structural wing 819 may expand the contact point between face blade 806 and central hub 810. Structural wing 819 may improve the integrity of the connection between face blade 806 and central hub 810, to prevent weakness over time caused by the torque of central hub 810 imparted into face blade 806. Structural wing 819 may further reduce unwanted flexion and/or vibration in face blade 806 as dasher 804c rotates within mixing vessel 104. In embodiments where face blade 806 and central hub 810 are co-formed of a single piece, structural wing 819 may include a smooth transition from face blade 806, in a substantially horizontal plane, to central hub 810, in a substantially vertical plane. In embodiments where face blade 806 and central hub 810 are separately formed, structural wing 819 may include an extension of face blade 806 and/or central hub 810 on either side of a connection between the two elements. In some non-limiting embodiments or aspects, no portion of face blade 806 may have a front surface that extends further towards the front end of mixing vessel 104 than a front surface of central hub 810.

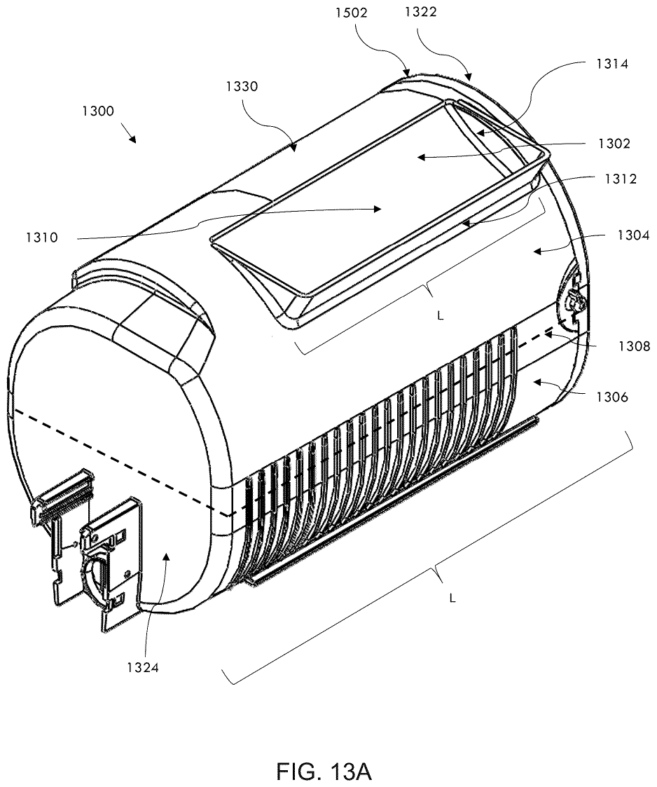

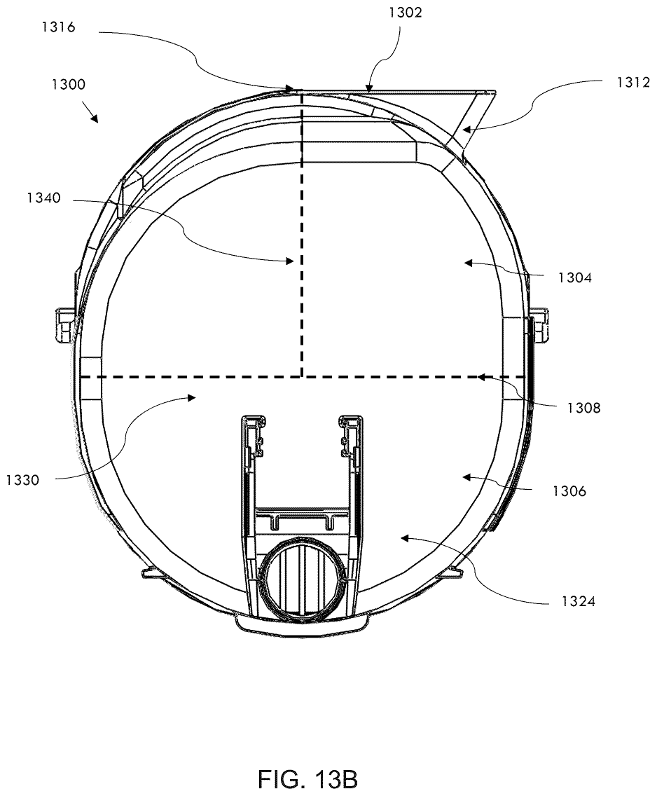

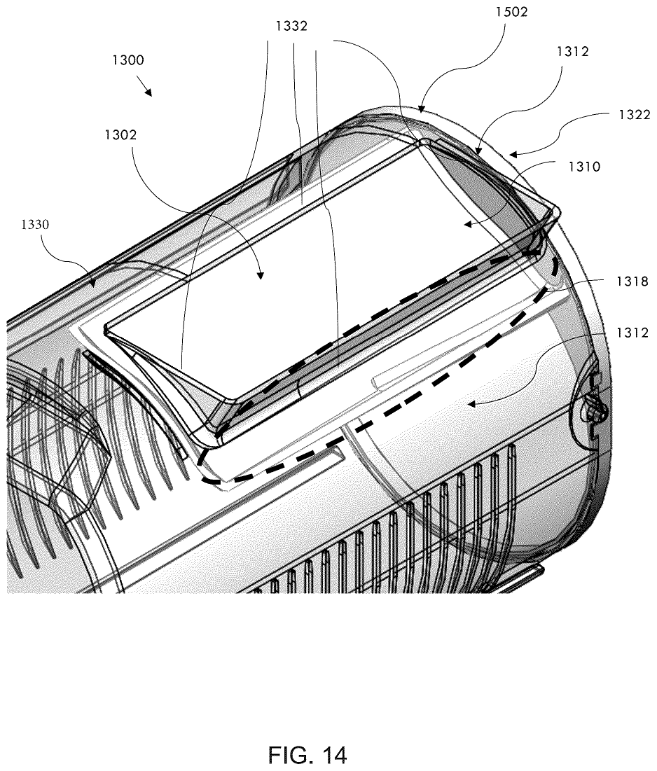

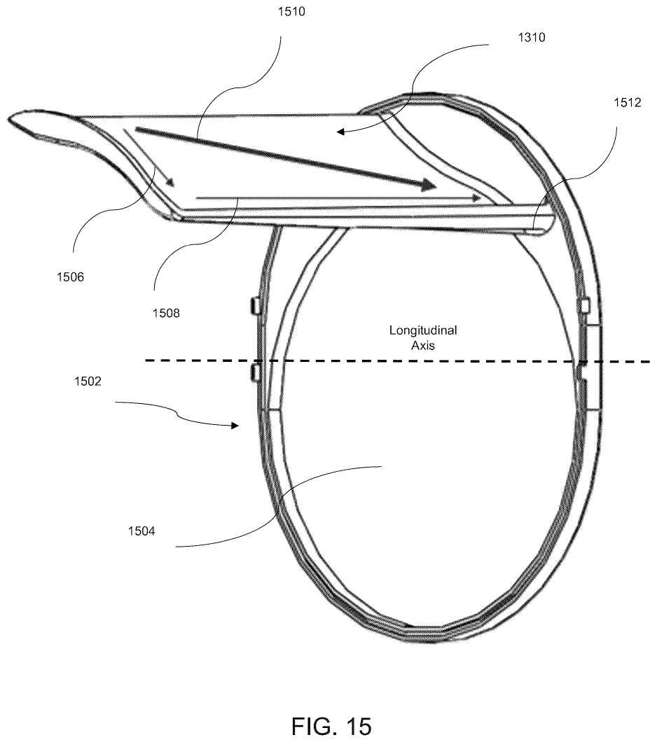

Referring now to FIGS. 13A and 13B, shown are diagrams of mixing vessel 1300 that include a pour-in opening to allow for ingress to a vessel chamber of mixing vessel 1300, according to some non-limiting embodiments or aspects. In some non-limiting embodiments or aspects, mixing vessel 1300 may be the same as or similar to mixing vessel 104. As shown in FIG. 13A, the pour-in opening may include aperture 1302. In some non-limiting embodiments or aspects, aperture 1302 may have a rectangular shape. Aperture 1302 may provide access (e.g., direct access, such that a material poured through aperture 1302 may enter mixing vessel 1300 without interference from another object, or indirect access, such that a material poured through aperture 1302 may enter mixing vessel 1300 after colliding with an object) into a vessel chamber of mixing vessel 1300. As further shown in FIG. 13A, mixing vessel 1300 may include top section 1304 and bottom section 1306 that are defined based on horizontal midline 1308 that divides mixing vessel 1300 approximately in half. As further shown in FIG. 13A, mixing vessel 1300 may include rear section 1322 (e.g., a section that faces towards an evaporator and/or upper housing section of a drink maker) and front section 1324 (e.g., a section that faces towards an outlet of a drink maker). In some non-limiting embodiments or aspects, aperture 1302 may be positioned on top section 1304 of mixing vessel 1300 and may extend at least 50% of the length (e.g., shown as “L” in FIG. 13A) of mixing vessel 1300. For example, the length of aperture 1302 may be in a range between 50% to 85% of the length of mixing vessel 1300. In one example, the length of aperture 1302 may be equal to at least 75% of the length of mixing vessel 1300. In this way, aperture 1302 may allow for access to the vessel chamber of mixing vessel 1300 even when a drink maker (e.g., drink maker 100) is positioned in a location that does not provide easy access to aperture 1302. For example, aperture 1302 may allow for access to the vessel chamber when the drink maker is placed under a cabinet or other structure (e.g., a rear portion of the drink maker at least partly under a cabinet). As further shown in FIG. 13A and FIG. 14, mixing vessel 1300 may include main body 1330 and end cap 1502 (which is described in further detail with regard to FIG. 15). In some non-limiting embodiments or aspects, main body 1330 may form the primary structure of mixing vessel 1300 and may include one or more structures (e.g., internal edge feature 1602) for holding end cap 1502 in place. In some non-limiting embodiments or aspects, end cap 1502 may be induction welded to main body 1330.

As further shown in FIGS. 13A and 13B, mixing vessel 1300 may include surface 1310 positioned underneath aperture 1302. In some non-limiting embodiments or aspects, surface 1310 may be positioned within an interior of mixing vessel 1300. In some non-limiting embodiments or aspects, surface 1310 may be between aperture 1302 and the vessel chamber. In some non-limiting embodiments or aspects, second aperture 1314 may be defined based on (e.g., between an end of) surface 1310 and an interior wall of mixing vessel 1300, where second aperture 1314 provides access to the vessel chamber of mixing vessel 1300. In some non-limiting embodiments or aspects, second aperture 1314 may be spaced a distance from rear section 1322 of mixing vessel 1300 to allow for material to flow through second aperture 1314 and into a vessel chamber of mixing vessel 1300. In some non-limiting embodiments or aspects, second aperture 1314 may be shaped as a slot. In some non-limiting embodiments or aspects, surface 1310 may be configured to reduce a speed of a material that is being poured into the vessel chamber of mixing vessel 1300 via aperture 1302. In some non-limiting embodiments or aspects, surface 1310 may be configured to redirect a flow of a material that is being poured into the vessel chamber of mixing vessel 1300 via aperture 1302. Additionally, or alternatively, surface 1310 may be configured to direct the flow of the material along a path that runs along a longitudinal axis of mixing vessel 1300 (e.g., an axis running between a rear end, near an upper housing section, and a front end, near an outlet). In this way, surface 1310 may prevent splashing and other undesirable effects and allow for proper mixing of materials. In some non-limiting embodiments or aspects, surface 1310 may be sized and configured to avoid interference with a dasher (e.g., dasher 204) of the frozen drink maker (e.g., drink maker 100).

As further shown in FIGS. 13A and 13B, mixing vessel 1300 may include retaining wall 1312 that is positioned around aperture 1302. In some implementations, retaining wall 1312 may be configured to prevent a material that is being poured into the vessel chamber via aperture 1302 from overflowing onto an exterior surface of mixing vessel 1300. As shown in FIG. 13B, aperture 1302 (e.g., and retaining wall 1312) may begin at peak 1316, which is defined based on vertical midline 1340, of top section 1304 of mixing vessel 1300.

Referring now to FIG. 14, shown is a transparent view of mixing vessel 1300 including aperture 1302, according to some non-limiting embodiments or aspects. As shown in FIG. 14, surface 1310 may include portion 1318 that extends past aperture 1302 in a direction towards side 1320 of mixing vessel 1300. In some non-limiting embodiments or aspects, a surface area of surface 1310 may be greater than or equal to a surface area of aperture 1302. In some non-limiting embodiments or aspects, a surface area of surface 1310 may be less than a surface area of aperture 1302. As further shown in FIG. 14, surface 1310 may extend beyond sides 1332 of aperture 1302. As further shown in FIG. 14, retaining wall 1312 may surround aperture 1302 on less than all sides 1332. For example, retaining wall 1312 may surround aperture 1302 on three sides 1332 (e.g., a first side distant from vertical midline 1340 and parallel to the longitudinal axis, along with two sides perpendicular to the first side).

Referring now to FIG. 15, shown is a diagram of end cap 1502 of mixing vessel 1300 that includes surface 1310, according to some non-limiting embodiments or aspects. As shown in FIG. 15, end cap 1502 may include main aperture 1504 to allow for an evaporator to pass through. As shown in FIG. 15, surface 1310 may include a contoured surface, where the contoured surface is curved in two directions as shown by arrows 1506, 1508, 1510. Surface 1310 may be configured to direct the flow of the material at least partly along a path represented by an arrow that runs along a longitudinal axis of mixing vessel 1300. As further shown in FIG. 15, surface 1310 may include aperture 1512 through which a material (e.g., a drink material to be frozen into a slush) may flow into the vessel chamber of mixing vessel 1300. In some non-limiting embodiments or aspects, aperture 1512 may formed separately from surface 1310. For example, aperture 1512 may be defined based on a space provided between surface 1310 and an interior surface of mixing vessel 1300 when end cap 1502 is placed within main body 1330 of mixing vessel 1300.

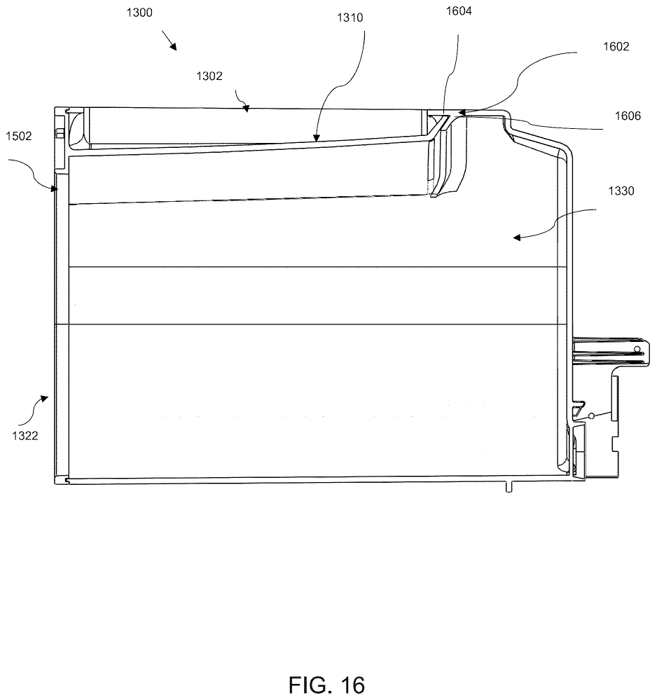

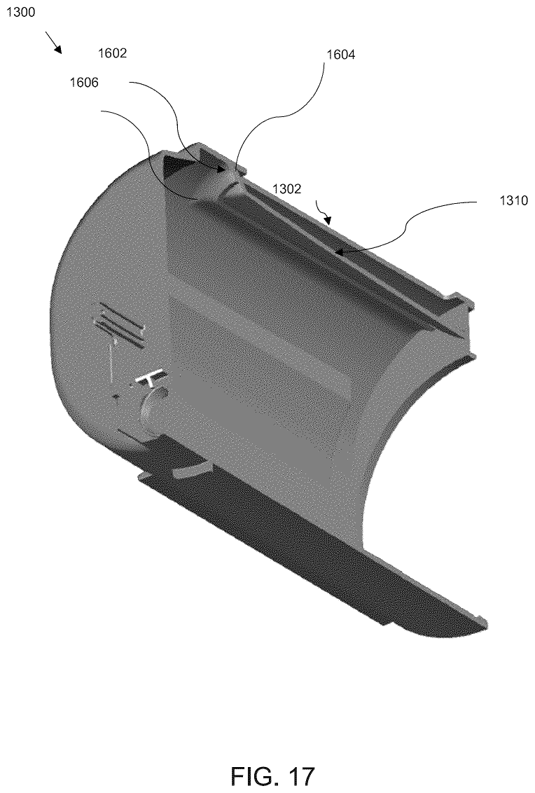

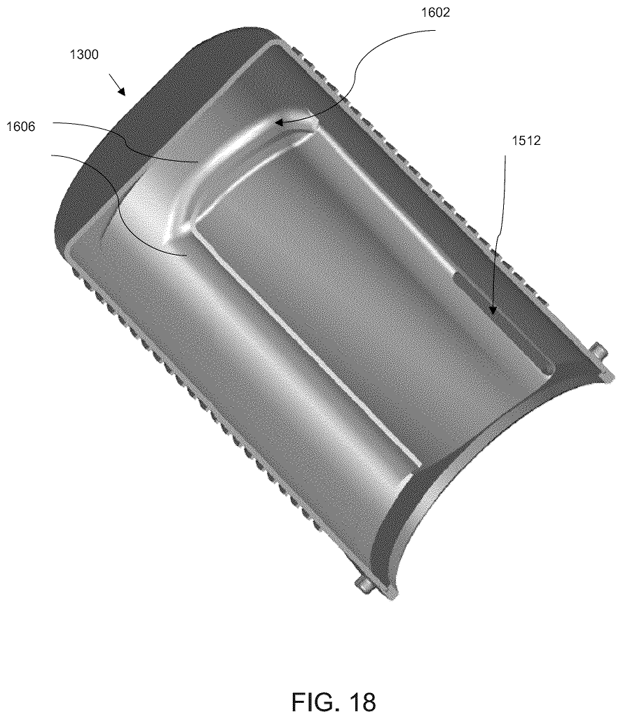

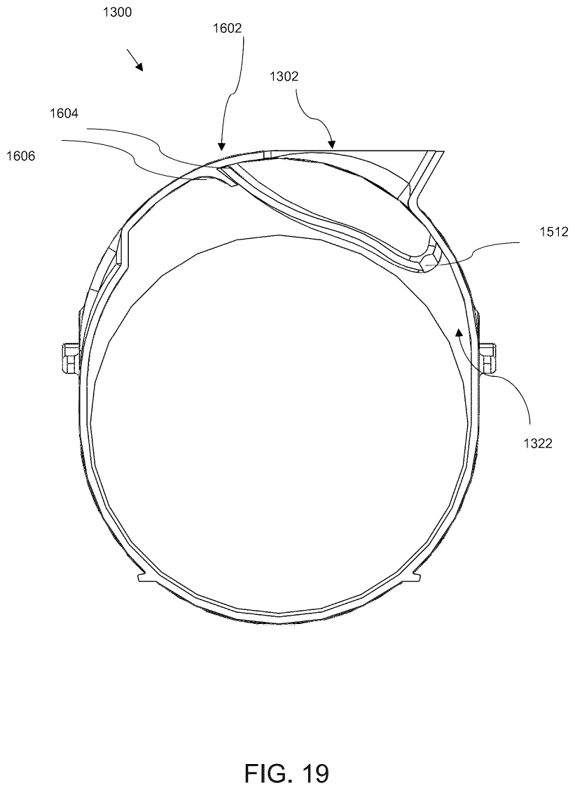

Referring now to FIGS. 16-19, shown are diagrams of mixing vessel 1300 with end cap 1502 in place, and which show internal edge feature 1602, according to some non-limiting embodiments or aspects. FIGS. 16 and 17 are cross-sectional views of mixing vessel 1300 along vertical midline 1340. FIG. 18 is a cross-sectional view of mixing vessel 1300 along horizontal midline 1308. FIG. 19 is an end view of mixing vessel 1300 from rear section 1322. As shown in FIGS. 16, 17, and 19, internal edge feature 1602 may be formed on an interior surface of mixing vessel 1300 and may include slot 1604 for receiving surface 1310 of end cap 1502. In some examples, slot 1604 may be formed to have a shape that corresponds to a shape of surface 1310 to receive surface 1310 and prevent surface 1310 (e.g., and end cap 1502) from movement. In this way, slot 1604 may allow for alignment of surface 1310 and may be configured to hold surface 1310 in place based on a friction fit between slot 1604 and surface 1310. Additionally, or alternatively, slot 1604 may provide a seal and prevent leakage of material that is poured through aperture 1512 (e.g., so that the material does not travel on a path other than through aperture 1512). As further shown in FIGS. 16-19, internal edge feature 1602 may include curved surface 1606. In some non-limiting embodiments or aspects, curved surface 1606 may include a rounded shape that is designed to improve circulation of a material within the vessel chamber of mixing vessel 1300. For example, curved surface 1606 may include a convex shape that faces the vessel chamber. As further shown in FIG. 18, curved surface 1606 may be formed to surround at least two sides of surface 1310. In some non-limiting embodiments or aspects, curved surface 1606 may be formed so that internal edge feature 1602 does not interfere with aperture 1512 of surface 1310 and still provides for a convex shape that faces the vessel chamber to improve circulation within mixing vessel 1300.

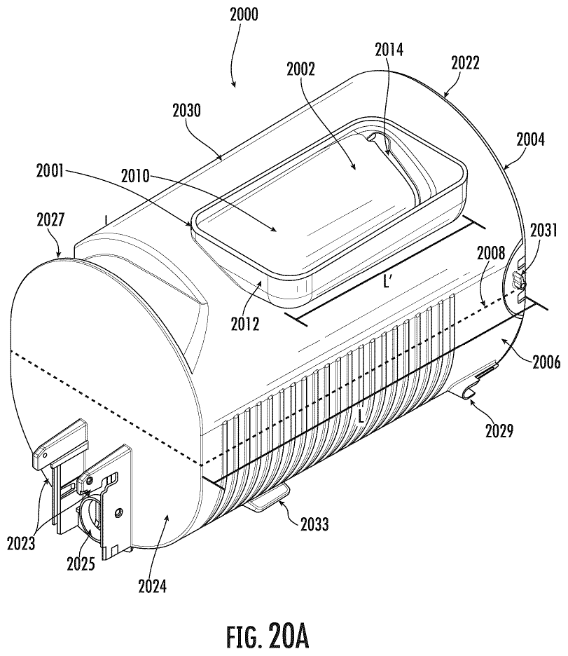

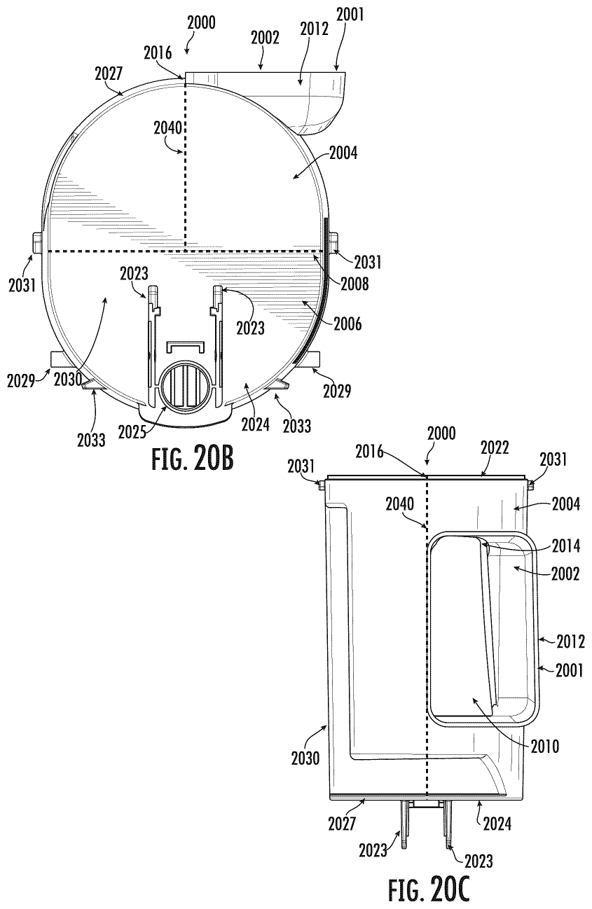

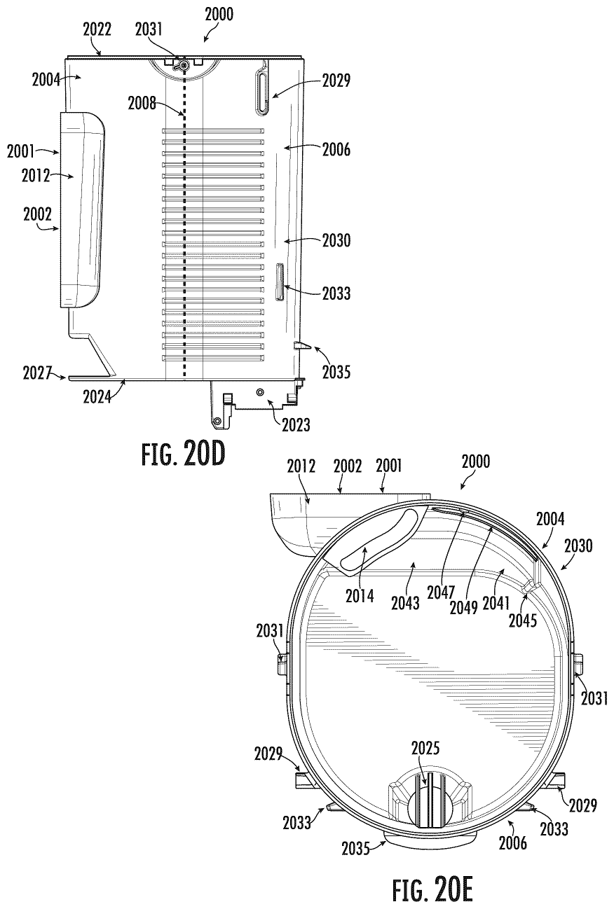

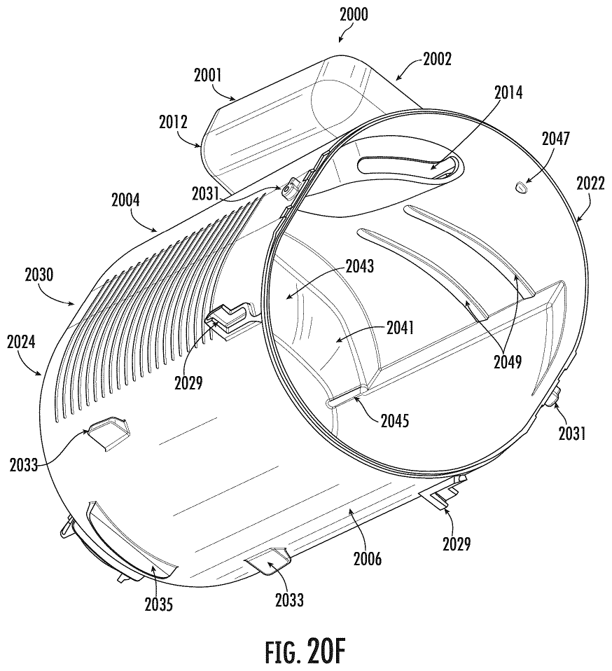

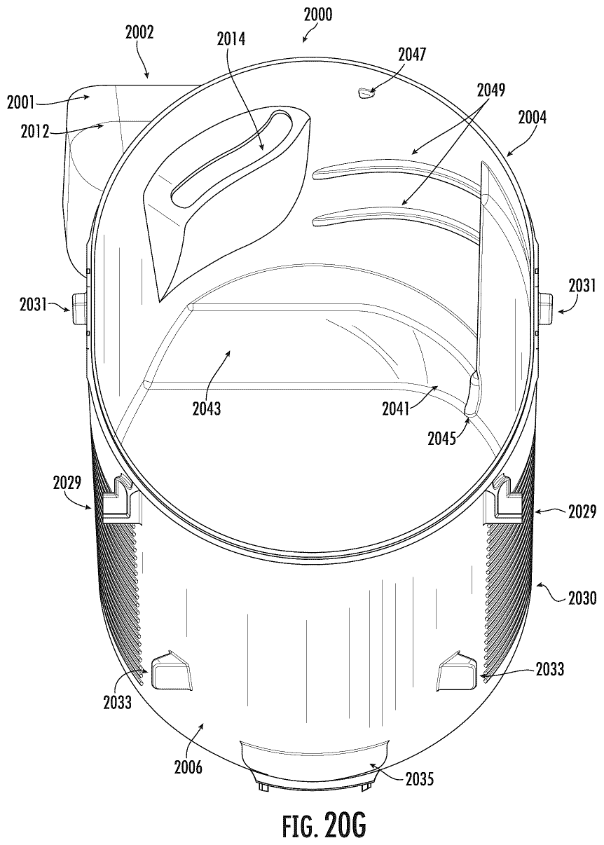

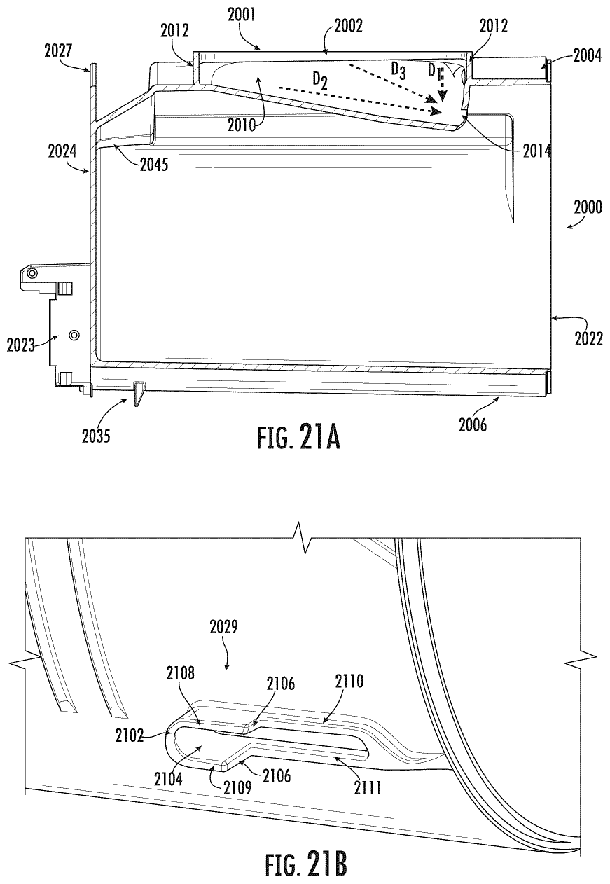

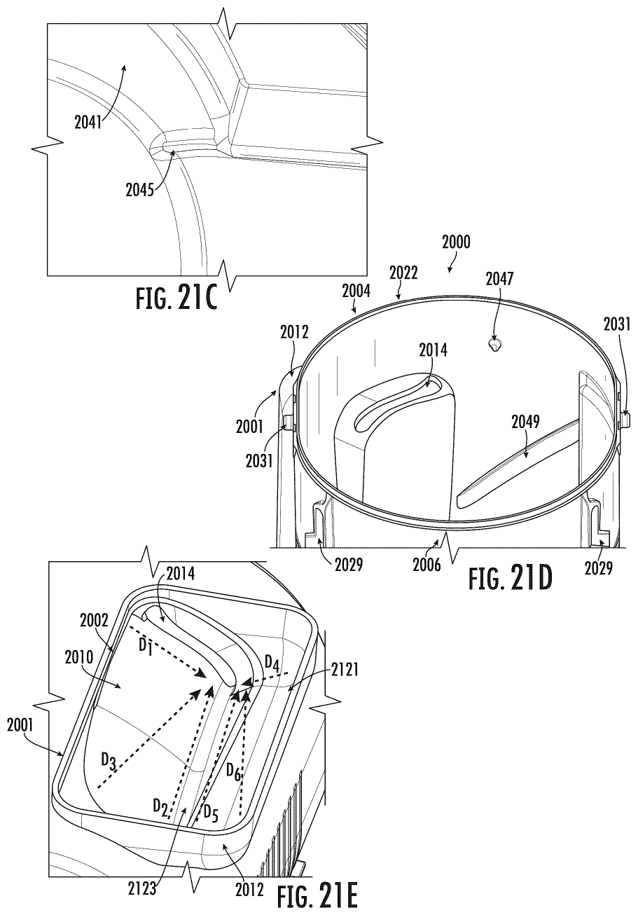

Referring now to FIGS. 20A-20G and 21A-21E, shown are views of mixing vessel 2000 (e.g., mixing vessel 104) having pour-in opening 2001 (e.g., a structure of mixing vessel 2000 configured to permit input of drink product and channel the drink product into an interior chamber of mixing vessel 2000), according to some non-limiting embodiments or aspects. In particular, FIG. 20A is a front, perspective view of mixing vessel 2000, FIG. 20B is a front view of mixing vessel 2000, FIG. 20C is a top view of mixing vessel 2000, FIG. 20D is a side view of mixing vessel 2000, FIG. 20E is a rear view of mixing vessel 2000, FIG. 20F is a bottom, titled, rear, perspective view of mixing vessel 2000, FIG. 20G is a rear, bottom view of mixing vessel 2000, FIG. 21A is a side view of a vertical, longitudinal cross-section of mixing vessel 2000, FIG. 21B is a close-up view of an exterior protrusion (e.g., first protrusion 2029) of mixing vessel 2000, FIG. 21C is a close-up view of an interior protrusion (e.g., first internal protrusion 2045) of mixing vessel 2000, FIG. 21D is a close-up view of flow promotion feature (e.g., second internal protrusion 2047) and ribs 2049, and FIG. 21E is a close-up view of pour-in opening 2001 of mixing vessel 2000.

As shown in FIGS. 20A-20G, 21A, and 21E, pour-in opening 2001 may include aperture 2002 (e.g., an opening leading to an interior volume of pour-in opening 2001 and through which drink product may be introduced to a drink maker, such as drink maker 100). Pour-in opening 2001 may further include retaining wall 2012 (e.g., an at least partly vertical surface configured to enclose an interior volume of pour-in opening 2001 and temporarily retain drink product within pour-in opening 2001). As shown in FIG. 20B, aperture 2002 (e.g., and retaining wall 2012) may begin at peak 2016, which is defined based on vertical midline 2040, of top section 2004 of mixing vessel 2000. In some non-limiting embodiments or aspects, retaining wall 2012 may have a top edge around a perimeter of aperture 2002 that is chamfered. The top edge may be chamfered around a portion (e.g., on two sides, such as two opposing sides, etc.) or the entirety of the perimeter. The chamfered top edge may provide for easier assembly of a cover (e.g., pour-in cover 2207).

In some non-limiting embodiments, retaining wall 2012 may define an open chamber that is positioned on top section 2004 of mixing vessel 2000. The open chamber may extend beyond an exterior wall of mixing vessel 2000 to allow for easier input of drink product into mixing vessel 2000, in particular while a portion of drink maker 100 is positioned under another object, such as a kitchen cabinet.

As shown in FIGS. 20A-20G, 21A, and 21D, mixing vessel 2000 may also include top section 2004 (e.g., a portion of mixing vessel 2000 above horizontal midline 2008) and bottom section 2006 (e.g., a portion of mixing vessel 2000 below horizontal midline 2008). Pour-in opening 2001 may be positioned on top section 2004 of mixing vessel 2000. Mixing vessel 2000 may further include front section 2024 (e.g., a portion of mixing vessel 2000 near an end where drink product is dispensed from mixing vessel 2000) and rear section 2022 (e.g., a portion of mixing vessel 2000 near an end proximal to an upper housing section 122 and/or opening where evaporator 202 is received within mixing vessel 2000). In some non-limiting embodiments or aspects, pour-in opening 2001 may include a portion that is proximate to rear section 2022, so as to direct drink product toward a rear of mixing vessel 2000 and prevent the disturbance of the consistency of processed drink product that has been already cooled and moved toward front section 2024.

In some non-limiting embodiments or aspects, and as shown in FIG. 20A, mixing vessel 2000 may have a length (L) that is greater than half the total length of drink maker 100 along the same axis. Pour-in opening 2001 may have a length (L′) that is less than or equal to length (L). In some non-limiting embodiments or aspects, the length (L′) of pour-in opening 2001 may be between 40% and 80% of the length (L) of mixing vessel 2000. In some non-limiting embodiments or aspects, the length (L′) of pour-in opening 2001 may be between 50% and 75% of the length (L) of mixing vessel 2000. In this manner, pour-in opening 2001 may permit input of drink product even while a portion of drink maker 100 is positioned under another object, such as a kitchen cabinet. Aperture 2002 may be less than or equal to a total length (L′) of pour-in opening 2001.

As shown in FIGS. 20A, 20C, 21A, and 21E, pour-in opening 2001 may further include surface 2010 positioned underneath aperture 2002. In some non-limiting embodiments or aspects, surface 2010 may be positioned within an interior of mixing vessel 2000. In some non-limiting embodiments or aspects, surface 2010 may be between aperture 2002 and the vessel chamber. In some non-limiting embodiments or aspects, second aperture 2014 may be defined based on (e.g., between an end of) surface 2010 and an interior wall of mixing vessel 2000, where second aperture 2014 provides access to the vessel chamber of mixing vessel 2000. In some non-limiting embodiments or aspects, second aperture 2014 may be proximate to rear section 2022 and spaced a distance from rear section 2022 of mixing vessel 2000 to allow for material to flow through second aperture 2014 and into a vessel chamber of mixing vessel 2000. In some non-limiting embodiments or aspects, surface 2010 may be configured to reduce a speed of a material that is being poured into the vessel chamber of mixing vessel 2000 via aperture 2002. In some non-limiting embodiments or aspects, surface 2010 may be configured to redirect a flow of a material that is being poured into the vessel chamber of mixing vessel 2000 via aperture 2002. Additionally, or alternatively, surface 2010 may be configured to direct the flow of the material along a path that runs along a longitudinal axis of mixing vessel 2000 (e.g., an axis running between rear section 2022 and front section 2024). In this way, surface 2010 may prevent splashing and other undesirable effects and allow for proper mixing of materials. In some non-limiting embodiments or aspects, surface 2010 may be sized and configured to avoid interference with a dasher (e.g., dasher 204) of the drink maker (e.g., drink maker 100).

In some non-limiting embodiments, a width and shape of second aperture 2014 may be selected to allow drink product to easily flow into mixing vessel 2000 while in a liquid state, while discouraging drink product that is frozen/semi-frozen from pushing back out of second aperture 2014 (e.g., egress due to froth). Furthermore, by orienting second aperture 2014 toward a rear of mixing vessel 2000, drink product is less likely to backflow up into pour-in opening 2001 (e.g., since less drink product will be present in a rear of mixing vessel 2000 during operation due to forward movement of drink product). Surface 2010 may be sloped such that all drink product entering pour-in opening via aperture 2002 thereafter exits into an internal chamber of mixing vessel 2000 via second aperture 2014. See, e.g., FIGS. 21A and 21E for further illustration of the slope of surface 2010 and the direction of flow of drink product added to pour-in opening 2001. It will be appreciated that second aperture 2014 may be limited in width so as to prevent/reduce the incursion of foreign objects, such as fingers, into an interior chamber of mixing vessel 2000 (e.g., to prevent contact with element such as dasher 204). Moreover, a bottom portion (e.g., a floor) of pour-in opening 2001 that extends into an interior of mixing vessel 2000 may be limited in depth, so as to allow inflow from second aperture 2014 without overly restricting a headspace in the vessel chamber therein. In some non-limiting embodiments, a size of second aperture 2014 may appropriate to allow for a desired rate of a drink product to be input into mixing vessel 2000. For example, second aperture 2014 may extend (e.g., extend completely) from peak 2016 to a location where retaining wall 2012 meet an exterior wall of top section 2004 to allow for an increased rate of drink product to be input into mixing vessel 2000.

As shown in FIGS. 20A-20G, mixing vessel 2000 may include main body 2030, which may form the primary structure of mixing vessel 2000 and may include one or more structures for holding an end cap (not shown) in place. Main body 2030 may enclose and define a vessel chamber inside mixing vessel 2000. In addition to those features described above, main body 2030 may include a number of internal and external features to improve the performance and structure of drink maker 100, as further described below.

As shown in FIGS. 20A, 20B, 20D-20G, 21B, and 21D, mixing vessel 2000 may include, on an exterior of main body 2030, first protrusion 2029, which may act to rest on an upper surface of a housing of the drink maker (e.g., housing 102). For example, first protrusion 2029 may include an extension of mixing vessel 2000 configured to act as a mounting point and contact with an upper rail of housing 102 upon which mixing vessel 2000 is positioned. First protrusion 2029 may provide stability to the mounting of mixing vessel 2000 and further guide a user in mounting mixing vessel 2000 on housing 102, sliding mixing vessel 2000 rearward, and positioning mixing vessel 2000 for proper coupling with housing 102. First protrusion 2029 may be formed of a material coextensive with other features of main body 2030 of mixing vessel 2000.

With specific reference to FIG. 21B, and in non-limiting embodiments or aspects, first protrusion 2029 may be shaped to improve rigidity of first protrusion 2029, such as by including rounded portion 2102 connecting upper long extension 2108 and lower long extension 2109. Furthermore, by leaving hollow portion 2104 not in-filled with material between upper long extension 2108 and lower long extension 2109, total material used for first protrusion 2029 may be reduced, reducing complexity and overall resources used for producing a rigid structural component. Furthermore, first protrusion 2029 may include upper short extension 2110 and lower short extension 2111 that connect to upper long extension 2108 and lower long extension 2109, respectively, by way of sloped portions 2106. The reduced width of upper short extension 2110 and lower short extension 2111 may allow first protrusion 2029 to be tapered out to its full width, further reducing materials used while maintaining structural stability.

As shown in FIGS. 20A-20G and 21D, mixing vessel 2000 may include, on an exterior of main body 2030, second protrusion 2031. Second protrusion 2031 may be configured to interface with a cam connected to a lever (e.g., lever 110), such that as the lever is moved to a coupling position, the cam may engage and pull second protrusion 2031 into a slot thereof, causing mixing vessel 2000 to seat firmly against an upper housing section (e.g., upper housing section 122) of a drink maker (e.g., drink maker 100). Second protrusion 2031 may be formed of a material coextensive with other features of main body 2030 of mixing vessel 2000.

As shown in FIGS. 20A, 20B, and 20D-20G, mixing vessel 2000 may include, on an exterior of main body 2030, third protrusion 2033. Third protrusion 2033 may be configured to interface with a slot in the housing (e.g., housing 102) of a drink maker (e.g., drink maker 100), such that third protrusion 2033 enters a slot shaped to receive third protrusion 2033. By seating with a slot of the housing, third protrusion 2033 may act to further connect mixing vessel 2000 to the housing and prevent unwanted movement or rotation of mixing vessel 2000 while mixing vessel 2000 is in a coupling position. Third protrusion 2033 may be formed of a material coextensive with other features of main body 2030 of mixing vessel 2000.

As shown in FIGS. 20D-20G and 21A, mixing vessel 2000 may include, on an exterior of main body 2030, fourth protrusion 2035. Fourth protrusion 2035 may be formed of a material coextensive with other features of main body 2030 of mixing vessel 2000. Fourth protrusion 2035 (e.g., a down-ward facing tab) may be configured to interface with condensation collection tray 220. For example, as mixing vessel 2000 is placed on a housing (e.g., housing 102) of a drink maker (e.g., drink maker 100), mixing vessel 2000 may be positioned above condensation collection tray 220. As mixing vessel 2000 is pushed backwards toward an upper housing section (e.g., upper housing section 122), fourth protrusion 2035 may contact a front of condensation collection tray 220 and prevent the removal of condensation collection tray 220 while mixing vessel 2000 is in the coupling position.

As shown in FIGS. 20A, 20B, and 20E, mixing vessel 2000 may include, at front section 2024 and passing through main body 2030, outlet 2025 (e.g., outlet 602). Outlet 2025 may be configured to permit drink product that is in mixing vessel 2000 to pass from a vessel chamber thereof to an exterior of mixing vessel 2000. Drink product flow from outlet 2025 may be temporarily blocked and/or released by interfacing with a dispenser assembly (e.g., dispenser assembly 108). Outlet 2025 may further include a grate (e.g., bars) to prevent passage of foreign objects (e.g., fingers) into a vessel chamber of mixing vessel 2000.

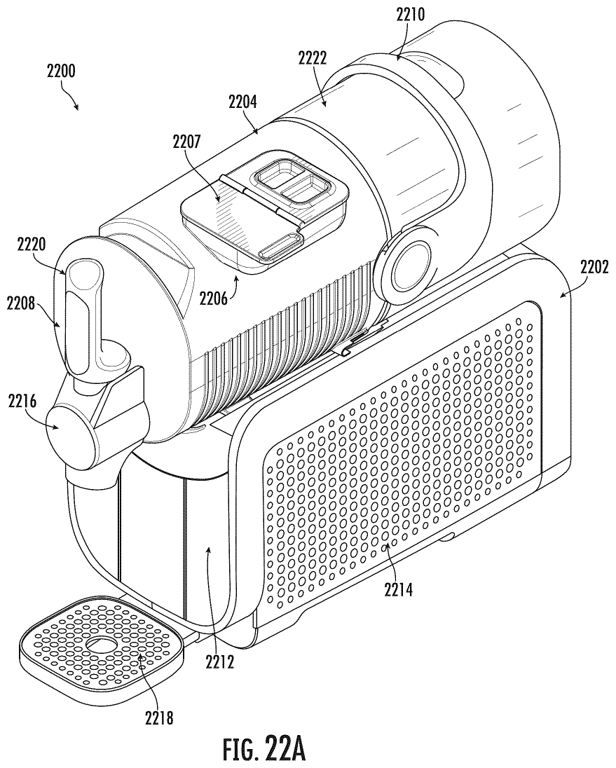

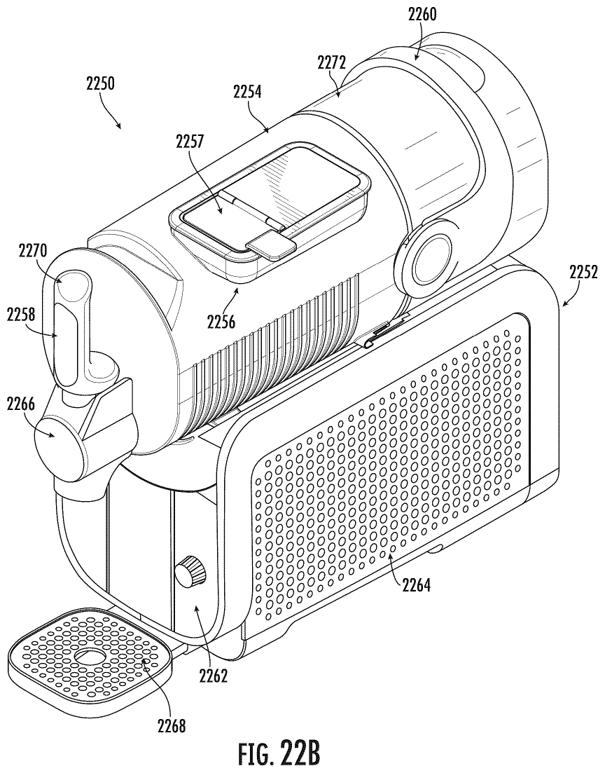

As shown in FIGS. 20A, 20B, 20C, 20D, and 21A, mixing vessel 2000 may include, at front section 2024 and on an exterior of main body 2030, dispenser assembly mount 2023. Dispenser assembly mount 2023 may be formed of a material coextensive with other features of main body 2030 of mixing vessel 2000. Dispenser assembly mount 2023 may include one or more protrusions from mixing vessel 2000, including one or more contact/fastening points, to allow a dispenser assembly (e.g., dispenser assembly 108) to be connected to mixing vessel 2000. For example, a shroud (e.g., shroud 116) may connect (e.g., snap-fit) to dispenser assembly mount 2023. By way of further example, components of dispenser assembly may connect to dispenser assembly mount 2023 using one or more pins. See, e.g., FIGS. 22A and 22B for exemplary depictions of dispenser assemblies (e.g., dispenser assembly 2208, dispenser assembly 2258) attached to dispenser assembly mount 2023 such that the drink maker is fully assembled. In some non-limiting embodiments, dispenser assembly mount 2023 may include slots (e.g., slots with ribs) to allow for a shroud (e.g., shroud 116) to be connected to dispenser assembly mount 2023. For example, dispenser assembly mount 2023 may include slots that have a shape corresponding to a connector (e.g., a protrusion having a shape to connect to the on the shroud, to allow the shroud to be snap-fit in place and/or to be removed from dispenser assembly mount 2023.

As shown in FIGS. 20A, 20B, 20C, 20D, and 21A, mixing vessel 2000 may include, at front section 2024, and on an exterior of main body 2030, lip 2027. Lip 2027 (e.g., a protrusion next to a recess) of mixing vessel 2000 may provide a grip/contact point for a user's hand, to allow better control of mixing vessel 2000 while mixing vessel 2000 is mounted and/or removed. Lip 2027 may be formed of a material coextensive with other features of main body 2030 of mixing vessel 2000.

As shown in FIGS. 20E-20G, 21A, and 21C, mixing vessel 2000 may include, on an interior of mixing vessel 2000, first internal protrusion 2045. First internal protrusion 2045 (e.g., a pronounced rib) may extend horizontally along an interior wall of mixing vessel 2000 and may be configured to encourage drink product to release from an interior wall of mixing vessel 2000 and rejoin a main mass of drink product being mixed in mixing vessel 2000. For example, as drink product is chilled and becomes frozen/semi-frozen, drink product may cling to an interior wall of mixing vessel 2000. As a dasher (e.g., dasher 204) rotates within mixing vessel 2000 and urges drink product in a rotational direction, some drink product may be forced partway up and along an interior wall. For that reason, first internal protrusion 2045 may be positioned on a side of dasher 204 where drink product is being directed at least partly toward a top of mixing vessel 2000. As drink product passes over first internal protrusion 2045, first internal protrusion 2045 disrupts the smooth plane of the internal wall and encourages the drink product to release from the wall and collapse back toward center of mass and/or dasher 204. Without first internal protrusion 2045, drink product may be more likely to become lodged too high on a wall/ceiling of mixing vessel 2000, such that the drink product does not continue to be fully and properly mixed. Furthermore, first internal protrusion 2045 may be formed of a material coextensive with other features of mixing vessel 2000, including one or more internal walls thereof.

As shown in FIGS. 20E-20G and 21C, mixing vessel 2000 may include a sloped surface on an interior of a vessel chamber thereof, proximate to front section 2024. For example, mixing vessel 2000 may include first sloped wall portion 2041 and second sloped wall portion 2043. First sloped wall portion 2041 may transition smoothly into second sloped wall portion 2043. First sloped wall portion 2041 and/or second sloped wall portion 2043 may be shaped to optimize use of the Coanda effect, which is the tendency of fluid to flow over smooth surfaces. First sloped wall portion 2041 and/or second sloped wall portion 2043 may be curved and/or rounded to promote guiding of drink product along their surfaces and away from the vertical walls of mixing vessel 2000. An upper edge (e.g., distant from the front of mixing vessel 2000) of first sloped wall portion 2041 and/or second sloped wall portion 2043 may end abruptly, so as to encourage fluid to drop off of their surface and back into the main mass of drink product being mixed in mixing vessel 2000.

As shown in FIGS. 20E, 20F, 20G, and 21D, mixing vessel 2000 may include, on an interior surface of a vessel chamber thereof, one or more ribs 2049. Each rib 2049 (e.g., an elongated protrusion) may extend from a side of mixing vessel 2000 and at least partly upward toward a vertical midline 2040 of mixing vessel 2000. Each rib 2049 may extend perpendicularly, or at least partly perpendicular, to a longitudinal axis of mixing vessel 2000. Additionally, or alternatively, each rib 2049 may be angled along its length toward a front of mixing vessel 2000. In some non-limiting embodiments or aspects, mixing vessel 2000 may have a small gap between the end terminus of ribs 2049 and pour-in opening 2001. In some non-limiting embodiments or aspects, ribs 2049 may extend across the interior top of mixing vessel 2000 and may be configured to encourage rotational movement of drink product (e.g., with movement of dasher 204) as well as prevent drink product from sticking to a ceiling of mixing vessel 2000. In some non-limiting embodiments or aspects, ribs 2049 may be configured to force drink product that has risen to a top of mixing vessel 2000 away from a top of mixing vessel 2000, to promote better circulation inside mixing vessel 2000. Ribs 2049 may also co-act with a front baffle (e.g., front baffle 107) to help guide drink product away from a front wall/ceiling of mixing vessel 2000 and back toward a mixing area at or adjacent a dasher (e.g., dasher 204). Ribs 2049 may also extend from a side baffle (e.g., side baffle 105) on a side of mixing vessel 2000. Furthermore, ribs 2049 may be formed of a material coextensive with other features of mixing vessel 2000, including one or more internal walls thereof.

In some non-limiting embodiments or aspects, the number of ribs 2049 may be selected to optimize channeled movement of the drink product without inundating mixing vessel 2000 with too many ribs 2049. Too many ribs 2049 may ultimately increase the surface area of the ceiling of mixing vessel 2000 and promote sticking of drink product. For that reason, one, two, or three ribs 2049 in the vessel as shown, along the ceiling, may best optimize these goals. However, the optimal number of ribs 2049 may depend on the length of mixing vessel 2000 itself. For example, a distance of approximately 50-60 mm (e.g., 54 mm) between ribs 2049 may be used to determine an optimal number of ribs 2049 along the ceiling of mixing vessel 2000. Furthermore, the area between ribs 2049 may be configured to be smooth, to further lower the likelihood of drink product sticking between the ribs 2049 themselves.

As shown in FIGS. 20E, 20F, 20G and 21D, mixing vessel 2000 may include, on an interior surface of a vessel chamber thereof, second internal protrusion 2047. Second internal protrusion 2047 may be configured to break up the surface tension of drink product rotating about the vessel chamber. For example, as drink product (e.g., in frozen or semi-frozen form) rotates across second internal protrusion 2047, second internal protrusion 2047 may create an air pocket that encourages the drink product to release from a ceiling of mixing vessel 2000. In some non-limiting embodiments or aspects, second internal protrusion 2047 may have rounded geometry, to allow drink product to slip easily over the surface of second internal protrusion 2047 and successfully create an air pocket. For example, second internal protrusion 2047 may be spherical, cylindrical, teardrop-shaped, and/or the like. In some non-limiting embodiments or aspects, second internal protrusion 2047 may extend from a ceiling/wall of mixing vessel 2000 toward an interior (e.g., toward dasher 204), such that it is at least partly convex (e.g., a convex dome, teardrop, rounded oblong shape, etc.). In some non-limiting embodiments or aspects, second internal protrusion 2047 may extend from a ceiling/wall of mixing vessel 2000 away from an interior (e.g., away from dasher 204), such that it is at least partly concave (e.g., a concave dome, teardrop, rounded oblong shape, etc.). In the latter case, second internal protrusion 2047 may effectively be an indentation in the inner surface of the ceiling/wall, which will also create an air pocket and break up surface tension. Whether at least partly concave or convex, second internal protrusion 2047 may act to prevent adherence of the contents of mixing vessel 2000, which would otherwise lead to a tunneling effect, in which frozen or semi-frozen contents form a cavity in its volume during processing in mixing vessel 2000.

In some non-limiting embodiments or aspects, second internal protrusion 2047 may be offset from being aligned with an edge of pour-in opening 2001 where pour-in opening 2001 extends into the vessel chamber, so as to optimize performance of second internal protrusion 2047 (e.g., by providing a disruption along an otherwise smooth arc of wall/ceiling). In some non-limiting embodiments or aspects, second internal protrusion 2047 may be offset from a vertical midline 2040 of mixing vessel 2000, to increase the likelihood of contact with drink product and to create a pocket in the surface of the drink product before drink product reaches an apex of the ceiling. Furthermore, second internal protrusion 2047 may be formed of a material coextensive with other features of mixing vessel 2000, including one or more internal walls thereof.

As shown in FIGS. 21A and 21E, surface 2010 of pour-in opening 2001 may be sloped to encourage drink product to flow, with the force of gravity, down and into an internal chamber of mixing vessel 2000. For example, surface 2010 may have a first slope component direction D₁ away from an upper side (e.g., adjacent peak 2016) of pour-in opening 2001 and toward a lower minimum of pour-in opening 2001. Surface 2010 may further have a second slope component direction D₂ away from an upper, front end of pour-in opening 2001 and toward a lower, rear end of pour-in opening 2001 (e.g., adjacent second aperture 2014). First slope component direction D₁ and second slope component direction D₂, when combined, may yield an average slope direction D₃, which is the general direction of drink product flow once poured into pour-in opening 2001 on surface 2010. Second slope component direction D₂ may allow a user to pour drink product in closer to a front end of mixing vessel 2000, which may be user friendly if the drink maker is positioned at least partly under an obstruction, such as a kitchen cabinet. As shown in FIG. 21A, once drink product flows to the bottom of pour-in opening 2001, the drink product exits out second aperture 2014 and is introduced to an interior of mixing vessel 2000.

With specific reference to FIG. 21E, pour-in opening 2001 may include second surface 2121 opposite surface 2010. Second surface 2121 may slope downward from an exterior perimeter of pour-in opening 2001 and toward channel 2123, which may include a trough and the minimum height at the base of surface 2010 and second surface 2121. Second surface 2121 may have a first slope component direction D₄ away from an upper, lateral side of pour-in opening 2001 and toward a lower minimum of pour-in opening 2001. Second surface 2121 may further have a second slope component direction D₅ away from an upper, front end of pour-in opening 2001 and toward a lower, rear end of pour-in opening 2001 (e.g., adjacent second aperture 2014). First slope component direction D₄ and second slope component direction D₅, when combined, may yield an average slope direction D₆, which is the general direction of drink product flow once poured into pour-in opening 2001 on second surface 2121. Second slope component direction D₅ may allow a user to pour drink product in closer to a front end of mixing vessel 2000, which may be user friendly if the drink maker is positioned at least partly under an obstruction, such as a kitchen cabinet. It will be appreciated that channel 2123 may be positioned in a valley between surface 2010 and second surface 2121. Surface 2010 and second surface 2121 may form two angled boundaries of an internal volume of pour-in opening 2001, in which drink product is temporarily retained until the drink product drains out second aperture 2014.

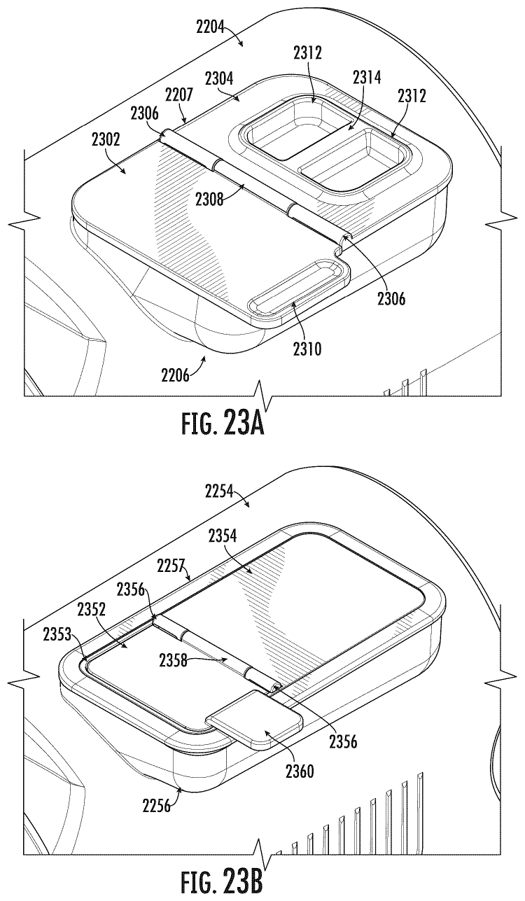

Referring now to FIG. 22A, shown is a perspective view of drink maker 2200 (e.g., drink maker 100) with mixing vessel 2204 (e.g., mixing vessel 104, mixing vessel 2000) having pour-in opening 2206 (e.g., pour-in opening 106, pour-in opening 2001), according to some non-limiting embodiments or aspects. Drink maker 2200 may include upper housing section 2222 (e.g., upper housing section 122) of housing 2202 (e.g., housing 102) to which mixing vessel 2204 is coupled, caused by action of lever 2210 (e.g., lever 110). Drink maker 2200 may include dispenser assembly 2208 (e.g., dispenser assembly 108), which may include handle 2220 (e.g., handle 120) and shroud 2216 (e.g., shroud 116). Drink maker 2200 may further include panel 2214 (e.g., panel 114), user interface 2212 (e.g., user interface 112), and drip tray 2218 (e.g., drip tray 118). As shown in FIG. 22A, pour-in opening 2206 further may include pour-in cover 2207. See, e.g., FIGS. 23A, 24A, and 25A for further depiction and description of non-limiting embodiments or aspects of pour-in cover 2207.

Referring now to FIG. 22B, shown is a perspective view of drink maker 2250 (e.g., drink maker 100) with mixing vessel 2254 (e.g., mixing vessel 104, mixing vessel 2000) having pour-in opening 2256 (e.g., pour-in opening 106, pour-in opening 2001), according to some non-limiting embodiments or aspects. Drink maker 2250 may include upper housing section 2272 (e.g., upper housing section 122) of housing 2252 (e.g., housing 102) to which mixing vessel 2254 is coupled, caused by action of lever 2260 (e.g., lever 110). Drink maker 2250 may include dispenser assembly 2258 (e.g., dispenser assembly 108), which may include handle 2270 (e.g., handle 120) and shroud 2266 (e.g., shroud 116). Drink maker 2200 may further include panel 2264 (e.g., panel 114), user interface 2262 (e.g., user interface 112), and drip tray 2268 (e.g., drip tray 118). As shown in FIG. 22B, pour-in opening 2256 further may include pour-in cover 2257. See, e.g., FIGS. 23B, 24B, and 25B for further depiction and description of non-limiting embodiments or aspects of pour-in cover 2257.

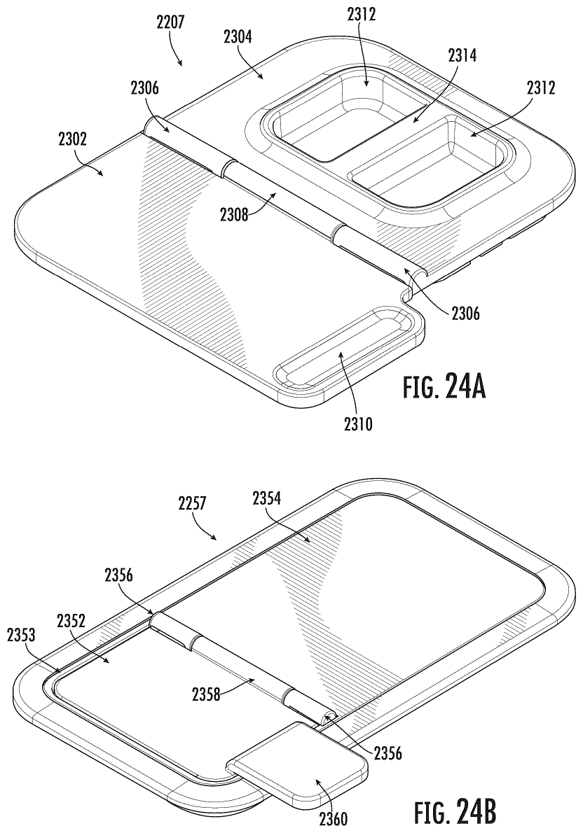

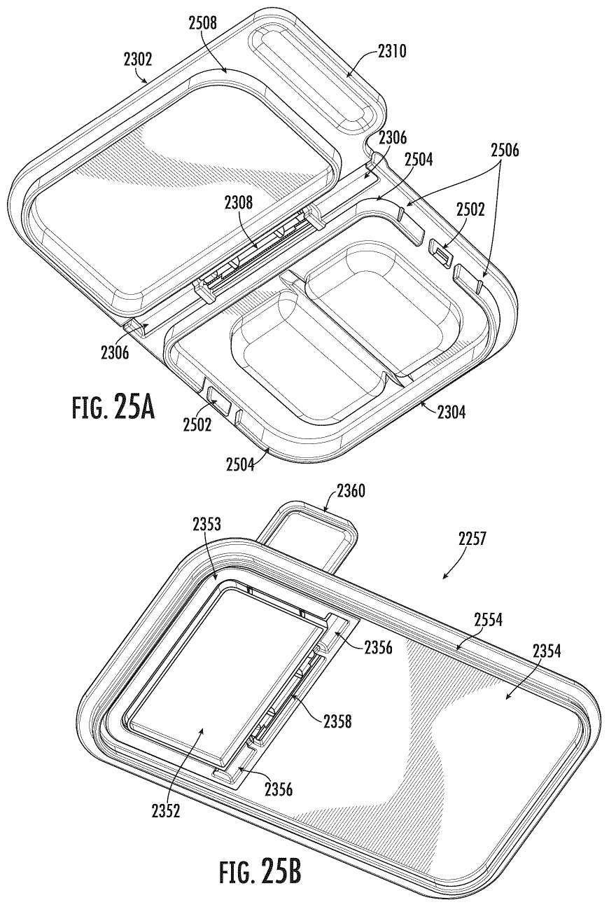

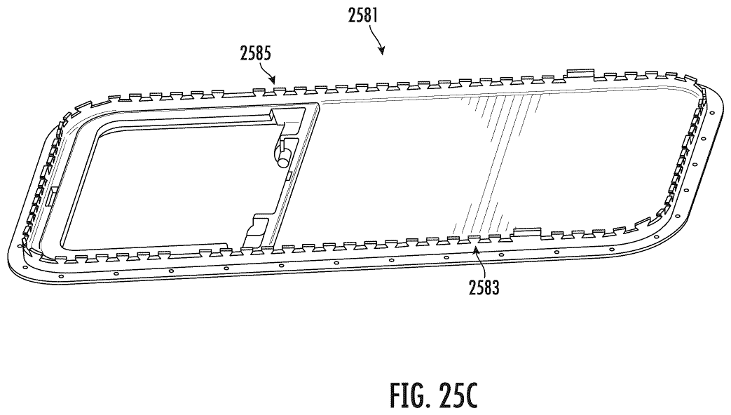

Referring now to FIGS. 23A, 24A, and 25A, shown are close-up views of pour-in opening 2206 and pour-in cover 2207, according to some non-limiting embodiments or aspects. In particular, FIG. 23A is a close-up, perspective view of mixing vessel 2204 having pour-in opening 2206 enclosed by pour-in cover 2207, FIG. 24A is a perspective view of pour-in cover 2207, and FIG. 25A is a bottom, perspective view of cover 2207. As shown, pour-in cover 2207 may include first side 2302, second side 2304, first hinge portion 2308, second hinge portions 2306, and/or grip protrusion 2310. As shown in FIG. 23A, pour-in cover 2207 may seat on and/or in an upper aperture of pour-in opening 2206 (e.g., aperture 2002), to prevent drink product from leaving/splashing out of pour-in opening 2206, and to prevent foreign objects from entering pour-in opening 2206.

With specific reference to FIGS. 23A and 24A, pour-in cover 2207 may include first side 2302 that may be lifted up by a user to access an interior of pour-in opening 2206 while pour-in cover 2207 is positioned over pour-in opening 2206. For this purpose, first side 2302 may include grip protrusion 2310, which may include an extended portion (e.g., past a perimeter of pour-in opening 2206) to allow a user to grasp first side 2302 and lift/lower first side 2302 of pour-in cover 2207. First side 2302 may be hingedly connected to second side 2304. For example, first side 2302 may be connected to first hinge portion 2308, which may rotate in-axis with second hinge portions 2306. In some non-limiting embodiments or aspects, first hinge portion 2308 may be fixed to and/or coextensive with first side 2302, and second hinge portions 2306 may be fixed to and/or coextensive with second side 2304. First side 2302 may be positioned more proximate to a front end of mixing vessel 2204, so as to improve access by a user, particularly if drink maker 2200 is at least partly positioned under an obstruction (e.g., a cabinet). It will be appreciated that by only opening a portion of an aperture of pour-in opening 2206 at a time (e.g., by lifting first side 2302), over-pouring and spilling may be reduced/eliminated.

With specific reference to FIGS. 23A and 24A, pour-in cover 2207 may include second side 2304 that remains stationary over pour-in opening 2206 while pour-in cover 2207 is in place over pour-in opening 2206. Second side 2304 may include a feature that allows a user to easily grip pour-in cover 2207 for installing/removing pour-in cover 2207 from pour-in opening 2206. For example, second side 2304 may include depressions 2312 that include cavities in a surface of second side 2304 and allows a user's fingers to extend down past an upper plane of pour-in cover 2207. Moreover, second side 2304 may include separator 2314 that acts as a grip point for a user's fingers to grasp pour-in cover 2207 to lift and/or deposit pour-in cover 2207. In this manner, a user may easily pick up and put down pour-in cover 2207 relative to pour-in opening 2206. Additionally, or alternatively, a user may use depressions 2312 and separator 2314 to be able to lift second side 2304 and/or pour-in cover 2307 to gain access to a great proportion of pour-in opening 2206. It will also be appreciated that removability of pour-in cover 2207 may promote cleanability of pour-in cover 2207.

With specific reference to FIG. 25A, pour-in cover 2207 may snugly fit in and/or on pour-in opening 2206, such that the user may lift first side 2302 without accidentally lifting other components of pour-in cover 2207. For example, pour-in cover 2207 may include first insert 2508 of first side 2302 that extends down from an upper plane of pour-in cover 2207 and interfaces with an upper/interior rim of pour-in opening 2206. Pour-in cover 2207 may further include second insert 2504 that extends down from an upper plane of pour-in cover 2207 and interfaces with an upper/interior rim of pour-in opening 2206. In this manner, pour-in cover 2207 may form a snap-fit, friction fit, press fit, and/or the like with pour-in opening 2206. By way of further example, pour-in cover 2207 may include detents 2502 (e.g., deflection clips) that allow second side 2304 of pour-in cover 2207 to form a snap-fit with pour-in opening 2206, to further secure pour-in cover 2207 while in place over pour-in opening 2206. Additionally, or alternatively, pour-in cover 2207 may include spacers 2506 (e.g., protrusions, which may be sloped and/or formed of a higher friction material) on an insert, such as second insert 2504, to encourage a friction/press fit with pour-in opening 2206 and prevent accidental removal of pour-in cover 2207.

Referring now to FIGS. 23B, 24B, and 25B, shown are close-up views of pour-in opening 2256 and pour-in cover 2257, according to some non-limiting embodiments or aspects. In particular, FIG. 23B is a close-up, perspective view of mixing vessel 2254 having pour-in opening 2256 enclosed by pour-in cover 2257, FIG. 24B is a perspective view of pour-in cover 2257, and FIG. 25B is a bottom, perspective view of cover 2257. As shown, pour-in cover 2257 may include door 2352, frame 2353, fixed side 2354, first hinge portion 2358, second hinge portions 2356, and/or grip protrusion 2360. As shown in FIG. 23B, pour-in cover 2257 may seat on and/or in an upper aperture of pour-in opening 2256 (e.g., aperture 2002), to prevent drink product from leaving/splashing out of pour-in opening 2256, and to prevent foreign objects from entering pour-in opening 2256.

With specific reference to FIGS. 23B and 24B, pour-in cover 2257 may have a portion that may be lifted up by a user to access an interior of pour-in opening 2256 while pour-in cover 2257 is positioned over pour-in opening 2256. For this purpose, door 2352 may include frame 2353, door 2352, and grip protrusion 2360, which may include an extended portion (e.g., past a perimeter of pour-in opening 2256) to allow a user to grasp onto a portion connected to door 2352 and lift/lower door 2352 of pour-in cover 2257 relative to frame 2353. Door 2352 may be hingedly connected to fixed side 2354. For example, door 2352 may be connected to first hinge portion 2358, which may rotate in-axis with second hinge portions 2356. In some non-limiting embodiments or aspects, first hinge portion 2358 may be fixed to and/or coextensive with door 2352, and second hinge portions 2356 may be fixed to and/or coextensive with fixed side 2354. Door 2352 may be positioned more proximate to a front end of mixing vessel 2254, so as to improve access by a user, particularly if drink maker 2250 is at least partly positioned under an obstruction (e.g., a cabinet). It will be appreciated that by only opening a portion of an aperture of pour-in opening 2256 at a time (e.g., by lifting door 2352), over-pouring and spilling may be reduced/eliminated.

With specific reference to FIGS. 23B and 24B, pour-in cover 2257 may include fixed side 2354 that remains stationary over pour-in opening 2256 while pour-in cover 2257 is in place over pour-in opening 2256. In some non-limiting embodiments or aspects, frame 2353 may extend around door 2352 and extend through and be included with fixed side 2354. In some non-limiting embodiments or aspects, a user may remove pour-in cover 2257 from pour-in opening 2256 by lifting up door 2352 and applying pressure on an underside of pour-in cover 2257. In some non-limiting embodiments or aspects, a user may remove pour-in cover 2257 from pour-in opening 2256 by gripping sides along edge of frame 2353 and lifting. It will also be appreciated that removability of pour-in cover 2257 may promote cleanability of pour-in cover 2257.

With specific reference to FIG. 25B, pour-in cover 2257 may snugly fit in and/or on pour-in opening 2256, such that the user may lift door 2352 without accidentally lifting other components of pour-in cover 2257. For example, pour-in cover 2257 may include insert 2554 that extends down from an upper plane of pour-in cover 2257 and interfaces with an upper/interior rim of pour-in opening 2256. In this manner, pour-in cover 2257 may form a snap-fit, friction fit, press fit, and/or the like with pour-in opening 2256.

Referring now to FIG. 25C, shown is a bottom perspective view of cover 2581 for a pour-in opening (e.g., pour-in opening 2001) of a drink maker, according to some non-limiting embodiments or aspects. As shown, flexible edge 2583 (e.g., rubber edge, silicone edge, etc.) of cover 2581 may be over-molded onto the substrate material (e.g., plastic) of cover 2581. Flexible edge 2583 may have increased surface area by way of dentition 2585 (e.g., a series of protrusions) along flexible edge 2583. Flexible edge 2583 may include dentition 2585. By increasing the surface area of flexible edge 2583, cover 2581 may have improved retention (e.g., grip onto the pour-in opening) when positioned on (e.g., over, around, and/or in) the pour-in opening. Furthermore, dentition 2585 provides individual flexibility in each protrusion of flexible edge 2583, increasing flexibility at any given point along flexible edge 2583 and improving ease of application and removal from the pour-in opening.

With further reference to FIGS. 23A-25C, cover 2207, cover 2257, and cover 2581 may provide at least a partial enclosure of an internal volume of their corresponding pour-in openings. When liquid is poured through the respective passages through covers 2207, 2257, 2581, liquid may be inclined to splash and rebound against the internal surfaces of the pour-in opening below. Because covers 2207, 2257, 2581 at least partly enclose and extend over their respective pour-in openings, liquid may be redirected back downward and may be reflected off of the bottom surface of covers 2207, 2257, 2581, instead of being spilled out of the pour-in opening.

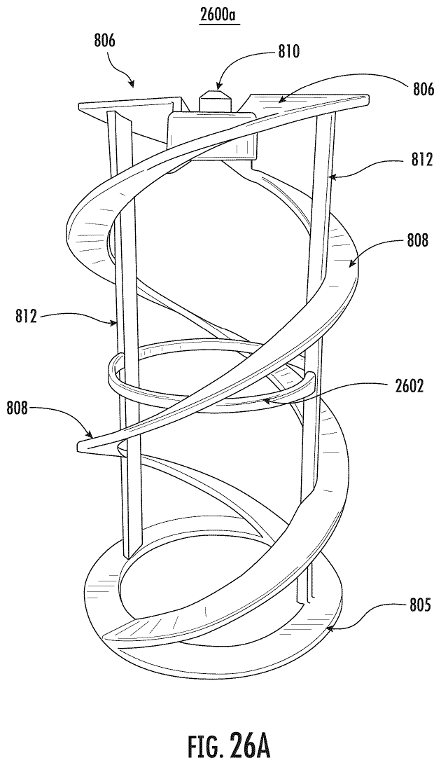

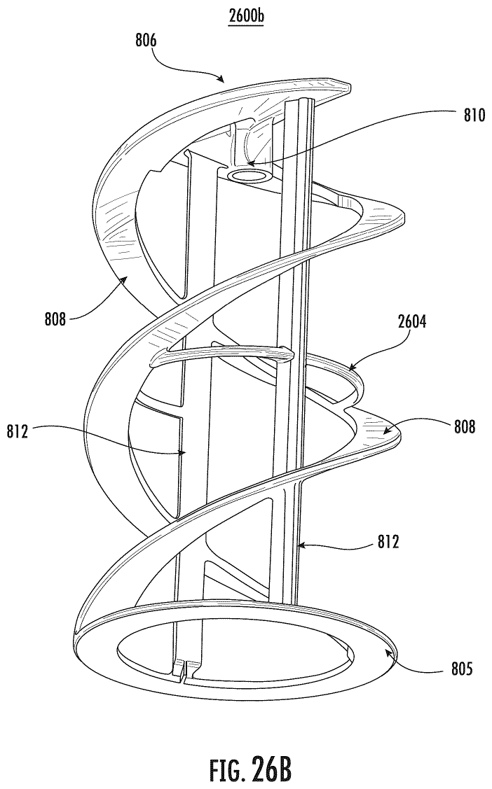

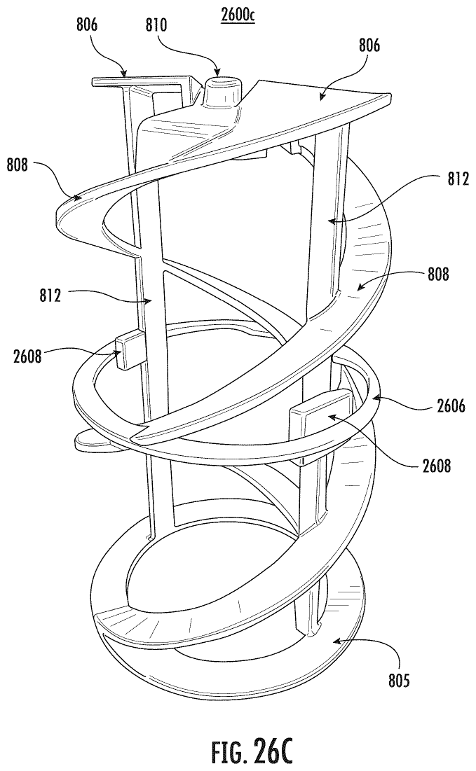

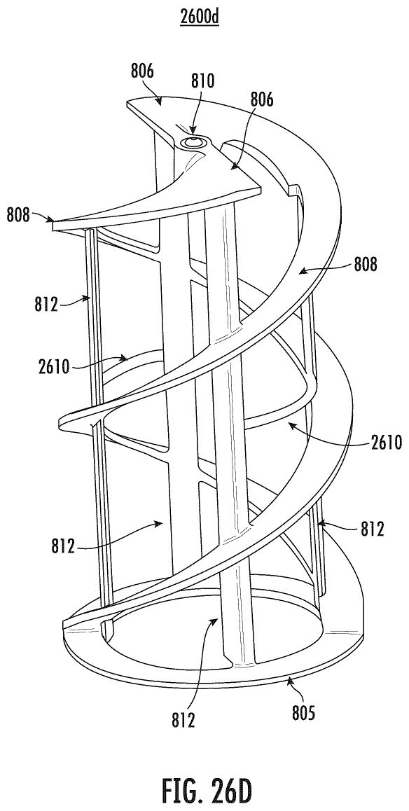

Referring now to FIGS. 26A-26C, shown are various examples of a dasher (e.g., dasher 204), according to some non-limiting embodiments or aspects. For illustration, FIG. 26A shows dasher 2600a, FIG. 26B shows dasher 2600b, and FIG. 26C shows dasher 2600c, according to some non-limiting embodiments or aspects. The dasher of each view depicts central hub 810 opposite mounting ring 805, with helical blades 808 extending from face blades 806 to mounting ring 805. Scraper blades 812 likewise connect from mounting ring 805 to face blade 806 and connect at various points to helical blades 808, improving structural stability. Dashers 2600a, 2600b, 2600c provide the improvement of reducing excessive ice buildup on dasher 204 and/or an evaporator (e.g., evaporator 202). For example, as evaporator 202 cools and causes ice crystals to form on an exterior surface thereof (e.g., a metal drum of evaporator 202), scraper blades 812 and an inner side of helical blades 808 are configured to contact the ice crystals and dislodge the ice crystals from evaporator 202. However, the resistive force of the ice crystals and/or drink product may cause scraper blades 812 and/or helical blades 808 to bow or flex outward slightly, increasing the gap between scraper blades 812 and/or helical blades 808 and evaporator 202, and reducing the scraping effect of scraper blades 812 and/or helical blades 808. Moreover, if scraper blades 812 and/or helical blades 808 flex too far, ice crystals may cling to evaporator 202 and/or dasher 204 rather than be deflected off into the greater drink product mixture. Ice buildup on evaporator 202 and/or dasher 204 may lead to stalling of drive motor 208. Dashers 2600a, 2600b, and 2600c provide improvements to enhance the rigidity of dasher 204 and/or counteract the displacing force of the ice crystals.

With reference to FIG. 26A, shown is dasher 2600a. In some non-limiting embodiments or aspects, dasher 2600a may be configured with reinforcement ring 2602 positioned between face blades 806 and mounting ring 805. Reinforcement ring 2602 may be a stabilizing, structural ring. Reinforcement ring 2602, as shown, may extend along a full 360° radial perimeter of the dasher. In some non-limiting embodiments or aspects, reinforcement ring 2602 may be positioned at or proximate to a middle of the dasher (e.g., along the length of the dasher). Reinforcement ring 2602 may have a circular, oval, rectangular, rounded rectangular, or other-shaped cross-section (e.g., taken along a direction from outside the dasher to an internal, middle axis of the dasher). Reinforcement ring 2602 may be shaped with a same circumferential shape as mounting ring 805, albeit with a same or different radius. Reinforcement ring 2602 may connect to one or more helical blades 808 and/or one or more scraper blades 812. For example, and as shown, reinforcement ring 2602 may connect, in sequence, a first helical blade 808, a first scraper blade 812, a second helical blade 808, and a second scraper blade 812 about the perimeter of reinforcement ring 2602 (e.g., including connecting the second scraper blade 812 to the first helical blade 808). Reinforcement ring 2602 may connect with each of the foregoing elements at an outer side of the element, an inner side of the element, and/or intersecting the element. In some non-limiting embodiments or aspects, multiple reinforcement rings 2602 may be positioned along a length of the dasher.

In some non-limiting embodiments or aspects, reinforcement ring 2602 may be at least partly attached to the dasher after formation (e.g., molding). Additionally, or alternatively, reinforcement ring 2602 may be at least partly co-formed (e.g., co-molded) with the dasher during formation (e.g., molding). Reinforcement ring 2602 may be formed of a durable, rigid plastic material, such as, but not limited to, polyoxymethylene (POM), polycarbonate (PC), polypropylene (PP), nylon, polybutylene terephthalate (PBT), and/or the like. As ice crystals push against scraper blades 812 and/or helical blades 808, such as in the gap between evaporator 202 and scraper blades 812 and/or helical blades 808, reinforcement ring 2602 may act to reduce the flexing of scraper blades 812 and/or helical blades 808, and/or counteract the displacing force of the ice crystal formation (e.g., by increasing radial stiffness).

With specific reference to FIG. 26B, shown is dasher 2600b. In some non-limiting embodiments or aspects, dasher 2600b may be configured with reinforcement ring 2604 positioned between face blades 806 and mounting ring 805. Reinforcement ring 2604 may be a stabilizing, structural ring. Reinforcement ring 2604, as shown, may extend less than a full 360° radial perimeter of the dasher (e.g., 270°, 180°, two sets of 90°, etc.). In some non-limiting embodiments or aspects, reinforcement ring 2604 may extend along 240° to 300° of the radial perimeter of the dasher. In some non-limiting embodiments or aspects, reinforcement ring 2604 may extend along approximately 270° of the radial perimeter of the dasher. In some non-limiting embodiments or aspects, reinforcement ring 2604 may be positioned at or proximate to a middle of the dasher (e.g., along the length of the dasher). Reinforcement ring 2604 may have a circular, oval, rectangular, rounded rectangular, or other-shaped cross-section (e.g., taken along a direction from outside the dasher to an internal, middle axis of the dasher). Reinforcement ring 2604 may be shaped with a partial circumferential shape corresponding to mounting ring 805, albeit with a same or different radius and not fully extending around the radial perimeter of the dasher. Reinforcement ring 2604 may connect to one or more helical blades 808 and/or one or more scraper blades 812. For example, and as shown, reinforcement ring 2604 may connect, in sequence, a first helical blade 808, a first scraper blade 812, a second helical blade 808, and a second scraper blade 812 about the perimeter of reinforcement ring 2604 (e.g., but not connecting the second scraper blade 812 to the first helical blade 808). Reinforcement ring 2604 may connect with each of the foregoing elements at an outer side of the element, an inner side of the element, and/or intersecting the element. In some non-limiting embodiments or aspects, multiple reinforcement rings 2604 may be positioned along a length of the dasher. It will also be appreciated that a dasher may include a combination of reinforcement ring 2602 and/or reinforcement ring 2604.

In some non-limiting embodiments or aspects, reinforcement ring 2604 may be at least partly attached to the dasher after formation (e.g., molding). Additionally, or alternatively, reinforcement ring 2604 may be at least partly co-formed (e.g., co-molded) with the dasher during formation (e.g., molding). Reinforcement ring 2604 may be formed of a durable, rigid plastic material, such as, but not limited to, polyoxymethylene (POM), polycarbonate (PC), polypropylene (PP), nylon, polybutylene terephthalate (PBT), and/or the like. As ice crystals push against scraper blades 812 and/or helical blades 808, such as in the gap between evaporator 202 and scraper blades 812 and/or helical blades 808, reinforcement ring 2604 may act to reduce the flexing of scraper blades 812 and/or helical blades 808, and/or counteract the displacing force of the ice crystal formation (e.g., by increasing radial stiffness). By not extending around the entirety of the radial perimeter of the dasher, reinforcement ring 2604 may provide an optimal balance of rigidity and flexibility, which also reducing overall material requirements.

With specific reference to FIG. 26C, shown is dasher 2600c. In some non-limiting embodiments or aspects, dasher 2600c may be configured with reinforcement ring 2606 positioned between face blades 806 and mounting ring 805. Reinforcement ring 2606 may be a compression ring. Reinforcement ring 2606, as shown, may extend around a full 360° radial perimeter of the dasher. In some non-limiting embodiments or aspects, reinforcement ring 2606 may be positioned at or proximate to a middle of the dasher (e.g., along the length of the dasher). Reinforcement ring 2606 may have a circular, oval, rectangular, rounded rectangular, or other-shaped cross-section (e.g., taken along a direction from outside the dasher to an internal, middle axis of the dasher). Reinforcement ring 2606 may be shaped with a circumferential shape approximately corresponding to mounting ring 805, albeit with a same or different radius and subject to flexion. In some non-limiting embodiments or aspects, the radius of reinforcement ring 2606 may be less than (e.g., slightly less than, substantially less than, and/or the like) the radius of mounting ring 805 and/or the radius of evaporator 202 (e.g., reinforcement ring 2606 may flex around and/or apply compression to the surface of evaporator 202). Reinforcement ring 2606 may connect to one or more helical blades 808 and/or one or more scraper blades 812. For example, and as shown, reinforcement ring 2606 may connect, in sequence, a first helical blade 808, a first scraper blade 812, a second helical blade 808, and a second scraper blade 812 about the perimeter of reinforcement ring 2606 (e.g., including connecting the second scraper blade 812 to the first helical blade 808). Reinforcement ring 2606 may connect with each of the foregoing elements at an outer side of the element and/or partly within the element. In some non-limiting embodiments or aspects, multiple reinforcement rings 2606 may be positioned along a length of the dasher. It will also be appreciated that a dasher may include a combination of reinforcement ring 2602, reinforcement ring 2604, and/or reinforcement ring 2606.

In some non-limiting embodiments or aspects, reinforcement ring 2606 may be at least partly attached to the dasher after formation (e.g., molding). Reinforcement ring 2606 may be formed of a durable, elastic material such as, but not limited to, silicone rubber, thermoplastic elastomers, thermoplastic polyurethane, ethylene propylene diene monomer (EPDM) rubber, and/or the like. Reinforcement ring 2606 may be connected to helical blades 808 and/or scraper blades 812 using mounts 2608 (e.g., fastener elements). Additionally, or alternatively, helical blades 808 and/or scraper blades 812 may include notches, holes, channels, grooves, and/or the like in which reinforcement ring 2606 may be at least partly seated. In some non-limiting embodiments or aspects, reinforcement ring 2606 may be removably attachable to the dasher. As ice crystals push against scraper blades 812 and/or helical blades 808, such as in the gap between evaporator 202 and scraper blades 812 and/or helical blades 808, reinforcement ring 2606 may act to reduce the flexing of scraper blades 812 and/or helical blades 808, and/or counteract the displacing force of the ice crystal formation (e.g., by providing a counter-acting elastic force).

With specific reference to FIG. 26D, shown is dasher 2600d. In some non-limiting embodiments or aspects, dasher 2600d may be configured with reinforcement ring 2610 positioned between face blades 806 and mounting ring 805. Reinforcement ring 2610 may include a plurality of segments of a stabilizing, structural ring. In some non-limiting embodiments or aspects, reinforcement ring 2610 may include a first ring segment and a second ring segment about the perimeter of reinforcement ring 2610, in which the first ring segment and the second ring segment are not continuously connected. For example, the first ring segment may extend along approximately 90° of the radial perimeter of dasher 2600d, and the second ring segment may extend along approximately 90° of the radial perimeter of dasher 2600d, wherein the first ring segment is positioned on a side opposite the second ring segment. Each ring segment of reinforcement ring 2610 may connect two or more scraper blades 812 and/or helical blades 808. For example, a first ring segment of reinforcement ring 2610 may connect first scraper blade 812 to second scraper blade 812, and a second ring segment of reinforcement ring 2610 may connect third scraper blade 812 to fourth scraper blade 812. It will be appreciated that reinforcement ring 2610 may nonetheless be referred to as a ring despite not fully encompassing a perimeter of dasher 2600d.

In some non-limiting embodiments or aspects, reinforcement ring 2610 may be at least partly attached to the dasher after formation (e.g., molding). Additionally, or alternatively, reinforcement ring 2610 may be at least partly co-formed (e.g., co-molded) with the dasher during formation (e.g., molding). Reinforcement ring 2610 may be formed of a durable, rigid plastic material, such as, but not limited to, polyoxymethylene (POM), polycarbonate (PC), polypropylene (PP), nylon, polybutylene terephthalate (PBT), and/or the like. As ice crystals push against scraper blades 812 and/or helical blades 808, such as in the gap between evaporator 202 and scraper blades 812 and/or helical blades 808, reinforcement ring 2610 may act to reduce the flexing of scraper blades 812 and/or helical blades 808, and/or counteract the displacing force of the ice crystal formation (e.g., by increasing radial stiffness).

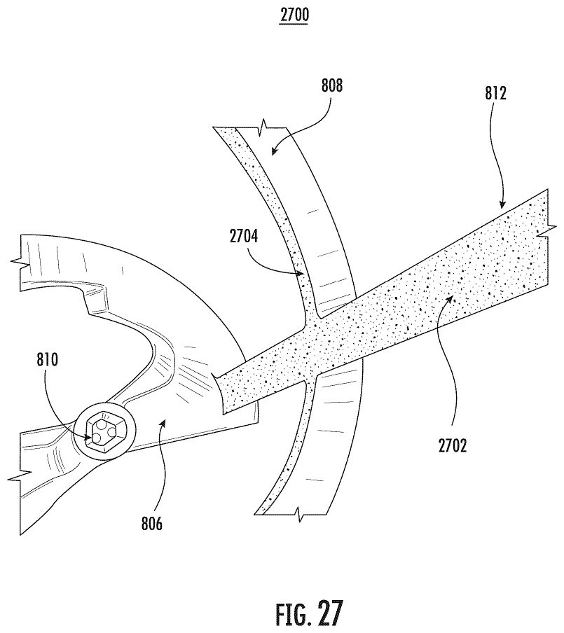

Referring now to FIG. 27, shown is a close-up, midline view of a dasher 2700 (e.g., dasher 204), according to some non-limiting embodiments or aspects. As shown, the dasher includes at least one helical blade 808, at least one scraper blade 812, mounting hub 810, and face blade 806. The perspective of FIG. 27 is from an interior of the dasher looking outward, observing inner side 2702 of scraper blade 812 and inner side 2704 of helical blade 808. When scraper blade 812 and/or helical blade 808 passes over evaporator 202 and encounters ice crystals formed on the outer surface of evaporator 202, at least part of the ice crystals will come into contact with inner side 2702 of scraper blade 812 and/or inner side 2704 of helical blade 808. If inner side 2702 and/or inner side 2704 are too smooth and/or highly polished, the ice crystals may slip past scraper blade 812 and/or helical blade 808, and/or not be imparted with as much scraping force, which may increase a likelihood of ice buildup on evaporator 202 and/or the dasher. To counteract this condition, inner side 2702 and/or inner side 2704 may be provided with a roughened, higher friction, and/or uneven surface (collectively referred to as a “rough surface”). The rough surface of inner side 2702 and/or inner side 2704 may improve the scraping ability of scraper blade 812 and/or helical blade 808 to remove ice crystals from evaporator 202. In some non-limiting embodiments or aspects, an optimized rough surface may have roughness in the range of 3.5-7.3 microns, such as 5 microns on the roughness average (RA) scale. A rough surface on inner side 2702 and/or inner side 2704 may also reduce operational noise of the machine that might otherwise result from overtaxing drive motor 208 or grinding against ice buildup with less effect.

In some non-limiting embodiments or aspects, scraper blade 812 and/or helical blade 808 may be molded in a mold with a partly uneven surface, such that inner side 2702 and/or inner side 2704 are molded to have a rough surface. In some non-limiting embodiments or aspects, inner side 2702 and/or inner side 2704 may be processed after molding to abrade and/or roughen inner side 2702 and/or inner side 2704 (e.g., sanding, sandblasting, etc.), decreasing a smoothness of inner side 2702 and/or inner side 2704. In some non-limiting embodiments or aspects, a coating may be applied to inner side 2702 and/or inner side 2704 after molding and/or processing to further increase a roughness of inner side 2702 and/or inner side 2704. In some non-limiting embodiments or aspects, additional structures may be attached to inner side 2702 and/or inner side 2704 to break up the plane of inner side 2702 and/or inner side 2704 and increase an overall roughness of inner side 2702 and/or inner side 2704. In such embodiments, the rough surface of inner side 2702 and/or inner side 2704 may improve the ability of the dasher to dislodge ice crystals that form on the exterior surface of evaporator 202.

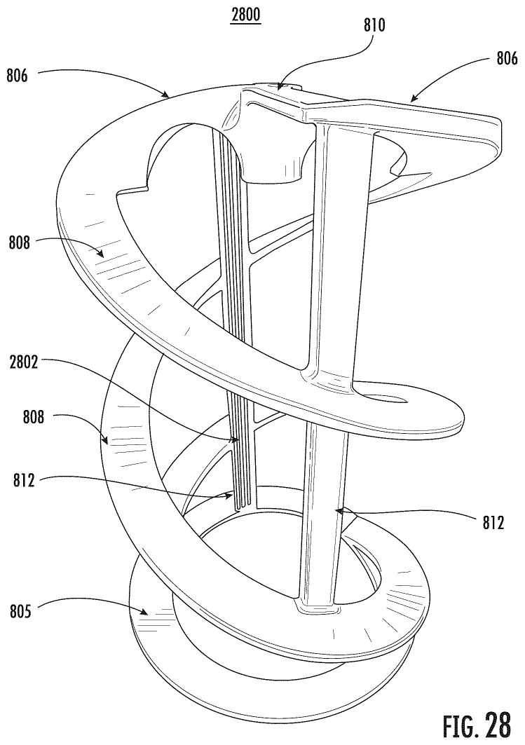

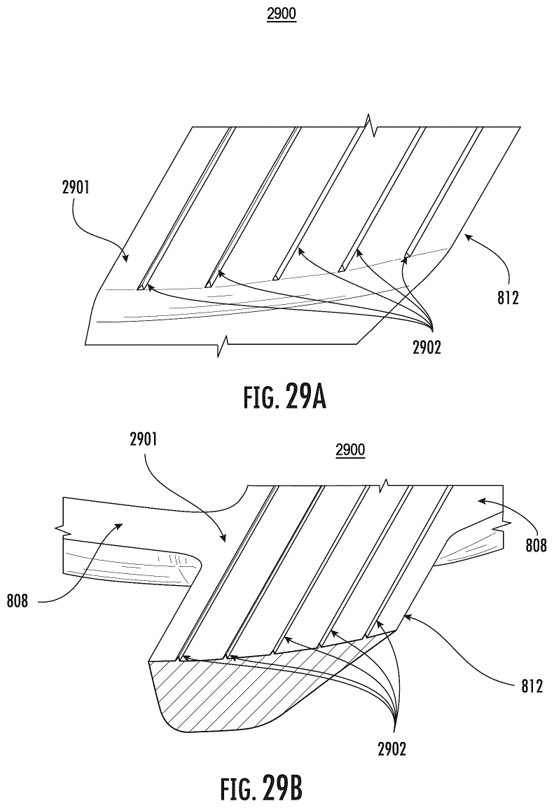

Referring now to FIG. 28, shown is a side-angle view of a dasher 2800 (e.g., dasher 204), according to some non-limiting embodiments or aspects. As shown, dasher 2800 may include face blades 806 that connect to central hub 810 on one end, and mounting ring 805 on an end opposite central hub 810. At least one helical blade 808 may extend between the ends. Furthermore, at least one scraper blade 812 may extend between the ends. On an inner surface of one or more scraper blades 812 may be one or more ribs 2802 (e.g., micro-rails) extending lengthwise along scraper blade 812. Ribs 2802 may extend in a direction parallel to, or approximately parallel to, a major axis of scraper blade 812. In some non-limiting embodiments or aspects, ribs 2802 may be co-formed with scraper blade 812 (e.g., co-molded). In some non-limiting embodiments or aspects, scraper blades 812 may be tooled to attach and/or embed ribs 2802 in an inner side of scraper blades 812. Ribs 2802 may have an angled cross-section, such as a triangular cross-section (see, e.g., FIGS. 29A and 29B) to further promote the removal of ice crystals from an exterior surface of evaporator 202. A height of ribs 2802 may be less than or equal to 1 mm (e.g., 0.2 mm tall) to minimize the size of the gap between helical blades 808 and/or scraper blades 812 and an exterior surface of evaporator 202, which may promote efficient scraping.

In some non-limiting embodiments or aspects, the number of ribs 2802 may vary. For example, at least three ribs 2802 may be configured lengthwise along each scraper blade 812. By way of further example, at least five ribs 2802 may be configured lengthwise along each scraper blade 812. In some non-limiting embodiments or aspects, each rib 2802 may be spaced uniformly apart from each other rib 2802 on a same scraper blade 812. It will also be appreciated that helical ribs (not shown) may be mounted on an inner side of helical blades 808, in addition to or alternatively to including ribs 2802 on scraper blade 812. The use of ribs 2802 on scraper blades 812 may reduce tooling complexity relative to the inclusion of helical ribs on helical blades 808. Each rib 2802 may be formed of a same or similar material to the material of scraper blade 812. In some non-limiting embodiments or aspects, ribs 2802 may be formed of a durable, plastic material that is resistant to deformation after repeated cycles and interactions with ice crystals. It will also be appreciated that ribs 2802 may be likewise provided on helical blades 808.

Referring now to FIGS. 29A and 29B, shown are a close-up, excerpt views of a dasher 2900 (e.g., dasher 204), according to some non-limiting embodiments or aspects. FIG. 29A depicts a portion of scraper blade 812 configured with a plurality of ribs 2902 (e.g., ribs 2802) spaced apart on inner surface 2901 of scraper blade 812. Inner surface 2901 may be oriented facing an exterior surface of evaporator 202, such that as the dasher spins, ribs 2902 and/or inner surface 2901 contact the ice crystals that form on the exterior surface of evaporator 202. In some non-limiting embodiments or aspects, ribs 2902 may include five or more ribs 2902 oriented lengthwise and substantially parallel to the length of scraper blade 812. A cross-section of each rib 2902 may be angular (e.g., triangular), to improve the scraping function of scraper blade 812 and minimize the clinging of ice crystals to inner surface 2901. The apex of each rib 2902 may be the farthest extension of scraper blade 812 from inner surface 2901 and may provide the greatest dislodging force on ice crystals that have formed, with the leading rib 2902 in the direction of rotation acting as first-contact among the set of ribs 2902. With specific reference to FIG. 29B, ribs 2902 may extend along scraper blade 812 over and beyond an inner side of a helical blade 808 that intersects with scraper blade 812. In some non-limiting embodiments or aspects, ribs 2902 may be co-formed with inner surface 2901, attached to inner surface 2901, embedded in inner surface 2901, and/or the like.

In some non-limiting embodiments or aspects, dasher 204 may be the same as or similar to at least one of dasher 2600a, dasher 2600b, dasher 2600c, dasher 2700, dasher 2800, dasher 2900, any combination thereof, and/or the like. In some non-limiting embodiments or aspects, to the extent possible, one or more features of any of dasher 2600a, dasher 2600b, dasher 2600c, dasher 2700, dasher 2800, and/or dasher 2900 may be combined with one or more features of any other of dasher 2600a, dasher 2600b, dasher 2600c, dasher 2700, dasher 2800, and/or dasher 2900.

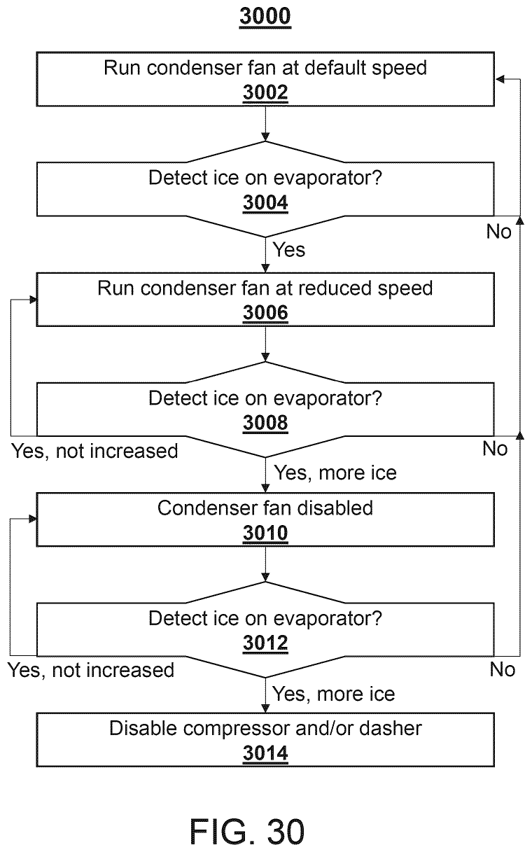

Referring now to FIG. 30, shown is a flow diagram of method 3000 for controlling a drink maker (e.g., drink maker 100), according to some non-limiting embodiments or aspects. The steps shown in FIG. 30 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. In some non-limiting embodiments or aspects, one or more of the steps of method 300 may be performed (e.g., completely, partially, and/or the like) by control system 400 and/or controller 402. In some non-limiting embodiments or aspects, one or more of the steps of method 300 may be performed (e.g., completely, partially, and/or the like) by another system, another device, another group of systems, or another group of devices, separate from or including control system 400 and/or controller 402.

As shown in FIG. 30, at step 3002, method 3000 may include running condenser fan 218 at a default speed. For example, controller 402 may run condenser fan 218 at a default speed (e.g., a default level of movement in air volume) during a primary cooling stage. As the drink product is cooling down, and before substantial or any ice crystal formation, controller 402 may control condenser fan 218 to operate at a first speed setting.

In some non-limiting embodiments or aspects, condenser fan 218 may include a brushed DC motor. To run condenser fan 218 at a default speed, controller 402 may supply condenser fan 218 with a maximum voltage (e.g., 12V) power input to run at 100% speed. In some non-limiting embodiments or aspects, condenser fan 218 may include a brushless DC motor. To run condenser fan 218 at a default speed, controller 402 may supply condenser fan 218 with a control signal (e.g., pulse width modulation (PWM) signal) configured to cause condenser fan 218 to determine a 100% operational duty cycle.

As shown in FIG. 30, at step 3004, method 3000 may include determining whether there is ice on the evaporator (e.g., evaporator 202). For example, controller 402 may determine the presence of ice, including an amount thereof, on a surface of evaporator 202. If ice is detected, method 3000 may proceed to step 3006. If no ice is detected, method 3000 may proceed back to step 3002 to continue to run condenser fan 218 at a default speed (e.g., unreduced). Step 3004 may be executed periodically (e.g., every several seconds) to monitor the condition of the drink product and to detect ice when ice first forms on the surface of evaporator 202, contributing to ice buildup.

In some non-limiting embodiments or aspects, the presence and amount of ice on evaporator 202 may be determined based on an electrical/mechanical proxy, such as a motor condition (e.g., motor current, voltage, resistance, etc.) determined by a motor signal of a drive motor (e.g., drive motor 208). As ice builds up on evaporator 202, drive motor 208 may encounter greater resistance and require more power to operate at the same cycle speed. More ice buildup may result in more power required to operate drive motor 208 at the same cycle speed. From these measures, controller 402 may not only detect a presence of ice, but controller 402 may further detect an amount of ice on evaporator 202.

As shown in FIG. 30, at step 3006, method 3000 may include running condenser fan 218 at a reduced speed. For example, controller 402 may, in response to detecting ice on evaporator 202 at step 3004, run condenser fan 218 at a second speed setting that is slower than the default speed setting. By running condenser fan 218 at a slower speed, condenser fan 218 may produce reduced airflow over condenser 216. Less airflow may result in less heat expelled from condenser 216. Less heat expelled from condenser 216 may produce less of an enthalpy drop across the expansion valve and produce a net lower cooling effect at evaporator 202. With a smaller temperature gradient between evaporator 202 and the cooling drink product, less heat may be absorbed from the drink product, which may slow the formation of ice crystals on the surface of evaporator 202. Controlling the speed of condenser fan 218 may have an advantage over cycling compressor 214, as compressor 214 may not be able to be cycled over short time intervals (e.g., as compared to condenser fan 218, which can be short-cycled), due to the presence of high-pressure refrigerant in the discharge line and condenser 216. If compressor 214 is restarted before pressure equalizes, compressor 214 may be restarting against a high head pressure, which may lead to stalling and/or damage to the compressor 214.

In some non-limiting embodiments or aspects, where condenser fan 218 includes a brushed DC motor, controller 402 may supply condenser fan 218 with a less-than-maximum voltage (e.g., 9V) power input to run condenser fan 218 at a reduced speed (e.g., 75% speed). In some non-limiting embodiments or aspects, where condenser fan 218 includes a brushless DC motor, controller 402 may supply condenser fan 218 with a control signal configured to cause condenser fan 218 to determine a reduced duty cycle (e.g., 75% operational duty cycle).

As shown in FIG. 30, at step 3008, method 3000 may include detecting ice on evaporator 202. For example, controller 402 may determine the presence of ice on evaporator 202, which may include an amount of ice on evaporator 202. If there is no longer ice on evaporator 202, method 3000 may proceed back to step 3002, to return condenser fan 218 to the default speed. If there is ice on evaporator 202, but the amount of ice has not continued to increase, controller 402 may maintain condenser fan 218 at the reduced speed at step 3006. If there is even more ice on evaporator 202 than last detected (e.g., at step 3004), method 3000 may proceed to step 3010. It will be appreciated that step 3008 may be repeated multiple times while the same level of ice is detected as remaining on evaporator 202. If controller 402 determines that operational conditions of the cooling circuit become dangerous, detrimental, or unsafe to continue running condenser fan 218 at a reduced speed, controller 402 may return to step 3002 and/or disable compressor 214 and/or dasher 204 for a short time.

As shown in FIG. 30, at step 3010, method 3000 may include disabling condenser fan 218. For example, controller 402 may disable (e.g., deactivate, turn off, stop) condenser fan 218 in response to detecting ice on evaporator 202, particularly detecting more ice on evaporator 202 even after condenser fan 218 was reduced in speed at step 3006.

In some non-limiting embodiments or aspects, selectively deactivating condenser fan 218 while maintaining compressor 214 operation may be advantageously employed to modulate the cooling rate of the cooling circuit. By halting airflow across condenser 216, the rate of heat rejection to the environment may be temporarily reduced, causing the condensing pressure and temperature to rise in a controlled manner. This may result in a decrease in the thermodynamic efficiency of the expansion process, as the refrigerant entering the expansion device may be at a higher temperature or partially vaporized, thereby reducing the cooling effect at evaporator 202. This technique enables fine-tuned regulation of cooling output without cycling compressor 214, which may be beneficial in dampening rapid temperature changes in the cooled environment. To mitigate potential adverse effects, such as compressor 214 overloading or pressure imbalances, various operational parameters may be dynamically monitored and adjusted by controller 402. These may include limiting the duration of deactivating condenser fan 218, monitoring high-side pressure or compressor 214 discharge temperature, and enabling reactivation of cooling fan 218 when predefined thresholds (e.g., threshold times, threshold pressures) are approached.

As shown in FIG. 30, at step 3012, method 3000 may include detecting ice on evaporator 202. For example, controller 402 may determine the presence of ice on evaporator 202, which may include an amount of ice on evaporator 202. If there is no longer ice on evaporator 202, method 3000 may proceed back to step 3002, to return condenser fan 218 to the default speed. If there is ice on evaporator 202 but the amount of ice has not continued to increase, controller 402 may keep condenser fan 218 off, while monitoring operational conditions of cooling circuit. If there is even more ice on evaporator 202 than last detected (e.g., at step 2008), method 3000 may proceed to step 3014. It will be appreciated that step 3012 may be repeated multiple times while the same level of ice is detected as remaining on evaporator 202. If controller 402 determines that operational conditions of the cooling circuit become dangerous, detrimental, or unsafe to continue keeping condenser fan 218 off, controller 402 may return to step 3002 or 3006, and/or disable compressor 214 and/or dasher 204 for a short time.

As shown in FIG. 30, at step 3014, method 3000 may include disabling compressor 214 and/or dasher 204. For example, controller 402 may, in response to determining that ice continues to be present on evaporator 202 (including increasing in buildup without mitigation despite cycling condenser fan 218 to a lower speed or off), disable compressor 214 and/or dasher 204 (e.g., by deactivating drive motor 208). By disabling compressor 214, the temperature drop in the drink product at the surface of evaporator 202 may be slowed, stopped, or even reversed, allowing ice buildup to clear from evaporator 202. By disabling drive motor 208, damage to or stalling of drive motor 208 may be avoided.

In some non-limiting embodiments or aspects, when compressor 214 is disabled, the cooling circuit may immediately cease to drive the refrigerant through the cycle, halting active cooling. As this happens, no more refrigerant evaporates or condenses in a meaningful way, so no heat may be absorbed from the environment around the surface of evaporator 202. When compressor 214 is disabled, condenser fan 218 may either be disabled or continue running briefly to dissipate remaining heat or to stabilize internal temperature.

With further reference to the foregoing figures, evaporator 202 may be further modified to reduce the likelihood of ice building on a surface of evaporator 202 (e.g., a metal drum thereof). By increasing a smoothness or lowering a coefficient of friction of an outer surface of evaporator 202, ice crystals may be less likely to cling and may be more easily dislodged by dasher 204. To create sufficient slipperiness, the outer surface of dasher 204 may undergo a polishing process. Additionally, or alternatively, a coating may be applied to an outer surface of evaporator 202 to increase the non-stick properties of evaporator 202. The slickening of evaporator 202 may be employed in conjunction with other embodiments described herein, to further reduce the likelihood of ice buildup on evaporator 202 and promote more uniform ice crystal formation in the mass of drink product in mixing vessel 104.

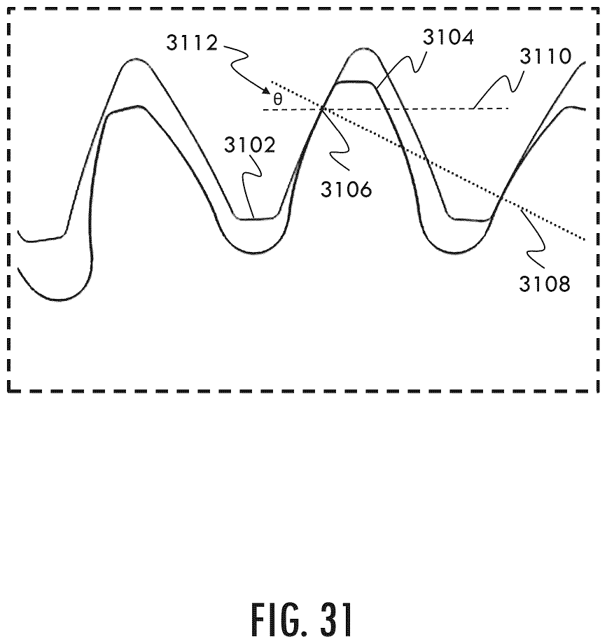

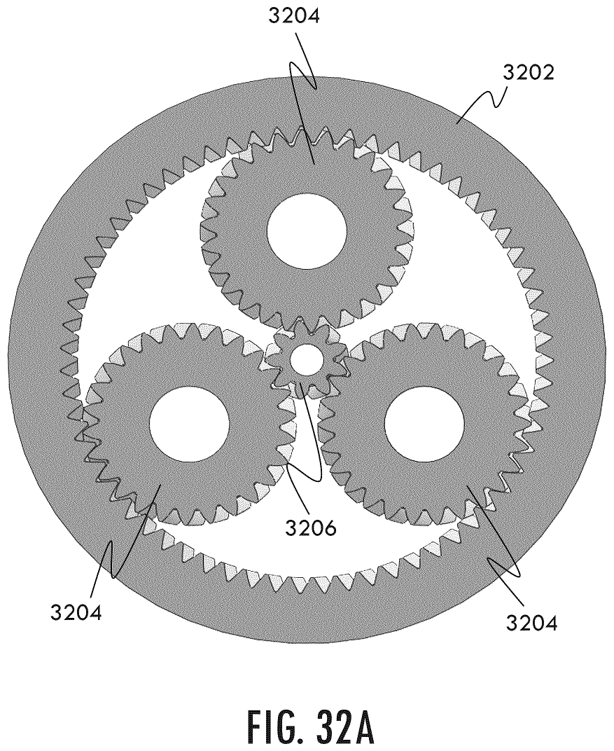

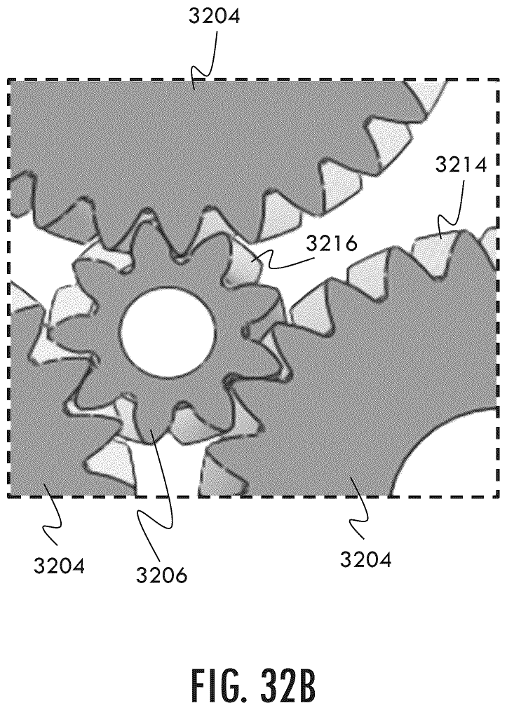

Referring now to FIG. 31, shown is a close-up view of a zone of engagement between two gears in a gear assembly of a drink maker, according to some non-limiting embodiments or aspects. For example, the example zone of engagement may be employed for gear assembly 210 of drink maker 100. Gear assembly 210 may include a planetary gear system. A planetary gear system may reduce rotational speed by distributing motion through a set of intermeshing gears arranged around a central axis. The system may include a central sun gear, multiple planet gears that rotate around the sun gear, a ring gear with internal teeth that engages with the planet gears, and a planet carrier that supports and holds the planet gears in position (see, e.g., FIG. 32A). Speed reduction may occur when one of these components is held stationary while torque is applied to another. For example, when the ring gear is fixed, torque may be applied to the sun gear. The planet carrier may be used as the output, and the planet gears may revolve around the sun while rotating on their own axes, causing the planet carrier to turn at a reduced rotational speed relative to the sun gear. The ratio of speed reduction depends on the relative number of teeth on the sun and ring gears. This arrangement enables compact transmission of high torque at lower rotational speeds. For example, dasher motor 208 running at approximately 3500 rotations per minute (RPM) may undergo between a 50- and 70-fold reduction in RPM through a multi-stage planetary gearbox, which may result in vibration and noise. As such, tooth profile optimization, among other mitigating design considerations, may be beneficial to reduce overall generated noise.

Individual projecting features on a gear may each be referred to as a gear tooth. Each tooth may have a tip (e.g., crest) at the outermost edge thereof, bounded radially by the addendum circle (e.g., the outside diameter). The tooth surfaces that transmit load may be referred to as the flanks. A driving flank of a tooth of one gear may apply pressure to a working flank of another gear. The flank of a gear tooth opposite the driving flank on the same tooth may be referred to as the coast flank. At the bottom in the valley between teeth is the root, bounded at its minimum by the root circle or dedendum circle (e.g., inside diameter). The curved transition between teeth may be referred to as the fillet. The depth of the tooth (e.g., thickness of flank) may be referred to as the face width. The top surface of an individual tooth may be referred to as the top land (e.g., tooth crest). Conversely, the surface at the bottom between teeth may be referred to as the bottom land or root surface. The distance from the center axis of the gear to the crest of a tooth may be referred to as the tip diameter. The pitch of the flank of a tooth may be referred to as the pressure angle (e.g., pressure angle 3112). In FIG. 31, pressure line 3108 demonstrates the angle that force is applied between a driving flank and a working flank, and the pressure angle may be interpreted as angle 3112 between pressure line 3108 and horizontal 3110.

In some non-limiting embodiments or aspects, the pressure angle between a driving flank of a first gear (e.g., a sun gear of a planetary gear system) and a working flank of a second gear (e.g., a planet gear of a planetary gear system) may be optimized to reduce vibration and noise. A larger pressure angle may result in a more even spread of forces between teeth. Spreading forces may result in lowering stress between teeth. Lowering stress may be beneficial to reduce material wear of gears. By optimizing the pressure angle between gear teeth, a gear assembly may operate more smoothly, reducing vibration and noise during operation of a drink maker.

As shown in FIG. 31, pressure angle 3112 on gear teeth of the gear assembly may be approximately 20 degrees, to balance performance and noise reduction. For example, each tooth 3104 of a planetary gear may have a pressure angle (e.g., perpendicular to pressure line 3108) that is approximately 20 degrees. Each tooth 3102 of a ring gear (e.g., surrounding the planetary gears) may have a corresponding pressure angle 3112 that is approximately 20 degrees. At the point of contact 3106 between a tooth 3104 of a planetary gear and a tooth 3102 of a ring gear, the angles and fit may be complementary to ensure the smooth transfer of force between the planetary gear and the ring gear. As shown, the planetary gear is rotating counterclockwise by action of tooth 3104, and tooth 3102 of ring gear is receiving the rotational force at point of contact 3106 by the planetary gear. It will be appreciated that the sun gear of a planetary gear system may likewise have a pressure angle of approximately 20 degrees and the sun gear's fit with each planetary gear may likewise be optimized.

Referring now to FIGS. 32A and 32B, shown are views of planetary gear system configurations for a gear assembly (e.g., gear assembly 210) of a drink maker (e.g., drink maker 100), according to some non-limiting embodiments or aspects. In particular, FIG. 32A shows a wide-angle view of the planetary gear system, and FIG. 32B shows a close-up view of the same planetary gear system. The depicted planetary gear system may include sun gear 3206, a plurality of planetary gears 3204 (e.g., three planetary gears), and a ring gear 3202. FIG. 32B is a close-up of sun gear 3206 and planetary gears 3204.

As shown in FIGS. 32A and 32B, the teeth of sun gear 3206, planetary gears 3204, and/or ring gear 3202 may be helical. A tooth profile may be described as helical when the teeth are cut at an angle to the gear's axis of rotation, rather than running straight across as in a spur gear. The angled orientation may cause the teeth to engage gradually, starting at one end and progressing smoothly across the tooth face, rather than making full-face contact all at once. As a result, helical gears may offer smoother and quieter operation, since the load is distributed more evenly and engagement is less abrupt. This gradual meshing may reduce vibration and noise. Furthermore, helical gears may handle higher loads and transmit more torque than similarly sized spur gears due to the increased contact area. Frictional heat and wear caused by the sliding action along the angled tooth surface may be mitigated/counteracted by optimized selection and application of lubrication, which is further described below. As shown in FIG. 32B, each tooth 3216 of sun gear 3206 may be cut helically to intermesh smoothly with each tooth 3214 of each planetary gear 3204. Each tooth 3214 of each planetary gear 3204 may be cut at a complementary angle to a tooth 3216 of sun gear 3206.

Other techniques may be employed to further dampen or reduce the amount of sound caused by gear assembly 210. For example, an area of upper housing section 122 that encloses gear assembly 210 may be assembled and/or packed with insulation (e.g., elastomeric pads, foam lining, rubber gaskets, etc.). Insulation may be useful for reducing the overall amplitude of sound produced by gear assembly 210. To improve the quality of the sound produced and eliminate sound frequencies and chattering that are bothersome to users, insulation may be combined with other mitigating optimizations, such as more/thicker grease, optimized tooth profile, and helical-cut gears. With respect to grease, grease may be most effective in the initial period of use of drink maker 100. The longer gear assembly 210 is in operation, the less effective grease may become due to mechanical shearing, thermal breakdown, oxidation, contamination, and/or separation of a base oil from a thickener. However, these aging effects may be slowed, and performance preserved, by selecting a grease with a suitable base oil and thickener system, using a grease with appropriate additives (e.g., anti-wear agents, corrosion inhibitors, oxidation stabilizers), minimizing contamination and moisture ingress (e.g., through effective seals), reducing ambient temperature penetration, and/or the like.

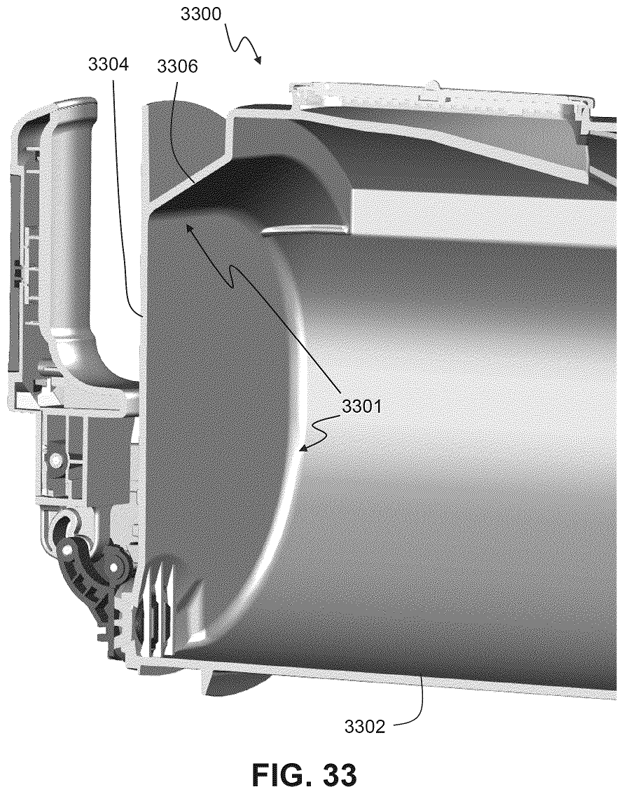

Referring now to FIG. 33, shown is a cross-sectional view of mixing vessel 3300 for a drink maker (e.g., drink maker 100), according to some non-limiting embodiments or aspects. The features of mixing vessel 3300, described in connection with FIG. 33, may be implemented with any mixing vessel described herein, including, but not limited to, mixing vessel 104, mixing vessel 2000, mixing vessel 2204, and mixing vessel 2254. Mixing vessel 3300 is configured to reduce the sticking of drink product to the edges and/or corners of mixing vessel 3300, which may reduce throughput and overall efficiency of the drink maker.

In some non-limiting embodiments or aspects, as liquid drink product is cooled inside mixing vessel 3300 and ice crystals begin to form in the drink product, the semi-frozen drink product may adhere to the walls of mixing vessel 3300. As a slush forms in the drink product and is scraped into suspension, the bulk drink product may become a dense slurry of ice crystals in liquid. Such contents may have a higher viscosity than the original liquid, and areas of mixing vessel 3300 furthest from dasher movement may have lower shear zones (e.g., less churning). In potentially stagnant boundary layers, semi-frozen material may settle and cling, particularly to edges and corners where the ratio of contact surface area for the drink product relative to encompassed volume is higher.

To reduce the tendency of drink product to adhere to edges and/or corners of mixing vessel 3300, mixing vessel 3300 may be configured with rounded edges 3301 on at least one interior edge of an internal chamber of mixing vessel 3300. Rounded edges 3301 may be shaped as a fillet and/or rounded seam. In some non-limiting embodiments or aspects, rounded edges 3301 may be co-formed with sidewall 3302 and/or front wall 3304. In some non-limiting embodiments or aspects, rounded edges 3301 may be formed with a smooth, curved surface. In some non-limiting embodiments or aspects, the radius of curvature (e.g., fillet radius) may be greater than or equal to 5 mm. In some non-limiting embodiments or aspects, the radius of curvature may be greater than or equal to 7 mm. In some non-limiting embodiments or aspects, the radius of curvature may be greater than or equal to 10 mm. It will be appreciated that as the radius of curvature increases, the amount of drink product waste due to adhesion (e.g., lodged product) may be decreased. It will also be appreciated that as the radius of curvature increases, the amount of manufacturing plastic use may increase. While all of the above radii of curvature may adequately reduce drink product waste (e.g., compared to a non-curved, non-filleted edge), a radius of curvature of approximately 6-8 mm (e.g., 7 mm) may balance well the objectives of reducing drink product waste and minimizing manufacturing plastic resource use.

In some non-limiting embodiments or aspects, rounded edges 3301 may be formed at an edge between sidewall 3302 (e.g., a wall of mixing vessel 3300 extending along at least a side of mixing vessel 3300) and front wall 3304 (e.g., a wall of mixing vessel 3300 proximate to an outlet/dispenser thereof). Rounded edges 3301 may be further formed at an edge between front wall 3304 and internal baffle 3306 (e.g., a portion of a wall of mixing vessel 3300, such as sidewall 3302, that extends away from front wall 3304 and at least partly toward a rear of mixing vessel 3300). As drink product is pushed toward and/or along rounded edges 3301, the rounded shape of rounded edges 3301 may permit drink product to flow more continuously over and/or between the internal walls of mixing vessel 3300, thereby preventing drink product from becoming lodged in an internal edge and/or corner of mixing vessel 330.

The foregoing described configuration of mixing vessel 3300 provides further improvements in combination with the rear-to-forward movement of drink product, as well as the rotational churning, by action of an internal dasher. As drink product is being cooled in mixing vessel 3300, dasher may rotate and generally move drink product toward a front of mixing vessel 3300, toward front wall 3304, which may be useful for dispensing the drink product. However, this rear-to-front force may increase the amount of drink product positioned at the edges/corners between sidewall 3302, front wall 3304, and/or internal baffle 3306. To compensate, rounded edges 3301 may permit drink product to crowd around a front of mixing vessel 3300 while churning, substantially reducing the likelihood of adhesion at those points. Accordingly, the efficiency of producing the frozen/semi-frozen drink product may be improved, and the drink product loss due to adhesion may be reduced at the time of dispensing.

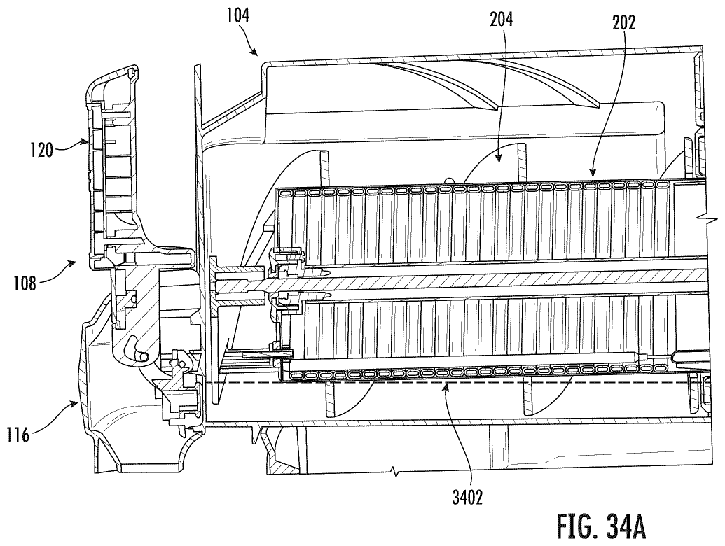

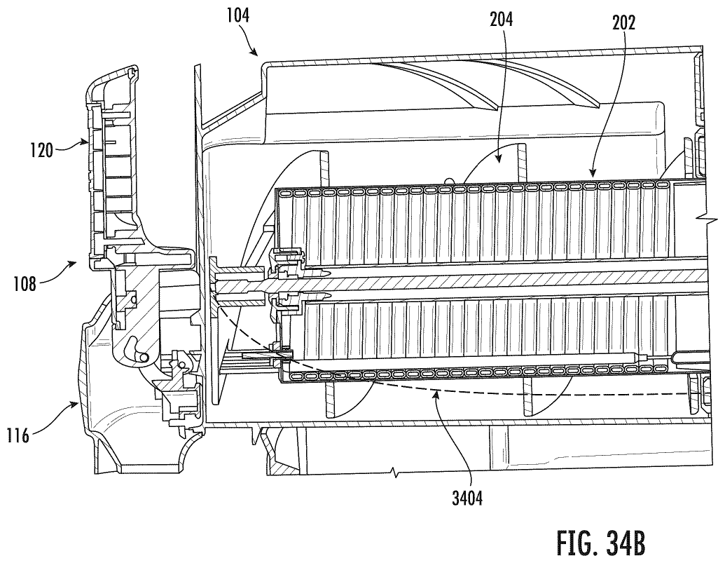

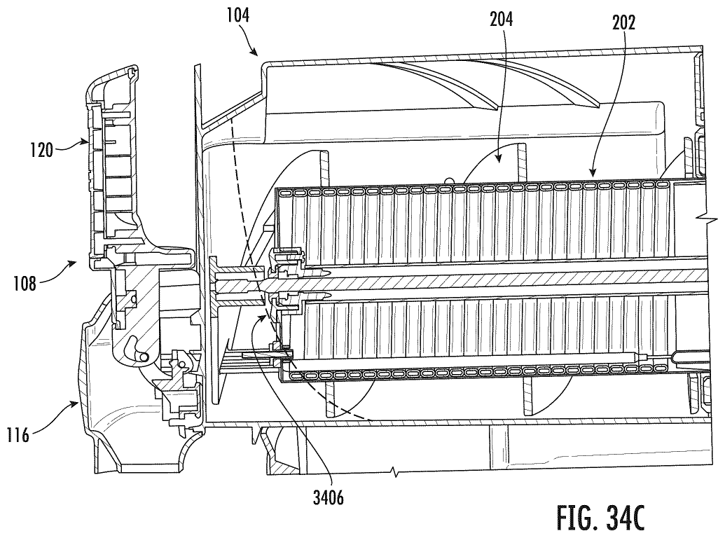

Referring now to FIGS. 34A-34C, shown are cross-sectional views of mixing vessel 104 and dispenser assembly 108, according to some non-limiting embodiments or aspects. As shown, a drink maker may include mixing vessel 104, dispenser assembly 108 with handle 120 and shroud 116, evaporator 202, and dasher 204. Mixing vessel 104 and evaporator 202 may be dimensioned and arranged so as to improve contact between drink product and evaporator 202 during operation of the drink maker. FIG. 34A illustrates first product level line 3402 associated with liquid or mostly liquid drink product, before the drink maker begins cooling the drink product contained in mixing vessel 104 and moving the drink product with dasher 204. FIG. 34B illustrates second product level line 3404 associated with a liquid or semi-liquid drink product, during the cooling of drink product contained in mixing vessel 104 and due to movement of the drink product by dasher 204, before or just after a phase change in the drink product has begun. FIG. 34C illustrates third product level line 3406 associated with a mostly solid slurry-like drink product, after the cooling of drink product has attained a target thickness for user consumption and due to the movement of the drink product by dasher 204.

With specific reference to FIG. 34A, and in some non-limiting embodiments or aspects, before a cooling and dashing process has begun, the drink product contained in mixing vessel 104 will be liquid. First product level line 3402 represents approximately the surface level for a minimum fill volume of mixing vessel 104. A bottom interior surface of mixing vessel 104 may be horizontal or slightly inclined toward a front end (left side of image) of mixing vessel 104. For a cooling process to effectively turn liquid drink product into a semi-frozen slurry, first product level line 3402 may be configured as a minimum liquid fill line where the liquid drink product just contacts a lower surface of evaporator 202, or would be caused to contact the lower surface of evaporator 202 due to the eventual movement caused by dasher 204.

In some non-limiting embodiments, a front wall of mixing vessel 2000 may include a blocking protrusion (e.g., a blocking rib) to prevent excessive downforce to be applied to handle 120. For example, the blocking protrusion may be positioned on front wall 3304, between fins of dispenser assembly mount 2023, and above outlet 2025 to prevent handle 120 from be moved beyond a position based on the block protrusion. In such an example, a bottom portion of handle 120 may come into contact with the blocking protrusion as handle 120 is rotated to the end of the range of motion when handle 120 is moved to allow for a drink product to flow out of outlet 2025.

In some non-limiting embodiments, an attachment shroud may be connected to dispenser assembly mount 2023 or the attachment shroud and dispenser assembly mount 2023 may be unitary component. The attachment shroud may allow for connection of dispenser assembly 108 (e.g., handle 120 of dispenser assembly 108) to an exterior surface of front wall 3304. In some non-limiting embodiments, the attachment shroud may include a seal (e.g., a silicone sealing component) that seals a notch or an aperture at a bottom of the attachment shroud to prevent the egress of liquid into undesirable locations in a drink maker.

With specific reference to FIG. 34B, and in some non-limiting embodiments or aspects, during a cooling and dashing process, the drink product contained in mixing vessel 104 will be inclined to move toward a front end of mixing vessel 104. The movement in the drink product caused by the churning and pushing forces of dasher 204 may cause the product level in mixing vessel 104 to shift toward a front end of mixing vessel 104. Second product level line 3404 represents approximately the surface level of the drink product while in a liquid or mostly liquid state, while dasher 204 is on and moving the drink product. The forward movement of the drink product increases contact of the drink product at a front end (the left side of the image) of evaporator 202, increasing a surface area of contact to improve a cooling of the drink product.

With specific reference to FIG. 34C, and in some non-limiting embodiments or aspects, during a cooling and dashing process, the drink product contained in mixing vessel 104 will be inclined to move toward a front end of mixing vessel 104 while its thickness is increasing. The movement in the drink product caused by dasher 204, combined with the thickening effect caused by evaporator 202, may cause the product level in mixing vessel 104 to more dramatically shift toward a front end of mixing vessel 104. Third product level line 3406 represents approximately the surface level of the drink product while in a semi-frozen or mostly frozen slurry-like state, while dasher 204 is on and evaporator 202 has cooled the drink product significantly. The forward and upward movement of the drink product increases the volume of drink product at the front end of mixing vessel 104, improving the available volume at the point of dispenser assembly 108 for dispensing from mixing vessel 104. Furthermore, more drink product will be bunched around the area of the face blades (e.g., face blades 806, described hereinabove) of dasher 204, which will further push drink product forward toward an outlet of mixing vessel 104. Furthermore, when gathered at the front end, frozen drink product will be less in contact with evaporator 202, preventing over-cooling and/or reduced contact surface area for freezing. If new liquid drink product is added to mixing vessel 104, it may be introduced at a rear of mixing vessel 104, away from where the semi-frozen or frozen-drink product is gathered at the front end of mixing vessel 104.

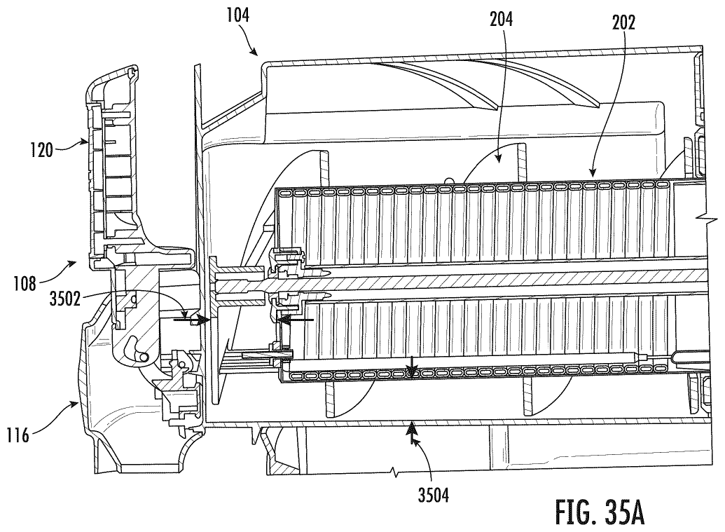

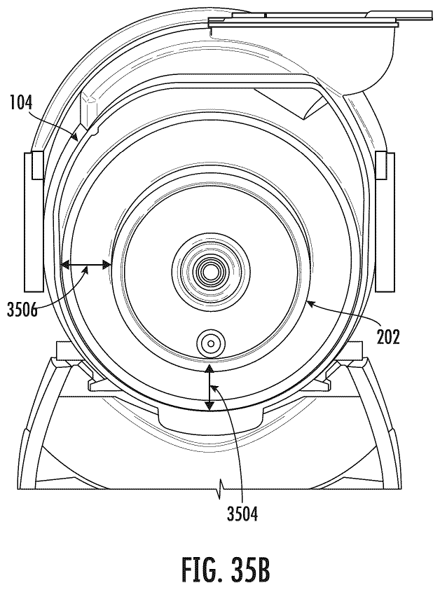

Referring now to FIGS. 35A and 35B, shown are views of components of a drink maker to illustrate relative dimensions of evaporator 202 and mixing vessel 104, according to some non-limiting embodiments or aspects. FIG. 35A shows a cross-sectional view of mixing vessel 104 and dispenser assembly 108 of a drink maker, according to some non-limiting embodiments or aspects. FIG. 35B shows a front cross-sectional view of a drink maker, according to some non-limiting embodiments or aspects. FIGS. 35A and 35B are provided to further illustrate the intentionally configured dimensions of space (e.g., volumes) around evaporator 202, particularly (i) between evaporator 202 and a front end of mixing vessel 104 (shown in FIG. 35A), (ii) between evaporator 202 and a bottom, interior surface of mixing vessel 104 (shown in FIGS. 35A and 35B), and (iii) between evaporator and a side, interior wall of mixing vessel 104 (shown in FIG. 35B). Dimension lines 3502 represent the distance between a front end of evaporator 202 and a front, interior wall of mixing vessel 104, creating a first volume for drink product to gather (e.g., as shown in FIG. 34C). Dimension lines 3504 represent the distance between a bottom surface of evaporator 202 and a bottom, interior surface of mixing vessel 104, creating a second volume for drink product to gather (e.g., as shown in FIG. 34A). Dimension lines 3506 represent the distance between a lateral side surface of evaporator 202 and a lateral side, interior surface of mixing vessel 104, creating a third volume for drink product to gather.

In some non-limiting embodiments or aspects, dimension lines 3502 (shown in FIG. 35A) indicate a gap at the front of evaporator 202 that is configured to be small enough to maintain some contact between semi-frozen or frozen drink product and evaporator 202, while balancing the additional material cost of evaporator and reduced volume (e.g., related to a maximum fill volume of mixing vessel 104). In some non-limiting embodiments or aspects, dimension lines 3504 (shown in FIGS. 35A and 35B) indicate a gap below evaporator 202, which delimits the volume for liquid to sit in, balanced against too small a volume that might result in more waste between dasher 204 and/or mixing vessel 104 on the bottom sides. This is further balanced against the design consideration that reduced gaps between evaporator 202 and side/front walls of mixing vessel 104 reduces the fin height of dasher 204, thereby reducing how much the ingredients are moved forward in mixing vessel 104. Similarly, and in some non-limiting embodiments or aspects, dimension lines 3506 (shown in FIG. 35B) indicate a gap between evaporator 202 and a lateral side, internal wall of mixing vessel 104, which delimits the volume for liquid to sit in, balanced against too small a volume that might result in more waste between dasher 204 and/or mixing vessel 104 on the lateral sides. This is further balanced against the design consideration that reduced gaps between evaporator 202 and later side walls of mixing vessel 104 reduces the fin height of dasher 204, thereby reducing how much the ingredients are moved forward in mixing vessel 104. As such, the gaps shown by dimension lines 3502, 3504, 3506 are configured to balance efficient contact between drink product and evaporator 202, meaningful dasher fin height 204 to impart a movement in drink product, and reduced drink product waste. In some non-limiting embodiments or aspects, each gap shown by dimension lines 3502, 3504, 3506 may be approximately 40 mm.

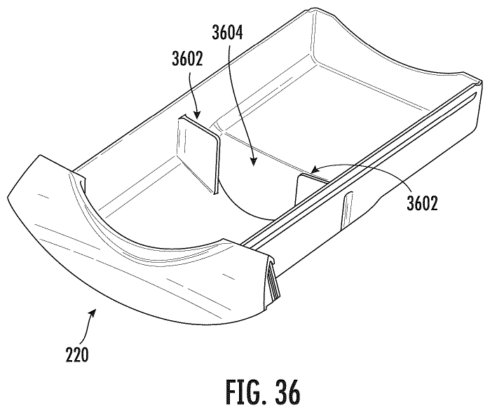

Referring now to FIG. 36, shown is a perspective view of condensation collection tray 220, according to some non-limiting embodiments or aspects. In some non-limiting embodiments or aspects, condensation collection tray 220 may include partitions 3602 and inclined surface 3604. Partitions 3602 (e.g., structural plates) may be provided as a form of baffling, configured to reduce the uncontrolled movement of liquid that may accumulate in condensation collection tray 220. For example, when a user removes condensation collection tray 220, the liquid contained therein may slosh back and forth, which may be an outcome referred to as the free surface effect. Partitions 3602 may break up the free surface area of the liquid, disrupting the liquid's momentum, thereby reducing sloshing loads and decreasing the likelihood of spillage when the condensation collection tray 220 is removed from the drink maker. Inclined surface 3604 may further urge collected liquid to move toward a front side (lower left side of image) of condensation collection tray 220 to improve pouring and retention of liquid in the sub-compartments of condensation collection tray 220.

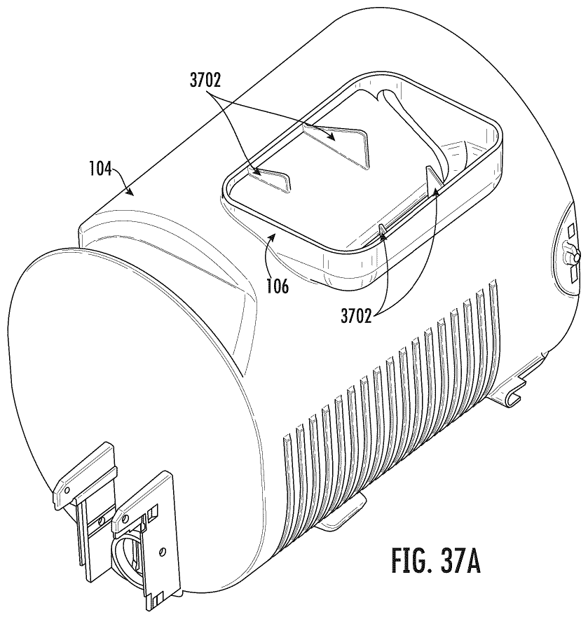

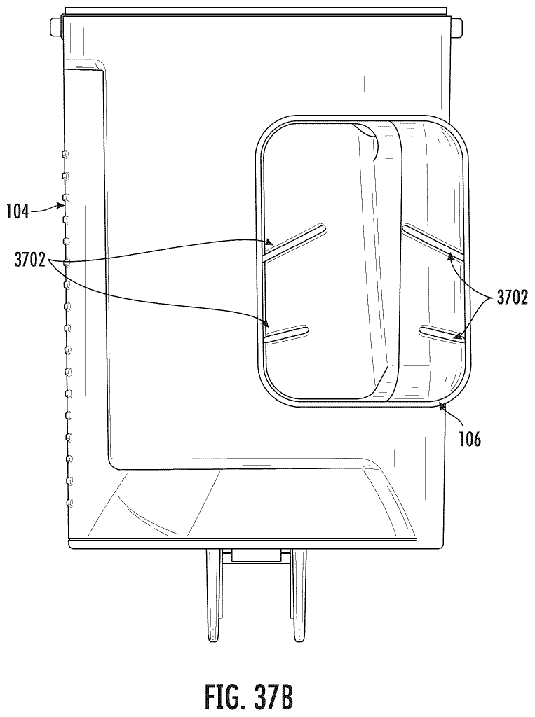

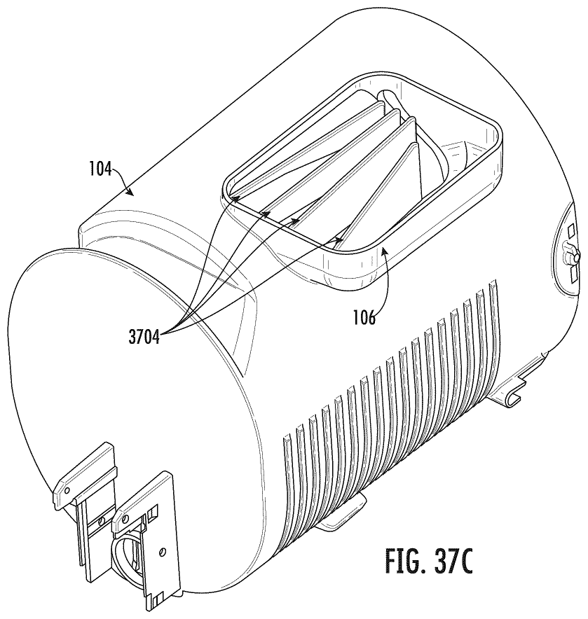

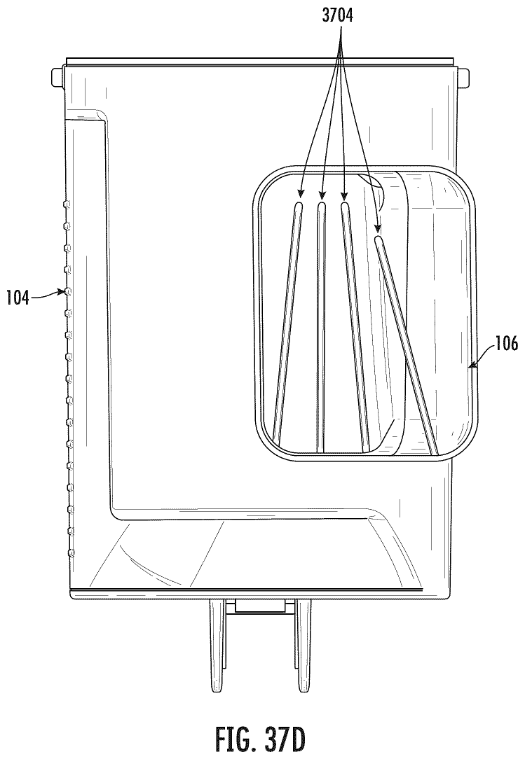

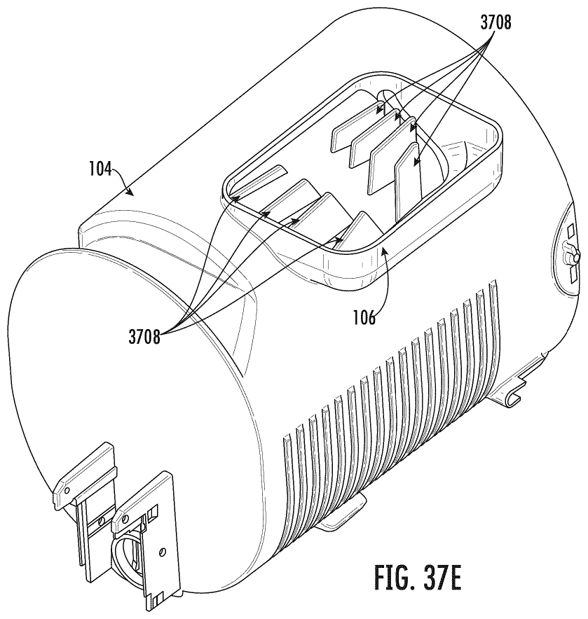

Referring now to FIGS. 37A and 37B, shown are views of pour-in opening 106, according to some non-limiting embodiments or aspects. FIG. 37A shows a perspective view of pour-in opening 106 with majority lateral-facing partitions, and FIG. 37B shows a top-down view of the same configuration. In some non-limiting embodiments or aspects, pour-in opening 106 may include lateral partitions 3702 (e.g., structural plates oriented cross-wise, or predominantly cross-wise) that are configured to reduce the likelihood of liquid being spilled out of pour-in opening 106 during pouring. For example, when liquid is introduced to pour-in opening 106, the incoming stream may strike the internal surfaces of pour-in opening 106 with considerable velocity and kinetic energy, which may create turbulence, splashing, and swirling currents in the well of pour-in opening 106. For more viscous liquids, lateral partitions 3702 may further reduce foam formation due to liquid turbulence. Furthermore, lateral partitions 3702 may, by disrupting the turbulence of introduced liquids, cause liquids to settle and flow more efficiently out through an aperture into the internal chamber of mixing vessel 104, particularly by first directing the liquid between lateral partitions 3702. One, two, three, four, or more lateral partitions 3702 may be included in pour-in opening 106. In some non-limiting embodiments or aspects, lateral partitions 3702 may be angled at approximately 60 to 75 degrees relative to the lengthwise flow of liquid moving from a front end to a back end of pour-in opening 106.

Referring now to FIGS. 37C and 37D, shown are views of pour-in opening 106, according to some non-limiting embodiments or aspects. FIG. 37C shows a perspective view of pour-in opening 106 with majority lengthwise-facing partitions, and FIG. 37D shows a top-down view of the same configuration. In some non-limiting embodiments or aspects, pour-in opening 106 may include lengthwise partitions 3704 (e.g., structural plates oriented lengthwise, or predominantly lengthwise) that are configured to reduce the likelihood of liquid being spilled out of pour-in opening 106 during pouring. For example, when liquid is introduced to pour-in opening 106, the incoming stream may strike the internal surfaces of pour-in opening 106 with considerable velocity and kinetic energy, which may create turbulence, splashing, and swirling currents in the well of pour-in opening 106. For more viscous liquids, lengthwise partitions 3704 may further reduce foam formation due to liquid turbulence. Furthermore, lengthwise partitions 3704 may, by disrupting the turbulence of introduced liquids, cause liquids to settle and flow more efficiently out through an aperture into the internal chamber of mixing vessel 104, particularly by the liquid first being directed in a direction parallel to lengthwise partitions 3704. One, two, three, four, or more lengthwise partitions 3704 may be included in pour-in opening 106. In some non-limiting embodiments or aspects, lengthwise partitions 3704 may be angled at approximately 5 to 20 degrees relative to the lengthwise flow of liquid moving from a front end to a back end of pour-in opening 106.

Referring now to FIG. 37E, shown is a perspective view of pour-in opening 106, according to some non-limiting embodiments or aspects. FIG. 37E shows a perspective view of pour-in opening 106 with two sections of majority lengthwise-facing partitions. In some non-limiting embodiments or aspects, pour-in opening may include front section lengthwise partitions 3706 and rear section lengthwise partitions 3708 (e.g., each structural plates oriented lengthwise, or predominantly lengthwise). For example, when liquid is introduced to pour-in opening 106, the incoming stream may strike the internal surfaces of pour-in opening 106 with considerable velocity and kinetic energy, which may create turbulence, splashing, and swirling currents in the well of pour-in opening 106. For more viscous liquids, front section lengthwise partitions 3706 and rear section lengthwise partitions 3708 may further reduce foam formation due to liquid turbulence. Furthermore, front section lengthwise partitions 3706 and rear section lengthwise partitions 3708 may, by disrupting the turbulence of introduced liquids, cause liquids to settle and flow more efficiently out through an aperture into the internal chamber of mixing vessel 104, particularly by the liquid first being directed in a direction parallel to first section lengthwise partitions 3706 and rear section lengthwise partitions 3708. A plurality of partitions 3706, 3708 (e.g., eight) may be included in pour-in opening 106. In some non-limiting embodiments or aspects, each partition may be angled at approximately 5 to 20 degrees relative to the lengthwise flow of liquid moving from a front end to a back end of pour-in opening 106.

It should be appreciated that the various implementations described herein are not limited to making frozen or semi-frozen drinks, but may be applied to produce a cold and/or cooled drink product that is cooler than a received drink product, but not frozen or semi-frozen. For example, in some non-limiting embodiments or aspects, the same or similar mechanisms and/or techniques may be used as part of a cold drink machine and/or cooled drink maker to produce, maintain and dispense cold drinks.

As discussed with respect to FIG. 4, actions associated with configuring or controlling a frozen drink maker, such as frozen drink maker 100, and processes described herein can be performed by one or more programmable processors executing one or more computer programs to control or to perform all or some of the operations described herein. All or part of the frozen drink maker 100 systems and processes can be configured or controlled by special purpose logic circuitry, such as, an FPGA and/or an ASIC or embedded microprocessor(s) localized to the instrument hardware.

Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

What is claimed is:

1. A drink maker comprising:
a mixing vessel configured to receive a drink product;
an evaporator positioned in the mixing vessel; and
a dasher configured to process the drink product in the mixing vessel,
wherein the mixing vessel comprises at least one rib protruding from an interior surface of the mixing vessel, the at least one rib extending from a side of the mixing vessel, along the interior surface of the mixing vessel, toward a midline of the mixing vessel.

2. The drink maker of claim 1, wherein the at least one rib comprises two or more ribs extending from a same side of the mixing vessel, along the interior surface of the mixing vessel, toward the midline of the mixing vessel.

3. The drink maker of claim 2, wherein an area between each rib of the two or more ribs is smooth.

4. The drink maker of claim 1, wherein the at least one rib extends at least partly perpendicularly from the side of the mixing vessel relative to a longitudinal axis of the mixing vessel, the at least one rib angled along its length toward a front of the mixing vessel.

5. The drink maker of claim 1, wherein the mixing vessel further comprises a pour-in opening, and wherein the at least one rib terminates proximate to the pour-in opening.

6. The drink maker of claim 1, wherein the mixing vessel further comprises a first internal protrusion extending horizontally along an interior wall of the mixing vessel.

7. The drink maker of claim 6, wherein the first internal protrusion is on a same side of the mixing vessel as the at least one rib.

8. The drink maker of claim 7, wherein an end of the at least one rib terminates at the first internal protrusion.

9. The drink maker of claim 1, wherein the mixing vessel further comprises a second internal protrusion on an upper, interior surface of the mixing vessel, the second internal protrusion being at least partly rounded and configured to reduce adherence of the drink product to the upper, interior surface of the mixing vessel.

10. The drink maker of claim 9, wherein the second internal protrusion is at least partly convex and extends into an interior of the mixing vessel, toward a bottom of the mixing vessel.

11. The drink maker of claim 9, wherein the second internal protrusion is at least partly concave and forms an indentation on the upper, interior surface of the mixing vessel.

12. The drink maker of claim 10, wherein the second internal protrusion is shaped as a tear drop.

13. A mixing vessel for a drink maker, the mixing vessel comprising at least one rib protruding from an interior surface of the mixing vessel, the at least one rib extending from a side of the mixing vessel, along the interior surface of the mixing vessel, toward a midline of the mixing vessel, the mixing vessel being configured to receive a drink product to be processed in the mixing vessel, and the mixing vessel being further configured to receive an evaporator of the drink maker positioned in the mixing vessel.

14. The mixing vessel of claim 13, wherein the at least one rib comprises two or more ribs extending from a same side of the mixing vessel, along the interior surface of the mixing vessel, toward the midline of the mixing vessel, and wherein an area between each rib of the two or more ribs is smooth.

15. The mixing vessel of claim 13, wherein the at least one rib extends at least partly perpendicularly from the side of the mixing vessel relative to a longitudinal axis of the mixing vessel, the at least one rib angled along its length toward a front of the mixing vessel.

16. The mixing vessel of claim 13, further comprising a pour-in opening, wherein the at least one rib terminates proximate to the pour-in opening.

17. The mixing vessel of claim 13, further comprising a first internal protrusion extending horizontally along an interior wall of the mixing vessel, and wherein the first internal protrusion is on a same side of the mixing vessel as the at least one rib.

18. The mixing vessel of claim 13, further comprising a second internal protrusion on an upper, interior surface of the mixing vessel, the second internal protrusion being rounded.

19. The mixing vessel of claim 18, wherein the second internal protrusion is convex and extends into an interior of the mixing vessel, toward a bottom of the mixing vessel.

20. The mixing vessel of claim 18, wherein the second internal protrusion is concave and forms an indentation on the upper, interior surface of the mixing vessel.
